(19) United States
(12) Patent Application Publication
(10) Pub. No.: US 2025/0084587 A1
(43) Pub. Date: Mar. 13, 2025

(54) BIOMATERIAL-BASED ELASTOMERIC MATERIALS

(71) Applicant: The Fynder Group, Inc., Chicago, IL (US)

(72) Inventors: Eric Epstein, Chicago, IL (US); Jeremy Weigand, Chicago, IL (US); Jeremy Gantz, Chicago, IL (US); Chris Staszel, Chicago, IL (US)

(21) Appl. No.: 18/885,305

(22) Filed: Sep. 13, 2024

Related U.S. Application Data
(60) Provisional application No. 63/538,279, filed on Sep. 13, 2023.
(60) Provisional application No. 63/626,362, filed on Jan. 29, 2024.
(60) Provisional application No. 63/664,118, filed on Jun. 25, 2024.

(51) Int. Cl. D06N 3/00; D06N 3/10

(52) U.S. Cl. CPC D06N 3/0027; D06N 3/106; D06N 2211/28

(57) ABSTRACT

Biomaterial-based elastomeric materials are disclosed, as are methods for making and using such fibrous materials. In some embodiments, a biomaterial textile composition includes a mixture of a thermoplastic elastomer and a second polymer. The biomaterial textile compositions of the disclosure are characterized by desirable combinations of material properties, e.g., elastic modulus and hardness, that make the materials especially suitable for various applications, particularly as leather analogs and similar textiles.

### CROSS REFERENCE TO RELATED APPLICATIONS

This application claims the benefit of priority of U.S. provisional patent applications 63/538,279, filed 13 Sep. 2023; 63/626,362, filed 29 Jan. 2024; and 63/664,118, filed 25 Jun. 2024. The entirety of each of the above-referenced applications is incorporated herein by reference.

### FIELD

This disclosure relates generally to biomaterial-based materials, such as textiles, and methods for the manufacture thereof, and particularly to durable, drapable materials that have a low content or are free of polyurethanes and polyvinyl chlorides and are suitable non-animal-derived alternatives to and/or analogs of conventional animal-derived materials, e.g., hide leather.

### BACKGROUND

Many current fibrous materials, including but not limited to textiles such as leather, create environmental problems during manufacturing and may be difficult or impossible to recycle or dispose of in an environmentally safe way at the end of an article's useful life. By way of non-limiting example, the manufacture of leather depends on the rearing of cattle (which has a significant environmental impact in itself and often raises animal welfare concerns) and requires a tanning step, which may use highly toxic chemicals such as chromium, formic acid, mercury, and various solvents. Leather also biodegrades slowly, over times of about 25 to 40 years. Many textile materials suffer from similar environmental or ethical concerns. There is thus a need in the art for fibrous or similar materials, such as textiles, that may be produced cost-effectively with a minimum of environmental impact and without animal welfare or other ethical concerns; it is further advantageous for such materials to be imparted with or engineered to have various selected physical and/or mechanical properties, e.g., tensile strength, tear strength, flexural rigidity, elasticity, texture, thermal properties, sensory attributes, etc., of conventional fibrous materials, e.g., leather.

It is particularly challenging to obtain, without the use of animal-derived components or environmentally damaging techniques, leather-like materials having the desirable qualities of (or improved qualities relative to) hide leather, e.g., high tensile strength, high tear strength, low elastic modulus (i.e., low stiffness and/or good drapability), ease of processing (i.e., ease of calendering, extrusion, molding, etc.), amenability to various adhesives (especially non-toxic or low-toxicity water-based adhesives, use of which is often critical to be attractive to designers and manufacturers for use as “drop-in” replacements for hide leather), and a high content of renewable material. Previous attempts to obtain leather-like materials without the use of animal-derived components have often incorporated significant amounts of polyurethanes and/or polyvinyl chlorides into the material, but processing of these polymers can be costly and/or environmentally damaging, and the resulting material often fails to achieve the desirable qualities of (or improved qualities relative to) hide leather; particularly, such materials often have a “plasticky” or “artificial” quality that is off-putting to consumers of hide leather. More recently, materials formed from highly crosslinked epoxy networks have been proposed as “drop-in” replacements for hide leather and poorly sustainable polyurethane leather analogs, but these materials cannot be recycled by remelting, and their manufacturing process is highly dependent on the supply of natural rubber, which is often harvested as a monocrop. There is thus a further need in the art for durable, drapable, recyclable materials that have a low content, or are free, of polyurethanes and polyvinyl chlorides and are suitable non-animal-derived alternatives to and/or analogs of conventional animal-derived materials, e.g., hide leather.

### SUMMARY

In an aspect of the present disclosure, a biomaterial textile composition comprises a polymer component, wherein the polymer component comprises from about 20 wt % to about 95 wt % of a thermoplastic elastomer; and from about 5 wt % to about 80 wt % of a second polymer, wherein the thermoplastic elastomer has an elastic modulus of no more than about 10 MPa; the second polymer has at least one characteristic selected from the group consisting of (i) a melt flow index greater than a melt flow index of the thermoplastic elastomer, (ii) a slip velocity greater than a slip velocity of the thermoplastic elastomer, or (iii) a viscosity lower than a viscosity of the thermoplastic elastomer; and the biomaterial textile composition has at least one of (i) an elastic modulus of no more than about 25 MPa, (ii) a Shore A hardness of no more than about 70, and (iii) a tensile stress at 5% tensile strain of no more than about 1.2 MPa.

In embodiments, the thermoplastic elastomer may make up at least about 40 wt % of the polymer component.

In embodiments, the thermoplastic elastomer may be a block copolymer comprising first and second polymer blocks. The first polymer block may, but need not, comprise a structural unit derived from one or more farnesenes. The structural unit derived from one or more farnesenes may, but need not, differ from the one or more farnesenes from which it is derived in that at least about 30%, at least about 40%, at least about 50%, at least about 60%, at least about 70%, at least about 80%, at least about 90%, or about 100% of carbon-carbon bonds that are double bonds in the one or more farnesenes are single bonds in the structural unit. The second polymer block may, but need not, comprise a structural unit derived from an aromatic vinyl monomer.

In embodiments, the second polymer may make up no more than about 80 wt % of the polymer component. The second polymer may, but need not, make up no more than about 45 wt % of the polymer component.

In embodiments, the second polymer may be selected from the group consisting of a thermoplastic polyester elastomer, an ethylene-vinyl acetate, a low-density polyethylene, a styrene-butadiene-styrene block copolymer, a styrene-ethylene-butylene-styrene block copolymer, a styrene-ethylene-propylene-styrene block copolymer, a styrene-ethylene-butadiene-styrene block copolymer, and combinations thereof. The second polymer may, but need not, be an ethylene-vinyl acetate wherein at least one of the following is true: (i) vinyl acetate monomers make up at least about 11%, at least about 12%, at least about 13%, at least about 14%, at least about 15%, at least about 16%, at least about 17%, at least about 18%, or at least about 19% of the ethylene-vinyl acetate on a molar or weight basis, (ii) the ethylene-vinyl acetate has a melt flow rate, at 190° C. and 2.16 kg, of about 2.1 grams per 10 minutes, (iii) the ethylene vinyl-acetate has an elastic modulus of about 20 MPa, and (iv) a proportion of carbon in the second polymer that is renewable, recyclable, and/or biologically derived is at least about 70% or at least about 80%. In embodiments, the second polymer may be selected from the group consisting of Braskem I'm Green™ EVA SVT2180, Braskem I'm Green™ low-density polyethylene SBC818, Braskem I'm Green™ linear low density polyethylene, Braskem I'm Green™ high-density polyethylene, Styroflex® 2G66 B60, Pebax® thermoplastic elastomers, Dryflex® Green, DuPont Hytrel® 3078 ECO B, polybutylene succinate, polyhydroxy alkanoates, polylactic acid, nylon-11, polyethylene furanoate, Keltan Eco EPDM, and combinations thereof.

In embodiments, the biomaterial textile composition may further comprise from about 1 wt % to about 10 wt % of a compatibilizer. The compatibilizer may, but need not, be selected from the group consisting of a polyolefin-octene-maleic anhydride copolymer, a polybutadiene-maleic anhydride copolymer, a polyolefin-carboxylic acid copolymer, a poly(farnesene) itaconic acid graft copolymer, a poly(farnesene) maleic anhydride graft copolymer, an epoxidized vegetable oil, an alkyl ester of an epoxidized vegetable oil, a rosin derivative, a polyester oligomer, a dicarboxylic acid ester, an ester of citric acid, a diether, a polyether oligomer, and combinations thereof.

In embodiments, the elastic modulus may be no more than about 20 MPa.

In embodiments, a molecular weight of at least one of the thermoplastic elastomer and the second polymer is about 20 kDa to about 300 kDa.

In embodiments, the thermoplastic elastomer may comprise a 1,3-diene monomer selected from the group consisting of one or more farnesenes, myrcene, butadiene, isoprene, and combinations thereof.

In embodiments, the thermoplastic elastomer may comprise an aromatic vinyl monomer selected from the group consisting of styrene, α-methylstyrene, 4-methylstyrene, styrene sulfonate, and combinations thereof. A styrene:farnesene weight ratio in the thermoplastic elastomer may, but need not, be from about 5:95 to about 50:50. The aromatic vinyl monomer may, but need not, be styrene, and the styrene may, but need not, make up from about 15 wt % to about 22 wt % of the thermoplastic elastomer.

In embodiments, the second polymer may have a tensile strength of from about 10 MPa to about 50 MPa.

In embodiments, the second polymer may have a density of from about 0.90 g/cm³ to about 1.28 g/cm³.

In embodiments, the second polymer may have a strain at break of from about 100% to about 1000%.

In embodiments, the second polymer may have a Shore D hardness of from about 24 to about 70.

In embodiments, the second polymer may have a melting point of from about 86° C. to about 221° C.

In embodiments, the second polymer may be capable of being bonded by at least one of a roasted hydrocarbon adhesive, a mixed-protein adhesive, a gelatin adhesive, a keratin adhesive, a fibrin adhesive, a wax adhesive, a starch adhesive, a dextrin adhesive, a polysaccharide adhesive, a tree gum or resin adhesive, a latex rubber cement adhesive, a methyl cellulose adhesive, a ketone adhesive, a dichloromethane adhesive, an acrylonitrile adhesive, a cyanoacrylate adhesive, a methyl acrylate adhesive, an ethylene-vinyl acetate adhesive, a polyolefin adhesive, a polyamide adhesive, a polyester adhesive, a polyurethane adhesive, a polycaprolactone adhesive, a phenol formaldehyde resin adhesive, a urea-formaldehyde adhesive, a polysulfide adhesive, an epoxy resin adhesive, a polyvinyl adhesive, a silicone resin adhesive, and a silyl modified polymer adhesive.

In embodiments, a polyurethane content of the biomaterial textile composition may be no more than about 10 wt %, no more than about 9 wt %, no more than about 8 wt %, no more than about 7 wt %, no more than about 6 wt %, no more than about 5 wt %, no more than about 4 wt %, no more than about 3 wt %, no more than about 2 wt %, no more than about 1 wt %, no more than about 0.9 wt %, no more than about 0.8 wt %, no more than about 0.7 wt %, no more than about 0.6 wt %, no more than about 0.5 wt %, no more than about 0.4 wt %, no more than about 0.3 wt %, no more than about 0.2 wt %, no more than about 0.1 wt %, no more than about 0.09 wt %, no more than about 0.08 wt %, no more than about 0.07 wt %, no more than about 0.06 wt %, no more than about 0.05 wt %, no more than about 0.04 wt %, no more than about 0.03 wt %, no more than about 0.02 wt %, or no more than about 0.01 wt %. The biomaterial textile composition may, but need not, be substantially free of polyurethanes.

In embodiments, a polyvinyl chloride content of the biomaterial textile composition may be no more than about 10 wt %, no more than about 9 wt %, no more than about 8 wt %, no more than about 7 wt %, no more than about 6 wt %, no more than about 5 wt %, no more than about 4 wt %, no more than about 3 wt %, no more than about 2 wt %, no more than about 1 wt %, no more than about 0.9 wt %, no more than about 0.8 wt %, no more than about 0.7 wt %, no more than about 0.6 wt %, no more than about 0.5 wt %, no more than about 0.4 wt %, no more than about 0.3 wt %, no more than about 0.2 wt %, no more than about 0.1 wt %, no more than about 0.09 wt %, no more than about 0.08 wt %, no more than about 0.07 wt %, no more than about 0.06 wt %, no more than about 0.05 wt %, no more than about 0.04 wt %, no more than about 0.03 wt %, no more than about 0.02 wt %, or no more than about 0.01 wt % of the biomaterial textile composition. The biomaterial textile composition may, but need not, be substantially free of polyvinyl chlorides.

In embodiments, materials that are renewable, recyclable, and/or biologically derived may make up at least about 50 wt %, at least about 55 wt %, at least about 60 wt %, at least about 65 wt %, at least about 70 wt %, at least about 75 wt %, at least about 80 wt %, at least about 85 wt %, at least about 90 wt %, at least about 91 wt %, at least about 92 wt %, at least about 93 wt %, at least about 94 wt %, at least about 95 wt %, at least about 96 wt %, at least about 97 wt %, at least about 98 wt %, at least about 99 wt %, at least about 99.1 wt %, at least about 99.2 wt %, at least about 99.3 wt %, at least about 99.4 wt %, at least about 99.5 wt %, at least about 99.6 wt %, at least about 99.7 wt %, at least about 99.8 wt %, at least about 99.9 wt %, at least about 99.91 wt %, at least about 99.92 wt %, at least about 99.93 wt %, at least about 99.94 wt %, at least about 99.95 wt %, at least about 99.96 wt %, at least about 99.97 wt %, at least about 99.98 wt %, or at least about 99.99 wt % of the biomaterial textile composition. Substantially all of the biomaterial textile composition may, but need not, be made up of materials that are renewable, recyclable, and/or biologically derived.

In embodiments, a proportion of carbon in the thermoplastic elastomer, the second polymer, or the biomaterial textile composition that is renewable, recyclable, and/or biologically derived may be at least about 50%, at least about 60%, at least about 70%, at least about 80%, or at least about 90%.

In embodiments, the biomaterial textile composition may further comprise a foaming agent.

In embodiments, the biomaterial textile composition may have a density of at least about 0.5 g/cm³.

In embodiments, the biomaterial textile composition may further comprise a filler or reinforcing material selected from the group consisting of cellulose fibers, cardboard, paper, microfibrillated cellulose, nanofibrillated cellulose, recycled fibers, recycled particles, polymeric fibers, flame retardants, colored pigments, polymeric particles, and combinations thereof.

In embodiments, the biomaterial textile composition may further comprise a biomass component. The biomass component may, but need not, comprise fungal hyphae and/or mycelium. The fungal hyphae and/or mycelium may, but need not, have a D50 particle size of about 10 μm to about 30 μm, or of about 20 μm, and/or a D90 particle size of about 35 μm. The biomass component may, but need not, make up at least about 10 wt %, at least about 15 wt %, at least about 20 wt %, at least about 25 wt %, at least about 30 wt %, at least about 35 wt %, at least about 40 wt %, at least about 45 wt %, or at least about 50 wt % of the biomaterial textile composition.

In embodiments, the polymer component may further comprise at least one surface modifier selected from the group consisting of a texture modifier, a slip agent, a non-slip agent, an anti-blocking agent, a matting agent, a gloss agent, and combinations thereof.

In embodiments, the second polymer may be a biologically derived elastomer. The biologically derived elastomer may, but need not, be a polyester having an elastic modulus of no more than about 100 MPa, no more than about 50 MPa, or no more than about 20 MPa. The polyester may, but need not, be a segmented polyester. The segmented polyester may, but need not, make up about 50 wt % to about 80 wt %, or about 65 wt % to about 80 wt %, of the polymer component.

In embodiments, a weight ratio between the thermoplastic elastomer and the second polymer may be from about 20:80 to about 90:10.

In embodiments, the thermoplastic elastomer and the second polymer may collectively make up at least about 50 wt %, at least about 55 wt %, at least about 60 wt %, at least about 65 wt %, at least about 70 wt %, at least about 75 wt %, at least about 80 wt %, at least about 85 wt %, at least about 90 wt %, at least about 95 wt %, at least about 96 wt %, at least about 97 wt %, at least about 98 wt %, or at least about 99 wt % of the biomaterial textile composition.

In embodiments, the polymer component may further comprise a third polymer. The polymer component may, but need not, further comprise a fourth polymer.

In embodiments, the thermoplastic elastomer may comprise Kuraray SEPTON™ BIO SF902, and the Kuraray SEPTON™ BIO SF902 may make up about 25 wt % to about 80 wt % of the polymer component. The Kuraray SEPTON™ BIO SF902 may, but need not, make up about 25 wt % to about 55 wt % of the polymer component.

In embodiments, the biomaterial textile composition may have a water uptake of no more than about 100%, no more than about 95%, no more than about 90%, no more than about 85%, no more than about 80%, no more than about 75%, no more than about 70%, no more than about 65%, no more than about 60%, no more than about 55%, no more than about 50%, no more than about 45%, no more than about 40%, no more than about 35%, no more than about 30%, no more than about 25%, no more than about 20%, no more than about 15%, no more than about 10%, no more than about 5%, no more than about 4%, no more than about 3%, no more than about 2%, or no more than about 1%.

In embodiments, the elastic modulus of the thermoplastic elastomer may be no more than about 9 MPa, no more than about 8 MPa, no more than about 7 MPa, no more than about 6 MPa, no more than about 5 MPa, no more than about 4 MPa, no more than about 3 MPa, no more than about 2 MPa, no more than about 1 MPa, no more than about 0.9 MPa, no more than about 0.8 MPa, no more than about 0.7 MPa, no more than about 0.6 MPa, no more than about 0.5 MPa, no more than about 0.4 MPa, no more than about 0.3 MPa, or no more than about 0.2 MPa.

In embodiments, the second polymer may have a Young's modulus of about 10 MPa to about 20 MPa, about 10 MPa to about 70 MPa, or about 10 MPa to about 250 MPa.

In embodiments, at least one of the following may be true: (i) the second polymer is low-density polyethylene and the thermoplastic elastomer is about 60 wt % to about 80 wt % of the polymer component, (ii) the second polymer is ethylene-vinyl acetate and the thermoplastic elastomer is about 55 wt % to about 65 wt % of the polymer component, and (iii) the second polymer is DuPont Hytrel® 3078 thermoplastic polyester elastomer, DuPont Hytrel® 3078 ECO B thermoplastic polyester elastomer, or a combination thereof and the thermoplastic elastomer is about 20 wt % to about 60 wt % of the polymer component.

In another aspect of the present disclosure, a biomaterial textile comprises a biomaterial textile composition as disclosed herein; and one or both of (i) a coating comprising or derived from a polar solvent, and (ii) a backing layer.

In embodiments, the biomaterial textile may comprise the backing layer, and the backing layer may be laminated to a layer of the biomaterial textile composition without the use of a chemical adhesive or bonding agent.

In another aspect of the present disclosure, a biomaterial textile comprises a thermoplastic elastomer; and a second polymer, wherein the biomaterial textile has an elastic modulus of no more than about 2500 MPa and at least one of (i) an elastic modulus of no more than about 20 MPa and (ii) a Shore A hardness of no more than about 60; and a weight ratio between the thermoplastic elastomer and the second polymer is from about 20:80 to about 90:10.

In embodiments, the thermoplastic elastomer may make up at least about 20 wt % of the biomaterial textile.

In embodiments, the thermoplastic elastomer may be a block copolymer comprising first and second polymer blocks. The first polymer block may, but need not, comprise a structural unit derived from one or more farnesenes. The structural unit derived from one or more farnesenes may, but need not, differ from the one or more farnesenes from which it is derived in that at least about 30%, at least about 40%, at least about 50%, at least about 60%, at least about 70%, at least about 80%, at least about 90%, or about 100% of carbon-carbon bonds that are double bonds in the one or more farnesenes are single bonds in the structural unit. The second polymer block may, but need not, comprise a structural unit derived from an aromatic vinyl monomer.

In embodiments, the second polymer may make up no more than about 80 wt % of the biomaterial textile. The second polymer may, but need not, make up no more than about 45 wt % of the biomaterial textile.

In embodiments, the second polymer may be selected from the group consisting of a thermoplastic polyester elastomer, an ethylene-vinyl acetate, a low-density polyethylene, a styrene-butadiene-styrene block copolymer, a styrene-ethylene-butylene-styrene block copolymer, a styrene-ethylene-propylene-styrene block copolymer, a styrene-ethylene-butadiene-styrene block copolymer, and combinations thereof. The second polymer may, but need not, be an ethylene-vinyl acetate wherein at least one of the following is true: (i) vinyl acetate monomers make up at least about 11%, at least about 12%, at least about 13%, at least about 14%, at least about 15%, at least about 16%, at least about 17%, at least about 18%, or at least about 19% of the ethylene-vinyl acetate on a molar or weight basis, (ii) the ethylene-vinyl acetate has a melt flow rate, at 190° C. and 2.16 kg, of about 2.1 grams per 10 minutes, (iii) the ethylene vinyl-acetate has an elastic modulus of about 20 MPa, and (iv) a proportion of carbon in the second polymer that is renewable, recyclable, and/or biologically derived is at least about 70% or at least about 80%.

In embodiments, the second polymer may be selected from the group consisting of Braskem I'm Green™ EVA SVT2180, Braskem I'm Green™ low-density polyethylene SBC818, linear low density polyethyelene, Braskem I'm Green™ high-density polyethylene, Styroflex® 2G66 B60, Pebax® thermoplastic elastomers, Dryflex® Green thermoplastic elastomer, DuPont Hytrel® 3078 thermoplastic polyester elastomer, DuPont Hytrel® 3078 ECO B thermoplastic polyester elastomer, polybutylene succinate, polyhydroxy alkanoates, polylactic acid, nylon-11, polyethylene furanoate, and combinations thereof.

In embodiments, the biomaterial textile may further comprise from about 1 wt % to about 10 wt % of a compatibilizer. The compatibilizer may, but need not, be selected from the group consisting of a polyolefin-octene-maleic anhydride copolymer, a polybutadiene-maleic anhydride copolymer, a polyolefin-carboxylic acid copolymer, a poly(farnesene) itaconic acid graft copolymer, a poly(farnesene) maleic anhydride graft copolymer, an epoxidized vegetable oil, an alkyl ester of an epoxidized vegetable oil, a rosin derivative, a polyester oligomer, a dicarboxylic acid ester, an ester of citric acid, a diether, a polyether oligomer, and combinations thereof.

In embodiments, the elastic modulus may be no more than about 20 MPa.

In embodiments, the thermoplastic elastomer may comprise a 1,3-diene monomer selected from the group consisting of one or more farnesenes, myrcene, butadiene, isoprene, and combinations thereof.

In embodiments, the thermoplastic elastomer may comprise an aromatic vinyl monomer selected from the group consisting of styrene, α-methylstyrene, 4-methylstyrene, styrene sulfonate, and combinations thereof. A styrene:farnesene weight ratio in the thermoplastic elastomer may, but need not, be from about 5:95 to about 50:50. The aromatic vinyl monomer may, but need not, be styrene, and the styrene may, but need not, make up from about 15 wt % to about 22 wt % of the thermoplastic elastomer.

In embodiments, the second polymer may have a tensile strength of from about 10 MPa to about 50 MPa.

In embodiments, the second polymer may have a density of from about 0.90 g/cm³ to about 1.28 g/cm³.

In embodiments, the second polymer may have a strain at break of from about 100% to about 1000%.

In embodiments, the second polymer may have a Shore D hardness of from about 24 to about 70.

In embodiments, the second polymer may have a melting point of from about 86° C. to about 221° C.

In embodiments, the second polymer may be capable of being bonded by at least one of a roasted hydrocarbon adhesive, a mixed-protein adhesive, a gelatin adhesive, a keratin adhesive, a fibrin adhesive, a wax adhesive, a starch adhesive, a dextrin adhesive, a polysaccharide adhesive, a tree gum or resin adhesive, a latex rubber cement adhesive, a methyl cellulose adhesive, a ketone adhesive, a dichloromethane adhesive, an acrylonitrile adhesive, a cyanoacrylate adhesive, a methyl acrylate adhesive, an ethylene-vinyl acetate adhesive, a polyolefin adhesive, a polyamide adhesive, a polyester adhesive, a polyurethane adhesive, a polycaprolactone adhesive, a phenol formaldehyde resin adhesive, a urea-formaldehyde adhesive, a polysulfide adhesive, an epoxy resin adhesive, a polyvinyl adhesive, a silicone resin adhesive, and a silyl modified polymer adhesive.

In embodiments, a polyurethane content of the biomaterial textile may be no more than about 10 wt %, no more than about 9 wt %, no more than about 8 wt %, no more than about 7 wt %, no more than about 6 wt %, no more than about 5 wt %, no more than about 4 wt %, no more than about 3 wt %, no more than about 2 wt %, no more than about 1 wt %, no more than about 0.9 wt %, no more than about 0.8 wt %, no more than about 0.7 wt %, no more than about 0.6 wt %, no more than about 0.5 wt %, no more than about 0.4 wt %, no more than about 0.3 wt %, no more than about 0.2 wt %, no more than about 0.1 wt %, no more than about 0.09 wt %, no more than about 0.08 wt %, no more than about 0.07 wt %, no more than about 0.06 wt %, no more than about 0.05 wt %, no more than about 0.04 wt %, no more than about 0.03 wt %, no more than about 0.02 wt %, or no more than about 0.01 wt %. The biomaterial textile may, but need not, be substantially free of polyurethanes.

In embodiments, a polyvinyl chloride content of the biomaterial textile may be no more than about 10 wt %, no more than about 9 wt %, no more than about 8 wt %, no more than about 7 wt %, no more than about 6 wt %, no more than about 5 wt %, no more than about 4 wt %, no more than about 3 wt %, no more than about 2 wt %, no more than about 1 wt %, no more than about 0.9 wt %, no more than about 0.8 wt %, no more than about 0.7 wt %, no more than about 0.6 wt %, no more than about 0.5 wt %, no more than about 0.4 wt %, no more than about 0.3 wt %, no more than about 0.2 wt %, no more than about 0.1 wt %, no more than about 0.09 wt %, no more than about 0.08 wt %, no more than about 0.07 wt %, no more than about 0.06 wt %, no more than about 0.05 wt %, no more than about 0.04 wt %, no more than about 0.03 wt %, no more than about 0.02 wt %, or no more than about 0.01 wt % of the biomaterial textile. The biomaterial textile may, but need not, be substantially free of polyvinyl chlorides.

In embodiments, materials that are renewable, recyclable, or both may make up at least about 50 wt %, at least about 55 wt %, at least about 60 wt %, at least about 65 wt %, at least about 70 wt %, at least about 75 wt %, at least about 80 wt %, at least about 85 wt %, at least about 90 wt %, at least about 91 wt %, at least about 92 wt %, at least about 93 wt %, at least about 94 wt %, at least about 95 wt %, at least about 96 wt %, at least about 97 wt %, at least about 98 wt %, at least about 99 wt %, at least about 99.1 wt %, at least about 99.2 wt %, at least about 99.3 wt %, at least about 99.4 wt %, at least about 99.5 wt %, at least about 99.6 wt %, at least about 99.7 wt %, at least about 99.8 wt %, at least about 99.9 wt %, at least about 99.91 wt %, at least about 99.92 wt %, at least about 99.93 wt %, at least about 99.94 wt %, at least about 99.95 wt %, at least about 99.96 wt %, at least about 99.97 wt %, at least about 99.98 wt %, or at least about 99.99 wt % of the biomaterial textile. Substantially all of the biomaterial textile may, but need not, be made up of materials that are renewable, recyclable, or both.

In embodiments, the biomaterial textile may further comprise a coating, and the coating may comprise or be derived from a polar solvent. A polyurethane content of the coating may, but need not, be no more than about 10 wt %, no more than about 9 wt %, no more than about 8 wt %, no more than about 7 wt %, no more than about 6 wt %, no more than about 5 wt %, no more than about 4 wt %, no more than about 3 wt %, no more than about 2 wt %, no more than about 1 wt %, no more than about 0.9 wt %, no more than about 0.8 wt %, no more than about 0.7 wt %, no more than about 0.6 wt %, no more than about 0.5 wt %, no more than about 0.4 wt %, no more than about 0.3 wt %, no more than about 0.2 wt %, no more than about 0.1 wt %, no more than about 0.09 wt %, no more than about 0.08 wt %, no more than about 0.07 wt %, no more than about 0.06 wt %, no more than about 0.05 wt %, no more than about 0.04 wt %, no more than about 0.03 wt %, no more than about 0.02 wt %, or no more than about 0.01 wt %. The coating may, but need not, be substantially free of polyurethane.

In embodiments, the biomaterial textile may further comprise a foaming agent.

In embodiments, the biomaterial textile may have a density of at least about 0.5 g/cm³.

In embodiments, the biomaterial textile may further comprise a filler or reinforcing material selected from the group consisting of fungal hyphae and/or mycelium, cellulose fibers, cardboard, paper, microfibrillated cellulose, nanofibrillated cellulose, recycled fibers, recycled particles, polymeric fibers, flame retardants, colored pigments, and polymeric particles, and combinations thereof. The filler or reinforcing material may, but need not, comprise fungal hyphae and/or mycelium, and the fungal hyphae and/or mycelium may, but need not, have a D50 particle size of about 10 μm to about 30 μm, or of about 20 μm, and/or a D90 particle size of about 35 μm.

In embodiments, the biomaterial textile may further comprise at least one surface modifier selected from the group consisting of a texture modifier, a slip agent, a non-slip agent, an anti-blocking agent, a matting agent, a gloss agent, and combinations thereof.

In embodiments, the second polymer may be a biologically derived elastomer. The biologically derived elastomer may, but need not, be a polyester having an elastic modulus of no more than about 100 MPa, no more than about 50 MPa, or no more than about 20 MPa. The polyester may, but need not, be a segmented polyester. The segmented polyester may, but need not, make up about 50 wt % to about 80 wt %, or about 65 wt % to about 80 wt %, of the polymer component.

In embodiments, the thermoplastic elastomer may make up from about 20 wt % to about 90 wt % of the biomaterial textile and the second polymer makes up from about 5 wt % to about 70 wt % of the biomaterial textile.

In embodiments, the thermoplastic elastomer and the second polymer may collectively make up at least about 50 wt %, at least about 55 wt %, at least about 60 wt %, at least about 65 wt %, at least about 70 wt %, at least about 75 wt %, at least about 80 wt %, at least about 85 wt %, at least about 90 wt %, at least about 95 wt %, at least about 96 wt %, at least about 97 wt %, at least about 98 wt %, or at least about 99 wt % of the biomaterial textile.

In another aspect of the present disclosure, a method for recycling biomaterials comprises melting a first biomaterial textile to form a deformable mixture comprising a liquid fraction and one or more biomaterials; deforming the deformable mixture into a desired spatial configuration; and treating the deformable mixture to form a recycled biomaterial textile.

In embodiments, the deforming step may comprise extruding the deformable mixture.

In embodiments, at least one of the first biomaterial textile and the recycled biomaterial textile may comprise a thermoplastic elastomer; and a second polymer, and at least one of the following may be true: (i) the at least one of the first biomaterial textile and the recycled biomaterial textile comprises the thermoplastic elastomer in an amount from about 20 wt % to about 90 wt % and the second polymer in an amount from about 5 wt % to about 70 wt %, and (ii) a weight ratio of the thermoplastic elastomer to the second polymer is from about 20:80 to about 90:10; and the at least one of the first biomaterial textile and the recycled biomaterial textile has an elastic modulus of no more than about 2500 MPa and at least one of (i) an elastic modulus of no more than about 20 MPa and (ii) a Shore A hardness of no more than about 60.

In embodiments, the thermoplastic elastomer may make up at least about 50 wt % of the at least one of the first biomaterial textile and the recycled biomaterial textile.

In embodiments, the thermoplastic elastomer may be a block copolymer comprising first and second polymer blocks. The first polymer block may, but need not, comprise a structural unit derived from one or more farnesenes. The structural unit derived from one or more farnesenes may, but need not, differ from the one or more farnesenes from which it is derived in that at least about 30%, at least about 40%, at least about 50%, at least about 60%, at least about 70%, at least about 80%, at least about 90%, or about 100% of carbon-carbon bonds that are double bonds in the one or more farnesenes are single bonds in the structural unit. The second polymer block may, but need not, comprise a structural unit derived from an aromatic vinyl monomer.

In embodiments, the second polymer may make up no more than about 80 wt % of the at least one of the first biomaterial textile and the recycled biomaterial textile. The second polymer may, but need not, make up no more than about 45 wt % of the at least one of the first biomaterial textile and the recycled biomaterial textile.

In embodiments, the second polymer may be selected from the group consisting of a thermoplastic polyester elastomer, an ethylene-vinyl acetate, a low-density polyethylene, a styrene-butadiene-styrene block copolymer, a styrene-ethylene-butylene-styrene block copolymer, a styrene-ethylene-propylene-styrene block copolymer, a styrene-ethylene-butadiene-styrene block copolymer and combinations thereof. The second polymer may, but need not, be an ethylene-vinyl acetate wherein at least one of the following is true: (i) vinyl acetate monomers make up at least about 11%, at least about 12%, at least about 13%, at least about 14%, at least about 15%, at least about 16%, at least about 17%, at least about 18%, or at least about 19% of the ethylene-vinyl acetate on a molar or weight basis, (ii) the ethylene-vinyl acetate has a melt flow rate, at 190° C. and 2.16 kg, of about 2.1 grams per 10 minutes, (iii) the ethylene vinyl-acetate has an elastic modulus of about 20 MPa, and (iv) a proportion of carbon in the second polymer that is renewable, recyclable, and/or biologically derived is at least about 70% or at least about 80%.

In embodiments, the second polymer may be selected from the group consisting of Braskem I'm Green™ EVA SVT2180, Braskem I'm Green™ low-density polyethylene SBC818, Braskem I'm Green™ high-density polyethylene, Styroflex® 2G66 B60, Pebax® thermoplastic elastomers, Dryflex® Green, DuPont Hytrel® 3078 ECO B thermoplastic polyester elastomer, DuPont Hytrel® 3078 thermoplastic polyester elastomer, polybutylene succinate, polyhydroxy alkanoates, polylactic acid, nylon-11, polyethylene furanoate, and combinations thereof.

In embodiments, the at least one of the first biomaterial textile and the recycled biomaterial textile may comprise from about 1 wt % to about 10 wt % of a compatibilizer. The compatibilizer may, but need not, be selected from the group consisting of a polyolefin-octene-maleic anhydride copolymer, a polybutadiene-maleic anhydride copolymer, a polyolefin-carboxylic acid copolymer, a poly(farnesene) itaconic acid graft copolymer, a poly(farnesene) maleic anhydride graft copolymer, an epoxidized vegetable oil, an alkyl ester of an epoxidized vegetable oil, a rosin derivative, a polyester oligomer, a dicarboxylic acid ester, an ester of citric acid, a diether, a polyether oligomer, and combinations thereof.

In embodiments, the elastic modulus may be no more than about 1 MPa.

In embodiments, the thermoplastic elastomer may comprise a 1,3-diene monomer selected from the group consisting of one or more farnesenes, myrcene, butadiene, isoprene, and combinations thereof.

In embodiments, the thermoplastic elastomer may comprise an aromatic vinyl monomer selected from the group consisting of styrene, α-methylstyrene, 4-methylstyrene, styrene sulfonate, and combinations thereof. A styrene:farnesene weight ratio in the thermoplastic elastomer may, but need not, be from about 5:95 to about 50:50. The aromatic vinyl monomer may, but need not, be styrene, and the styrene may, but need not, make up from about 15 wt % to about 22 wt % of the thermoplastic elastomer.

In embodiments, the second polymer may have a tensile strength of from about 10 MPa to about 50 MPa.

In embodiments, the second polymer may have a density of from about 0.90 g/cm³ to about 1.28 g/cm³.

In embodiments, the second polymer may have a strain at break of from about 100% to about 1000%.

In embodiments, the second polymer may have a Shore D hardness of from about 24 to about 70.

In embodiments, the second polymer may have a melting point of from about 86° C. to about 221° C.

In embodiments, the second polymer may be capable of being bonded by at least one of a roasted hydrocarbon adhesive, a mixed-protein adhesive, a gelatin adhesive, a keratin adhesive, a fibrin adhesive, a wax adhesive, a starch adhesive, a dextrin adhesive, a polysaccharide adhesive, a tree gum or resin adhesive, a latex rubber cement adhesive, a methyl cellulose adhesive, a ketone adhesive, a dichloromethane adhesive, an acrylonitrile adhesive, a cyanoacrylate adhesive, a methyl acrylate adhesive, an ethylene-vinyl acetate adhesive, a polyolefin adhesive, a polyamide adhesive, a polyester adhesive, a polyurethane adhesive, a polycaprolactone adhesive, a phenol formaldehyde resin adhesive, a urea-formaldehyde adhesive, a polysulfide adhesive, an epoxy resin adhesive, a polyvinyl adhesive, a silicone resin adhesive, and a silyl modified polymer adhesive.

In embodiments, a polyurethane content of the at least one of the first biomaterial textile and the recycled biomaterial textile may be no more than about 10 wt %, no more than about 9 wt %, no more than about 8 wt %, no more than about 7 wt %, no more than about 6 wt %, no more than about 5 wt %, no more than about 4 wt %, no more than about 3 wt %, no more than about 2 wt %, no more than about 1 wt %, no more than about 0.9 wt %, no more than about 0.8 wt %, no more than about 0.7 wt %, no more than about 0.6 wt %, no more than about 0.5 wt %, no more than about 0.4 wt %, no more than about 0.3 wt %, no more than about 0.2 wt %, no more than about 0.1 wt %, no more than about 0.09 wt %, no more than about 0.08 wt %, no more than about 0.07 wt %, no more than about 0.06 wt %, no more than about 0.05 wt %, no more than about 0.04 wt %, no more than about 0.03 wt %, no more than about 0.02 wt %, or no more than about 0.01 wt %. The at least one of the first biomaterial textile and the recycled biomaterial textile may, but need not, be substantially free of polyurethanes.

In embodiments, a polyvinyl chloride content of the at least one of the first biomaterial textile and the recycled biomaterial textile may be no more than about 10 wt %, no more than about 9 wt %, no more than about 8 wt %, no more than about 7 wt %, no more than about 6 wt %, no more than about 5 wt %, no more than about 4 wt %, no more than about 3 wt %, no more than about 2 wt %, no more than about 1 wt %, no more than about 0.9 wt %, no more than about 0.8 wt %, no more than about 0.7 wt %, no more than about 0.6 wt %, no more than about 0.5 wt %, no more than about 0.4 wt %, no more than about 0.3 wt %, no more than about 0.2 wt %, no more than about 0.1 wt %, no more than about 0.09 wt %, no more than about 0.08 wt %, no more than about 0.07 wt %, no more than about 0.06 wt %, no more than about 0.05 wt %, no more than about 0.04 wt %, no more than about 0.03 wt %, no more than about 0.02 wt %, or no more than about 0.01 wt %. The at least one of the first biomaterial textile and the recycled biomaterial textile may, but need not, be substantially free of polyvinyl chlorides.

In embodiments, materials that are renewable, recyclable, or both may make up at least about 50 wt %, at least about 55 wt %, at least about 60 wt %, at least about 65 wt %, at least about 70 wt %, at least about 75 wt %, at least about 80 wt %, at least about 85 wt %, at least about 90 wt %, at least about 91 wt %, at least about 92 wt %, at least about 93 wt %, at least about 94 wt %, at least about 95 wt %, at least about 96 wt %, at least about 97 wt %, at least about 98 wt %, at least about 99 wt %, at least about 99.1 wt %, at least about 99.2 wt %, at least about 99.3 wt %, at least about 99.4 wt %, at least about 99.5 wt %, at least about 99.6 wt %, at least about 99.7 wt %, at least about 99.8 wt %, at least about 99.9 wt %, at least about 99.91 wt %, at least about 99.92 wt %, at least about 99.93 wt %, at least about 99.94 wt %, at least about 99.95 wt %, at least about 99.96 wt %, at least about 99.97 wt %, at least about 99.98 wt %, or at least about 99.99 wt % of the at least one of the first biomaterial textile and the recycled biomaterial textile. Substantially all of the at least one of the first biomaterial textile and the recycled biomaterial textile may, but need not, be made up of materials that are renewable, recyclable, or both.

In embodiments, the at least one of the first biomaterial textile and the recycled biomaterial textile may further comprise a coating, and the coating may comprise or be derived from a polar solvent. A polyurethane content of the coating may, but need not, be no more than about 10 wt %, no more than about 9 wt %, no more than about 8 wt %, no more than about 7 wt %, no more than about 6 wt %, no more than about 5 wt %, no more than about 4 wt %, no more than about 3 wt %, no more than about 2 wt %, no more than about 1 wt %, no more than about 0.9 wt %, no more than about 0.8 wt %, no more than about 0.7 wt %, no more than about 0.6 wt %, no more than about 0.5 wt %, no more than about 0.4 wt %, no more than about 0.3 wt %, no more than about 0.2 wt %, no more than about 0.1 wt %, no more than about 0.09 wt %, no more than about 0.08 wt %, no more than about 0.07 wt %, no more than about 0.06 wt %, no more than about 0.05 wt %, no more than about 0.04 wt %, no more than about 0.03 wt %, no more than about 0.02 wt %, or no more than about 0.01 wt %. The coating may, but need not, be substantially free of polyurethane.

In embodiments, the at least one of the first biomaterial textile and the recycled biomaterial textile may further comprise a foaming agent.

In embodiments, the at least one of the first biomaterial textile and the recycled biomaterial textile may have a density of at least about 0.5 g/cm³.

In embodiments, the at least one of the first biomaterial textile and the recycled biomaterial textile may further comprise a filler or reinforcing material selected from the group consisting of fungal hyphae and/or mycelium, cellulose fibers, cardboard, paper, microfibrillated cellulose, nanofibrillated cellulose, recycled fibers, recycled particles, polymeric fibers, flame retardants, colored pigments, and polymeric particles, and combinations thereof. The filler or reinforcing material may, but need not, comprise fungal hyphae and/or mycelium, and the fungal hyphae and/or mycelium may, but need not, have a D50 particle size of about 10 μm to about 30 μm, or of about 20 μm, and/or a D90 particle size of about 35 μm.

In embodiments, the at least one of the first biomaterial textile and the recycled biomaterial textile may further comprise at least one surface modifier selected from the group consisting of a texture modifier, a slip agent, a non-slip agent, an anti-blocking agent, a matting agent, a gloss agent, and combinations thereof.

In embodiments, the second polymer may be a biologically derived elastomer. The biologically derived elastomer may, but need not, be a polyester having an elastic modulus of no more than about 100 MPa, no more than about 50 MPa, or no more than about 20 MPa. The polyester may, but need not, be a segmented polyester. The segmented polyester may, but need not, make up about 50 wt % to about 80 wt %, or about 65 wt % to about 80 wt %, of the polymer component.

In embodiments, a weight ratio between the thermoplastic elastomer and the second polymer may be from about 20:80 to about 90:10.

In embodiments, the method may further comprise embossing or imprinting a pattern or texture into a surface of the recycled biomaterial textile.

In embodiments, the method may further comprise prior to the deforming step, adding a non-recycled biomaterial textile composition fraction to the deformable mixture.

In embodiments, the first biomaterial textile may comprise a finish or topcoat.

In embodiments, the method may further comprise, prior to the deforming step, separating a backing or coating from the first biomaterial textile.

In embodiments, the liquid fraction may comprise an oil.

In another aspect of the present disclosure, a method for making a biomaterial textile comprises deforming a deformable mixture comprising a liquid fraction and one or more biomaterials into a desired spatial configuration, wherein the one or more biomaterials comprise at least one polymer; treating the deformable mixture; and processing the polymer.

In embodiments, the one or more biomaterials may comprise at least two polymers. The at least two polymers may, but need not, comprise Kuraray SEPTON™ BIO SF902 and at least one polymer selected from the group consisting of ethylene-vinyl acetate, DuPont Hytrel® 3078 ECO B thermoplastic polyester elastomer, DuPont Hytrel® 3078 thermoplastic polyester elastomer, and low-density polyethylene.

In embodiments, the deforming step may comprise extruding the deformable mixture.

In embodiments, the processing step may comprise at least one of calendering, compression molding, and injection molding.

In embodiments, the polymer may make up from about 5 wt % to about 70 wt % of the biomaterial textile.

In embodiments, the biomaterial textile may comprise a thermoplastic elastomer in an amount of from about 20 wt % to about 90 wt % of the biomaterial textile; and the biomaterial textile may have an elastic modulus of no more than about 2500 MPa and at least one of (i) an elastic modulus of no more than about 20 MPa and (ii) a Shore A hardness of no more than about 60. The thermoplastic elastomer may, but need not, make up at least about 25 wt % of the biomaterial textile. The thermoplastic elastomer may, but need not, make up at least about 50 wt % of the biomaterial textile.

In embodiments, the thermoplastic elastomer may be a block copolymer comprising first and second polymer blocks. The first polymer block may, but need not, comprise a structural unit derived from one or more farnesenes. The structural unit derived from one or more farnesenes may, but need not, differ from the one or more farnesenes from which it is derived in that at least about 30%, at least about 40%, at least about 50%, at least about 60%, at least about 70%, at least about 80%, at least about 90%, or about 100% of carbon-carbon bonds that are double bonds in the one or more farnesenes are single bonds in the structural unit. The second polymer block may, but need not, comprise a structural unit derived from an aromatic vinyl monomer.

In embodiments, the polymer may make up no more than about 55 wt % of the biomaterial textile.

In embodiments, the polymer may be selected from the group consisting of a thermoplastic polyester elastomer, an ethylene-vinyl acetate, a low-density polyethylene, a styrene-butadiene-styrene block copolymer, a styrene-ethylene-butylene-styrene block copolymer, a styrene-ethylene-propylene-styrene block copolymer, a styrene-ethylene-butadiene-styrene block copolymer, and combinations thereof. The polymer may, but need not, comprise an ethylene-vinyl acetate wherein at least one of the following is true: (i) vinyl acetate monomers make up at least about 11%, at least about 12%, at least about 13%, at least about 14%, at least about 15%, at least about 16%, at least about 17%, at least about 18%, or at least about 19% of the ethylene-vinyl acetate on a molar or weight basis, (ii) the ethylene-vinyl acetate has a melt flow rate, at 190° C. and 2.16 kg, of about 2.1 grams per 10 minutes, (iii) the ethylene vinyl-acetate has an elastic modulus of about 20 MPa, and (iv) a proportion of carbon in the second polymer that is renewable, recyclable, and/or biologically derived is at least about 70% or at least about 80%.

In embodiments, the biomaterial textile may further comprise from about 1 wt % to about 10 wt % of a compatibilizer. The compatibilizer may, but need not, be selected from the group consisting of a polyolefin-octene-maleic anhydride copolymer, a polybutadiene-maleic anhydride copolymer, a polyolefin-carboxylic acid copolymer, a poly(farnesene) itaconic acid graft copolymer, a poly(farnesene) maleic anhydride graft copolymer, an epoxidized vegetable oil, an alkyl ester of an epoxidized vegetable oil, a rosin derivative, a polyester oligomer, a dicarboxylic acid ester, an ester of citric acid, a diether, a polyether oligomer, and combinations thereof.

In embodiments, the elastic modulus may be no more than about 1 MPa.

In embodiments, the thermoplastic elastomer may comprise a 1,3-diene monomer selected from the group consisting of one or more farnesenes, myrcene, butadiene, isoprene, and combinations thereof.

In embodiments, the thermoplastic elastomer may comprise an aromatic vinyl monomer selected from the group consisting of styrene, α-methylstyrene, 4-methylstyrene, limonene, and combinations thereof. A styrene:farnesene weight ratio in the thermoplastic elastomer may, but need not, be from about 5:95 to about 50:50. The aromatic vinyl monomer may, but need not, be styrene, and the styrene may, but need not, make up from about 15 wt % to about 22 wt % of the thermoplastic elastomer.

In embodiments, the polymer may have a tensile strength of from about 10 MPa to about 50 MPa.

In embodiments, the polymer may have a density of from about 0.94 g/cm³ to about 1.28 g/cm³.

In embodiments, the polymer may have a strain at break of from about 100% to about 1000%.

In embodiments, the polymer may have a Shore D hardness of from about 24 to about 70.

In embodiments, the polymer may have a melting point of from about 86° C. to about 221° C.

In embodiments, the polymer may be capable of being bonded by at least one of a roasted hydrocarbon adhesive, a mixed-protein adhesive, a gelatin adhesive, a keratin adhesive, a fibrin adhesive, a wax adhesive, a starch adhesive, a dextrin adhesive, a polysaccharide adhesive, a tree gum or resin adhesive, a latex rubber cement adhesive, a methyl cellulose adhesive, a ketone adhesive, a dichloromethane adhesive, an acrylonitrile adhesive, a cyanoacrylate adhesive, a methyl acrylate adhesive, an ethylene-vinyl acetate adhesive, a polyolefin adhesive, a polyamide adhesive, a polyester adhesive, a polyurethane adhesive, a polycaprolactone adhesive, a phenol formaldehyde resin adhesive, a urea-formaldehyde adhesive, a polysulfide adhesive, an epoxy resin adhesive, a polyvinyl adhesive, a silicone resin adhesive, and a silyl modified polymer adhesive.

In embodiments, a polyurethane content of the biomaterial textile may be no more than about 10 wt %, no more than about 9 wt %, no more than about 8 wt %, no more than about 7 wt %, no more than about 6 wt %, no more than about 5 wt %, no more than about 4 wt %, no more than about 3 wt %, no more than about 2 wt %, no more than about 1 wt %, no more than about 0.9 wt %, no more than about 0.8 wt %, no more than about 0.7 wt %, no more than about 0.6 wt %, no more than about 0.5 wt %, no more than about 0.4 wt %, no more than about 0.3 wt %, no more than about 0.2 wt %, no more than about 0.1 wt %, no more than about 0.09 wt %, no more than about 0.08 wt %, no more than about 0.07 wt %, no more than about 0.06 wt %, no more than about 0.05 wt %, no more than about 0.04 wt %, no more than about 0.03 wt %, no more than about 0.02 wt %, or no more than about 0.01 wt %. The biomaterial textile may, but need not, be substantially free of polyurethanes.

In embodiments, a polyvinyl chloride content of the biomaterial textile may be no more than about 10 wt %, no more than about 9 wt %, no more than about 8 wt %, no more than about 7 wt %, no more than about 6 wt %, no more than about 5 wt %, no more than about 4 wt %, no more than about 3 wt %, no more than about 2 wt %, no more than about 1 wt %, no more than about 0.9 wt %, no more than about 0.8 wt %, no more than about 0.7 wt %, no more than about 0.6 wt %, no more than about 0.5 wt %, no more than about 0.4 wt %, no more than about 0.3 wt %, no more than about 0.2 wt %, no more than about 0.1 wt %, no more than about 0.09 wt %, no more than about 0.08 wt %, no more than about 0.07 wt %, no more than about 0.06 wt %, no more than about 0.05 wt %, no more than about 0.04 wt %, no more than about 0.03 wt %, no more than about 0.02 wt %, or no more than about 0.01 wt % of the biomaterial textile. The biomaterial textile may, but need not, be substantially free of polyvinyl chlorides.

In embodiments, materials that are renewable, recyclable, or both may make up at least about 50 wt %, at least about 55 wt %, at least about 60 wt %, at least about 65 wt %, at least about 70 wt %, at least about 75 wt %, at least about 80 wt %, at least about 85 wt %, at least about 90 wt %, at least about 91 wt %, at least about 92 wt %, at least about 93 wt %, at least about 94 wt %, at least about 95 wt %, at least about 96 wt %, at least about 97 wt %, at least about 98 wt %, at least about 99 wt %, at least about 99.1 wt %, at least about 99.2 wt %, at least about 99.3 wt %, at least about 99.4 wt %, at least about 99.5 wt %, at least about 99.6 wt %, at least about 99.7 wt %, at least about 99.8 wt %, at least about 99.9 wt %, at least about 99.91 wt %, at least about 99.92 wt %, at least about 99.93 wt %, at least about 99.94 wt %, at least about 99.95 wt %, at least about 99.96 wt %, at least about 99.97 wt %, at least about 99.98 wt %, or at least about 99.99 wt % of the biomaterial textile. Substantially all of the biomaterial textile may, but need not, be made up of materials that are renewable, recyclable, or both.

In embodiments, the biomaterial textile may further comprise a coating, and the coating may comprise or be derived from a polar solvent. A polyurethane content of the coating may, but need not, be no more than about 10 wt %, no more than about 9 wt %, no more than about 8 wt %, no more than about 7 wt %, no more than about 6 wt %, no more than about 5 wt %, no more than about 4 wt %, no more than about 3 wt %, no more than about 2 wt %, no more than about 1 wt %, no more than about 0.9 wt %, no more than about 0.8 wt %, no more than about 0.7 wt %, no more than about 0.6 wt %, no more than about 0.5 wt %, no more than about 0.4 wt %, no more than about 0.3 wt %, no more than about 0.2 wt %, no more than about 0.1 wt %, no more than about 0.09 wt %, no more than about 0.08 wt %, no more than about 0.07 wt %, no more than about 0.06 wt %, no more than about 0.05 wt %, no more than about 0.04 wt %, no more than about 0.03 wt %, no more than about 0.02 wt %, or no more than about 0.01 wt %. The coating may, but need not, be substantially free of polyurethane.

In embodiments, the biomaterial textile may further comprise a foaming agent.

In embodiments, the biomaterial textile may have a density of at least about 0.5 g/cm³.

In embodiments, the biomaterial textile may further comprise a filler or reinforcing material selected from the group consisting of fungal hyphae and/or mycelium, cellulose fibers, cardboard, paper, microfibrillated cellulose, nanofibrillated cellulose, recycled fibers, recycled particles, polymeric fibers, flame retardants, colored pigments, and polymeric particles, and combinations thereof. The filler or reinforcing material may, but need not, comprise fungal hyphae and/or mycelium, and the fungal hyphae and/or mycelium may, but need not, have a D50 particle size of about 10 μm to about 30 μm, or of about 20 μm, and/or a D90 particle size of about 35 μm.

In embodiments, the biomaterial textile may further comprise at least one surface modifier selected from the group consisting of a texture modifier, a slip agent, a non-slip agent, an anti-blocking agent, a matting agent, a gloss agent, and combinations thereof.

In embodiments, the polymer may be a biologically derived elastomer. The biologically derived elastomer may, but need not, be a polyester having an elastic modulus of no more than about 100 MPa, no more than about 50 MPa, or no more than about 20 MPa. The polyester may, but need not, be a segmented polyester. The segmented polyester may, but need not, make up about 50 wt % to about 80 wt %, or about 65 wt % to about 80 wt %, of the polymer component.

In embodiments, the at least one polymer may comprise a thermoplastic elastomer and a second polymer, and a weight ratio between the thermoplastic elastomer and the polymer may be from about 20:80 to about 90:10.

In embodiments, the method may further comprise embossing or imprinting a pattern or texture into a surface of the recycled biomaterial textile.

In embodiments, the processing step may comprise cross-linking the polymer.

In embodiments, the method may further comprise subjecting the biomaterial textile to at least one of treatment with a primer, corona treatment, flame treatment, and plasma treatment; and applying a coating to the biomaterial textile.

In embodiments, the method may further comprise imparting a desired color, pattern, or texture to the biomaterial textile. The imparting step may, but need not, comprise at least one of adding a pigment to the deformable mixture, laser-cutting or laser-etching a surface of the biomaterial textile, spraying a colored coating onto a surface of the biomaterial textile, applying a transfer film to a surface of the biomaterial textile, and embossing a surface of the biomaterial textile.

In embodiments, the liquid fraction may comprise an oil.

In another aspect of the present disclosure, a biomaterial textile composition comprises a polymer component, wherein the polymer component comprises at least 20 wt % of a thermoplastic elastomer block copolymer, wherein the thermoplastic elastomer block copolymer comprises a first block comprising a polymeric composition selected from the group consisting of polyfarnesene, hydrogenated polyfarnesene, poly(β-farnesene), hydrogenated poly(β-farnesene), polymyrcene, hydrogenated polymyrcene, poly(β-myrcene), hydrogenated poly(β-myrcene), polybutadiene, hydrogenated polybutadiene, polyisoprene, hydrogenated polyisoprene, polyocimene, hydrogenated polyocimene, polyalloocimene, hydrogenated polyalloocimene, polyphellandrene, hydrogenated polyphellandrene, poly(cyclic 1,3-diene), hydrogenated poly(cyclic 1,3-diene), polymyrcenol, hydrogenated polymyrcenol, poly(β-myrcenol), hydrogenated poly(β-myrcenol), polyipsdienol, hydrogenated polyipsdienol, poly(ethylidene norbornene), poly(dicyclopentadiene), poly(vinyl norbornene), poly(alkyl acrylate), poly(ester) acrylate, poly(ether) acrylate, poly(vinyl ester), poly(vinyl alcohol), poly(vinyl nitrile), poly(ether), poly(ester), poly(carbonate), polyethylene, polypropylene, a polyitaconate, polyisobutylene, polyoctene, polyhexene, polybutylene, polymethyl pentene, polysiloxane, and combinations thereof; and a second block comprising a polymeric composition selected from the group consisting of polymerized aromatic vinyl compound, poly(methyl methacrylate), polypropylene, polyethylene, a polyimide, polyisobornyl methacrylate, polyisobornyl acrylate, and combinations thereof, wherein the thermoplastic elastomer block copolymer has an elastic modulus of no more than about 10 MPa; and the biomaterial textile composition has at least one of (i) an elastic modulus of no more than about 25 MPa, (ii) a Shore A hardness of no more than about 70, and (iii) a tensile stress at 5% tensile strain of no more than about 1.2 MPa.

In embodiments, the polymeric composition of the first block may comprise a structural unit derived from one or more farnesenes, and the structural unit derived from one or more farnesenes may differ from the one or more farnesenes from which it is derived in that at least about 30%, at least about 40%, at least about 50%, at least about 60%, at least about 70%, at least about 80%, at least about 90%, or about 100% of carbon-carbon bonds that are double bonds in the one or more farnesenes are single bonds in the structural unit.

In embodiments, the second block may comprise styrene monomer units in an amount of about 17 to about 22 wt % of the thermoplastic elastomer block copolymer.

In embodiments, a weight ratio of the first block to the second block may be from about 50:50 to about 95:5.

In embodiments, a proportion of carbon in the thermoplastic elastomer block copolymer that is renewable, recyclable, and/or biologically derived may be at least about 70% or at least about 80%.

In embodiments, the thermoplastic elastomer block copolymer may make up at least about 40 wt % of the polymer component.

In embodiments, the biomaterial textile composition may further comprise from about 1 wt % to about 10 wt % of a compatibilizer. The compatibilizer may, but need not, be selected from the group consisting of a polyolefin-octene-maleic anhydride copolymer, a polybutadiene-maleic anhydride copolymer, a polyolefin-carboxylic acid copolymer, a poly(farnesene) itaconic acid graft copolymer, a poly(farnesene) maleic anhydride graft copolymer, an epoxidized vegetable oil, an alkyl ester of an epoxidized vegetable oil, a rosin derivative, a polyester oligomer, a dicarboxylic acid ester, an ester of citric acid, a diether, a polyether oligomer, and combinations thereof.

In embodiments, the elastic modulus of the biomaterial textile composition may be no more than about 20 MPa.

In embodiments, a polyurethane content of the biomaterial textile composition may be no more than about 10 wt %, no more than about 9 wt %, no more than about 8 wt %, no more than about 7 wt %, no more than about 6 wt %, no more than about 5 wt %, no more than about 4 wt %, no more than about 3 wt %, no more than about 2 wt %, no more than about 1 wt %, no more than about 0.9 wt %, no more than about 0.8 wt %, no more than about 0.7 wt %, no more than about 0.6 wt %, no more than about 0.5 wt %, no more than about 0.4 wt %, no more than about 0.3 wt %, no more than about 0.2 wt %, no more than about 0.1 wt %, no more than about 0.09 wt %, no more than about 0.08 wt %, no more than about 0.07 wt %, no more than about 0.06 wt %, no more than about 0.05 wt %, no more than about 0.04 wt %, no more than about 0.03 wt %, no more than about 0.02 wt %, or no more than about 0.01 wt %. The biomaterial textile composition may, but need not, be substantially free of polyurethanes.

In embodiments, a polyvinyl chloride content of the biomaterial textile composition may be no more than about 10 wt %, no more than about 9 wt %, no more than about 8 wt %, no more than about 7 wt %, no more than about 6 wt %, no more than about 5 wt %, no more than about 4 wt %, no more than about 3 wt %, no more than about 2 wt %, no more than about 1 wt %, no more than about 0.9 wt %, no more than about 0.8 wt %, no more than about 0.7 wt %, no more than about 0.6 wt %, no more than about 0.5 wt %, no more than about 0.4 wt %, no more than about 0.3 wt %, no more than about 0.2 wt %, no more than about 0.1 wt %, no more than about 0.09 wt %, no more than about 0.08 wt %, no more than about 0.07 wt %, no more than about 0.06 wt %, no more than about 0.05 wt %, no more than about 0.04 wt %, no more than about 0.03 wt %, no more than about 0.02 wt %, or no more than about 0.01 wt % of the biomaterial textile composition. The biomaterial textile composition may, but need not, be substantially free of polyvinyl chlorides.

In embodiments, materials that are renewable, recyclable, or both may make up at least about 50 wt %, at least about 55 wt %, at least about 60 wt %, at least about 65 wt %, at least about 70 wt %, at least about 75 wt %, at least about 80 wt %, at least about 85 wt %, at least about 90 wt %, at least about 91 wt %, at least about 92 wt %, at least about 93 wt %, at least about 94 wt %, at least about 95 wt %, at least about 96 wt %, at least about 97 wt %, at least about 98 wt %, at least about 99 wt %, at least about 99.1 wt %, at least about 99.2 wt %, at least about 99.3 wt %, at least about 99.4 wt %, at least about 99.5 wt %, at least about 99.6 wt %, at least about 99.7 wt %, at least about 99.8 wt %, at least about 99.9 wt %, at least about 99.91 wt %, at least about 99.92 wt %, at least about 99.93 wt %, at least about 99.94 wt %, at least about 99.95 wt %, at least about 99.96 wt %, at least about 99.97 wt %, at least about 99.98 wt %, or at least about 99.99 wt % of the biomaterial textile composition. Substantially all of the biomaterial textile composition may, but need not, be made up of materials that are renewable, recyclable, or both.

In embodiments, the biomaterial textile composition may further comprise a foaming agent.

In embodiments, the biomaterial textile composition may have a density of at least about 0.5 g/cm³.

In embodiments, the biomaterial textile composition may further comprise a filler or reinforcing material selected from the group consisting of cellulose fibers, cardboard, paper, microfibrillated cellulose, nanofibrillated cellulose, recycled fibers, recycled particles, polymeric fibers, flame retardants, colored pigments, polymeric particles, and combinations thereof.

In embodiments, the biomaterial textile composition may further comprise a biomass component. The biomass component may, but need not, comprise fungal hyphae and/or mycelium. The biomass component may, but need not, make up at least about 10 wt %, at least about 15 wt %, at least about 20 wt %, at least about 25 wt %, at least about 30 wt %, at least about 35 wt %, at least about 40 wt %, at least about 45 wt %, or at least about 50 wt % of the biomaterial textile composition.

In embodiments, the polymer component may further comprise at least one surface modifier selected from the group consisting of a texture modifier, a slip agent, a non-slip agent, an anti-blocking agent, a matting agent, a gloss agent, and combinations thereof.

In embodiments, the thermoplastic elastomer block copolymer may comprise Kuraray SEPTON™ BIO SF902, and the Kuraray SEPTON™ BIO SF902 may make up about 20 wt % to about 80 wt % of the polymer component. The Kuraray SEPTON™ BIO SF902 may, but need not, make up about 20 wt % to about 55 wt % of the polymer component.

In embodiments, the polymer component may further comprise a second polymer.

In embodiments, the second polymer may make up no more than about 80 wt % of the polymer component. The second polymer may, but need not, make up no more than about 45 wt % of the polymer component.

In embodiments, the second polymer may be selected from the group consisting of a thermoplastic polyester elastomer, an ethylene-vinyl acetate, a low-density polyethylene, a styrene-butadiene-styrene block copolymer, a styrene-ethylene-butylene-styrene block copolymer, a styrene-ethylene-propylene-styrene block copolymer, a styrene-ethylene-butadiene-styrene block copolymer, and combinations thereof. The second polymer may, but need not, be an ethylene-vinyl acetate wherein at least one of the following is true: (i) vinyl acetate monomers make up at least about 11%, at least about 12%, at least about 13%, at least about 14%, at least about 15%, at least about 16%, at least about 17%, at least about 18%, or at least about 19% of the ethylene-vinyl acetate on a molar or weight basis, (ii) the ethylene-vinyl acetate has a melt flow rate, at 190° C. and 2.16 kg, of about 2.1 grams per 10 minutes, (iii) the ethylene vinyl-acetate has an elastic modulus of about 20 MPa, and (iv) a proportion of carbon in the second polymer that is renewable, recyclable, and/or biologically derived is at least about 70% or at least about 80%.

In embodiments, the second polymer may be selected from the group consisting of Braskem I'm Green™ EVA SVT2180, Braskem I'm Green™ low-density polyethylene SBC818, Braskem I'm Green™ linear low density polyethylene, Braskem I'm Green™ high-density polyethylene, Styroflex® 2G66 B60, Pebax® thermoplastic elastomers, Dryflex® Green, DuPont Hytrel® 3078 thermoplastic polyester elastomer, DuPont Hytrel® 3078 ECO B thermoplastic polyester elastomer, polybutylene succinate, polyhydroxy alkanoates, polylactic acid, nylon-11, polyethylene furanoate, Keltan Eco EPDM, and combinations thereof.

In embodiments, a molecular weight of at least one of the thermoplastic elastomer and the second polymer may be about 20 kDa to about 300 kDa.

In embodiments, the second polymer may have a tensile strength of from about 10 MPa to about 50 MPa.

In embodiments, the second polymer may have a density of from about 0.90 g/cm³ to about 1.28 g/cm³.

In embodiments, the second polymer may have a strain at break of from about 100% to about 1000%.

In embodiments, the second polymer may have a Shore D hardness of from about 24 to about 70.

In embodiments, the second polymer may have a melting point of from about 86° C. to about 221° C.

In embodiments, the second polymer may be capable of being bonded by at least one of a roasted hydrocarbon adhesive, a mixed-protein adhesive, a gelatin adhesive, a keratin adhesive, a fibrin adhesive, a wax adhesive, a starch adhesive, a dextrin adhesive, a polysaccharide adhesive, a tree gum or resin adhesive, a latex rubber cement adhesive, a methyl cellulose adhesive, a ketone adhesive, a dichloromethane adhesive, an acrylonitrile adhesive, a cyanoacrylate adhesive, a methyl acrylate adhesive, an ethylene-vinyl acetate adhesive, a polyolefin adhesive, a polyamide adhesive, a polyester adhesive, a polyurethane adhesive, a polycaprolactone adhesive, a phenol formaldehyde resin adhesive, a urea-formaldehyde adhesive, a polysulfide adhesive, an epoxy resin adhesive, a polyvinyl adhesive, a silicone resin adhesive, and a silyl modified polymer adhesive.

In embodiments, the second polymer may be a biologically derived elastomer. The biologically derived elastomer may, but need not, be a polyester having an elastic modulus of no more than about 100 MPa, no more than about 50 MPa, or no more than about 20 MPa. The polyester may, but need not, be a segmented polyester. The segmented polyester may, but need not, make up about 50 wt % to about 80 wt %, or about 65 wt % to about 80 wt %, of the polymer component.

In embodiments, a weight ratio between the thermoplastic elastomer and the second polymer may be from about 20:80 to about 90:10.

In embodiments, the thermoplastic elastomer and the second polymer may collectively make up at least about 50 wt %, at least about 55 wt %, at least about 60 wt %, at least about 65 wt %, at least about 70 wt %, at least about 75 wt %, at least about 80 wt %, at least about 85 wt %, at least about 90 wt %, at least about 95 wt %, at least about 96 wt %, at least about 97 wt %, at least about 98 wt %, or at least about 99 wt % of the biomaterial textile composition.

In embodiments, the polymer component may further comprise a third polymer. The polymer component may, but need not, further comprise a fourth polymer.

In embodiments, the biomaterial textile composition may further comprise a topcoat.

In embodiments, the biomaterial textile composition may further comprise one or more additives and may not comprise a topcoat.

In embodiments, the biomaterial textile composition may have a water uptake of no more than about 100%, no more than about 95%, no more than about 90%, no more than about 85%, no more than about 80%, no more than about 75%, no more than about 70%, no more than about 65%, no more than about 60%, no more than about 55%, no more than about 50%, no more than about 45%, no more than about 40%, no more than about 35%, no more than about 30%, no more than about 25%, no more than about 20%, no more than about 15%, no more than about 10%, no more than about 5%, no more than about 4%, no more than about 3%, no more than about 2%, or no more than about 1%.

In another aspect of the present disclosure, a biomaterial textile comprises a biomaterial textile composition as disclosed herein, wherein the biomaterial textile further comprises one or both of (i) a coating, wherein the coating comprises or is derived from a polar solvent, and (ii) a backing layer.

In embodiments, a polyurethane content of the coating may be no more than about 10 wt %, no more than about 9 wt %, no more than about 8 wt %, no more than about 7 wt %, no more than about 6 wt %, no more than about 5 wt %, no more than about 4 wt %, no more than about 3 wt %, no more than about 2 wt %, no more than about 1 wt %, no more than about 0.9 wt %, no more than about 0.8 wt %, no more than about 0.7 wt %, no more than about 0.6 wt %, no more than about 0.5 wt %, no more than about 0.4 wt %, no more than about 0.3 wt %, no more than about 0.2 wt %, no more than about 0.1 wt %, no more than about 0.09 wt %, no more than about 0.08 wt %, no more than about 0.07 wt %, no more than about 0.06 wt %, no more than about 0.05 wt %, no more than about 0.04 wt %, no more than about 0.03 wt %, no more than about 0.02 wt %, or no more than about 0.01 wt %. The coating may, but need not, be substantially free of polyurethane.

In another aspect of the present disclosure, a biomaterial textile composition comprises an at least partially hydrogenated styrene/farnesene block copolymer having at least one characteristic selected from the group consisting of (i) a Shore A hardness of about 6 to about 10, (ii) a styrene content of about 10 wt % to about 25 wt %, and (iii) a melt flow rate at 230° C. and 10 kg of about 50 g/10 min to about 60 g/10 min; and a polyester, having a Young's modulus of no more than about 600 MPa and derived from polymerization of one or more diacids with one or more diols, wherein the one or more diols comprise 1,4-butanediol, a weight ratio of the at least partially hydrogenated styrene/farnesene block copolymer to the polyester is at least about 0.4, and the biomaterial textile composition has at least one characteristic selected from the group consisting of (iv) a Shore A hardness of no more than about 70 and (v) a tensile stress at 5% tensile strain of no more than about 1.2 MPa.

In embodiments, the biomaterial textile composition may have an elastic modulus of no more than about 25 MPa.

In embodiments, the at least partially hydrogenated styrene/farnesene block copolymer may comprise Kuraray SEPTON™ BIO SF902.

In embodiments, the polyester may comprise polybutylene succinate.

In embodiments, the biomaterial textile composition may be in the form of a sheet having a thickness of at least about 0.7 mm. The thickness may, but need not, be about 0.7 mm to about 1 mm.

In embodiments, the biomaterial textile composition may be in the form of a sheet having a thickness of no more than about 0.7 mm. The thickness may, but need not, be about 0.1 mm to about 0.5 mm.

In embodiments, the Shore A hardness of the at least partially hydrogenated styrene/farnesene block copolymer may be about 7 to about 9, or about 8.

In embodiments, the styrene content of the at least partially hydrogenated styrene/farnesene block copolymer may be about 15 wt % to about 20 wt %, or about 18 wt %.

In embodiments, the melt flow rate at 230° C. and 10 kg of the at least partially hydrogenated styrene/farnesene block copolymer may be about 54 g/10 min to about 56 g/10 min.

In another aspect of the present disclosure, a biomaterial textile comprises a layer or sheet of a biomaterial textile composition as disclosed herein; and a backing layer.

While specific embodiments and applications have been illustrated and described, the present disclosure is not limited to the precise configuration and components described herein. Various modifications, changes, and variations which will be apparent to those skilled in the art may be made in the arrangement, operation, and details of the methods and systems disclosed herein without departing from the spirit and scope of the overall disclosure.

As used herein, unless otherwise specified, the terms “about,” “approximately,” etc., when used in relation to numerical limitations or ranges, mean that the recited limitation or range may vary by up to 10%. By way of non-limiting example, “about 750” can mean as little as 675 or as much as 825, or any value therebetween. When used in relation to ratios or relationships between two or more numerical limitations or ranges, the terms “about,” “approximately,” etc. mean that each of the limitations or ranges may vary by up to 10%; by way of non-limiting example, a statement that two quantities are “approximately equal” can mean that a ratio between the two quantities is as little as 0.9:1.1 or as much as 1.1:0.9 (or any value therebetween), and a statement that a four-way ratio is “about 5:3:1:1” can mean that the first number in the ratio can be any value of at least 4.5 and no more than 5.5, the second number in the ratio can be any value of at least 2.7 and no more than 3.3, and so on.

The embodiments and configurations described herein are neither complete nor exhaustive. As will be appreciated, other embodiments are possible utilizing, alone or in combination, one or more of the features set forth above or described in detail below.

### BRIEF DESCRIPTION OF THE DRAWINGS

FIGS. 1A and 1B show the tensile modulus and tensile strength, respectively, of sheets made from varying weight ratios of Septon Bio SF902 (Kuraray Co., Ltd.) and Hytrel 3078 ECO-B (DuPont de Nemours, Inc.).

FIGS. 2A and 2B show the tensile strength and elongation at break, respectively, of sheets made from three types of poly(styrene-farnesene-styrene) block copolymer/segmented bio-polyester blends with additional biomass.

FIG. 3 shows the elastic moduli of biomaterial textile sheets according to the present disclosure as a function of fungal biomass content.

FIG. 4 shows the elastic modulus of sheets made from poly(styrene-farnesene-styrene) block copolymer/poly(styrene-butadiene-styrene) block copolymer blends.

FIG. 5 shows the strain at break of sheets made from varying weight ratios of Septon Bio SF902 and I'm Green EVA SVT2180 (SKYi FKuR Bioplymers Pvt Ltd.).

FIGS. 6A, 6B, and 6C illustrate topcoated and embossed leather analog materials according to the present disclosure.

FIG. 7 illustrates a leather analog material according to the present disclosure in which the aesthetics of hide/true leather are closely matched.

FIGS. 8A and 8B are graphs of elastic moduli, as a function of SF902 content in the non-fungal polymer blend, of blends of ethylene-vinyl acetate (EVA) and low-density polyethylene, respectively, with thermoplastic elastomer and fungal biomass.

FIGS. 9A, 9B, and 9C are graphs of the tensile strength, tensile modulus, and tear force, respectively, of crosslinked and non-crosslinked fungal biomass/thermoplastic elastomer/EVA blends.

FIGS. 10A and 10B illustrate the surface roughness and edge of tearing of thermoplastic elastomer/EVA blends, respectively with and without fungal biomass.

FIG. 11A is an image of an extruded sheet formed by recycling and re-granulating a polyurethane-coated sheet and re-blending the re-granulated material using a twin-screw extruder.

FIG. 11B is an image of reground granules of the sheet illustrated in FIG. 11A.

FIG. 11C illustrates pellets of “100% virgin,” “50% regrind/50% virgin,” and “100% regrind” materials according to Example 15.

FIG. 12A is an image of an extruded sheet of the “100% virgin” material illustrated in FIG. 11C.

FIG. 12B is an image of an extruded sheet of the “50% regrind/50% virgin” material illustrated in FIG. 11C.

### DETAILED DESCRIPTION

Unless defined otherwise, all technical and scientific terms used herein have the same meaning as is commonly understood by one of ordinary skill in the art. All patents, applications, published applications, and other publications to which reference is made herein are incorporated by reference in their entirety. If there is a plurality of definitions for a term herein, the definition provided in the Summary prevails unless otherwise stated.

As used herein, unless otherwise specified, the indefinite article “a” means “one or more.” By way of non-limiting example, any reference herein to “a biologically derived polymer” is to be interpreted as “one or more biologically derived polymers.”

As used herein, unless otherwise specified, the term “acrylate,” when used with reference to a polymer, means that the polymer contains acrylate monomers, methacrylate monomers, or a combination thereof.

As used herein, unless otherwise specified, the term “aqueous” refers to any mixture or solution that includes water. It is to be expressly understood, therefore, that in an “aqueous” solution as that term is used herein, water may be the only solute, one of two or more solutes, the only solvent, or one of two or more solvents.

As used herein, unless otherwise specified, the term “backing material” or “backing layer” refers to a material, or a layer of material, that is added to a composite article to impart one or more desired mechanical and/or structural characteristics (e.g., improved tensile modulus, improved strain at break, increased rigidity/stiffness, etc.). It is to be expressly understood that a backing material or backing layer, as those terms are used herein, need not be disposed on a “back” (i.e., rear, posterior) aspect of a composite article but may be disposed on any exterior aspect (front, back, top, bottom, sides, etc.) or within an interior of the article (e.g., distributed throughout the article, “sandwiched” between layers of other material(s), etc.).

As used herein, unless otherwise specified, the term “biodegradable” refers to a material that, under a given set of conditions (e.g., the conditions specified in ISO 20136:2017, “Leather-determination of degradability by micro-organisms”), degrades by way of biological action at a rate faster than conventional hide/true leather having similar mechanical properties.

As used herein, unless otherwise specified, the term “biomass” refers to a mass of a living or formerly living organism, including fungal, microbial, and plant biomass. Microbial biomass sources can include bacterial, fungal (including higher fungi), and microalgal biomass sources. Plant biomass sources can include any source of plant-based biopolymers such as cellulose, lignin and pectin. By way of non-limiting example, the phrase “filamentous fungal biomass” as used herein refers to a mass of a living or formerly living filamentous fungus.

As used herein, unless otherwise specified, the term “biomaterial” refers to any tissue or other physical material derived from one or more living or formerly living organisms other than animals (e.g., filamentous fungi, plants, bacteria, algae, yeasts, etc.). “Biomaterials,” as that term is used herein, may be biomasses or portions thereof, but may also be materials that are directly or indirectly derived from the organism(s) (e.g., extracts, metabolites, etc.).

As used herein, unless otherwise specified, the term “biomaterial textile” refers to a textile that is made at least partially from biomaterials.

As used herein, unless otherwise specified, the term “biomaterial textile composition” refers to that portion of a textile composition that is (1) made at least partially from biomaterials, and (2) includes all components of the textile composition other than topcoats, topcoat adhesives, and backing materials.

As used herein, unless otherwise specified, the term “colloid” refers to a mixture in which particles of one substance (the “dispersed phase”) are dispersed throughout a volume of a different substance (the “dispersion medium”); for example, the dispersed phase can comprise or consist of microscopic or macroscopic bubbles, particles, etc. Where the dispersed phase and the dispersion medium of a colloid are specifically identified herein, they are separated by a hyphen, with the dispersed phase identified first, e.g., a reference herein to an “oil-water colloid” refers to a colloid in which an oil is the dispersed phase and water is the dispersion medium.

As used herein, unless otherwise specified, the term “colloidal gel” refers to a colloid in which the dispersed phase is a liquid, and the dispersion medium is a solid. Examples of colloidal gels as that term is used herein include but are not limited to agar, hair gel, and opal.

As used herein, unless otherwise specified, the term “degree of swelling” refers to the relative amount of change in the mass of a solid item when the solid is saturated with a liquid. By way of non-limiting example, a solid item that has a mass of 200 g when dry and a mass of 300 g when saturated with water has a degree of swelling in water of 50%, or 0.5. Where the term “degree of swelling” is used herein without explicitly identifying a liquid, the liquid may be assumed to be water.

As used herein, unless otherwise specified, the term “deposit” means to cast, lay down, place, or put a deformable mass of material into a desired spatial configuration, such as by extrusion or other suitable techniques.

As used herein, unless otherwise specified, the term “durable” refers to a material that has at least one of a tear strength of at least about 5 N/mm, a tear force of at least about 5 N, and a tensile strength of at least about 1.5 MPa.

As used herein, unless otherwise specified, the term “elastic modulus” refers to Young's modulus.

As used herein, unless otherwise specified, the term “emulsion” refers to a colloid in which both the dispersed phase and the dispersion medium are liquids. Examples of emulsions as that term is used herein include but are not limited to lotions, latex, and many biological membranes.

As used herein, unless otherwise specified, the terms “hide leather” and “true leather” are interchangeable and each refer to a durable, flexible material created by tanning the hide or skin of an animal.

As used herein, unless otherwise specified, the term “high-density foam material” refers to a solid foam material having a density of more than 3.5 pounds per cubic foot (56 kg/m³).

As used herein, unless otherwise specified, the term “loading ratio” refers to a weight ratio of biomass to polymer in a biomaterial-based material composition.

As used herein, unless otherwise specified, the term “low-density foam material” refers to a solid foam material having a density of 1.5 to 2.5 pounds per cubic foot (24 to 40 kg/m³).

As used herein, unless otherwise specified, the term “mass loss upon soaking” refers to the relative amount of mass lost by a solid item after soaking in a liquid, disregarding the mass of liquid absorbed by the solid item. By way of non-limiting example, a solid item that has a mass of 100 grams when dry and a mass (disregarding the mass of absorbed liquid) of 95 grams after soaking in water has a mass loss upon soaking in water of 5%. Where the term “mass loss upon soaking” is used herein without explicitly identifying a liquid, the liquid may be assumed to be water.

As used herein, unless otherwise specified, the term “medium-density foam material” refers to a solid foam material having a density of 2.5 to 3.5 pounds per cubic foot (40 to 56 kg/m³).

As used herein, unless otherwise specified, the term “particle” refers to a small, discrete, localized object to which can be ascribed chemical or physical properties such as volume, density, and/or mass. “Particles,” as that term is used herein, may be microscopic or macroscopic; may be in the gas (e.g., air bubbles), liquid (e.g., droplets of the dispersed phase in an emulsion), or solid (e.g., granules of a powder) phase; and may take any of a variety of shapes (e.g., spheres, oblate spheroids, fibers, tubes, rods, etc.). Particles in the solid phase may be referred to herein as “particulates” or “particulate matter.”

As used herein, unless otherwise specified, the term “sheet” refers to a layer of solid material having a generally flat or planar shape and a high ratio of surface area to thickness.

As used herein, unless otherwise specified, the term “sol” refers to a colloid in which the dispersed phase is a solid and the dispersion medium is a liquid. Examples of sols as that term is used herein include but are not limited to blood, mud, paint, and pigmented ink.

As used herein, unless otherwise specified, the term “solid aerosol” refers to a colloid in which the dispersed phase is a solid and the dispersion medium is a gas. Examples of solid aerosols as that term is used herein include smoke, ice clouds, and atmospheric particulates.

As used herein, unless otherwise specified, the term “solid sol” refers to a colloid in which both the dispersed phase and the dispersion medium are solids. Examples of solid sols as that term is used herein include cranberry glass.

As used herein, unless otherwise specified, the term “tannin” refers generally to any molecule that forms strong bonds with protein structures, and more particularly to a molecule that, when applied to hide leather, bonds strongly to protein moieties within the collagen structures of the skin to improve the strength and degradation resistance of the leather. The most commonly used types of tannins are vegetable tannins, i.e., tannins extracted from trees and plants, and chromium tannins such as chromium (III) sulfate. Other examples of tannins as that term is used herein include modified naturally derived polymers, biopolymers, and salts of metals other than chromium, e.g., aluminum silicate (sodium aluminum silicate, potassium aluminum silicate, etc.).

As used herein, unless otherwise specified, the term “textile” refers to an article made primarily or entirely of interlacing fibers.

As used herein, unless otherwise specified, the term “textile composition” refers to any material composition from which a textile (as that term is used herein) can be made. Thus, by way of non-limiting example, aramid fibers, cellulose triacetate fibers, cotton, glass fibers, hemp, jute, linen, nylon, olefin fiber, polyacrylonitrile fibers, rayon, silk, spandex, and wool are “textile compositions” as that term is used herein, because textiles can be made from each of these materials.

As used herein, unless otherwise specified, the term “topcoat” refers to a material, or a layer of material, that coats at least one external surface of a biomaterial textile composition. It is to be expressly understood that a topcoat, as that term is used herein, need not be disposed on a “top” surface of a biomaterial textile composition but may be disposed on any exterior surface (front, back, top, bottom, sides, etc.) thereof.

As used herein, unless otherwise specified, the term “very low-density foam material” refers to a solid foam material having a density of less than 1.5 pounds per cubic foot (24 kg/m³).

As used herein, unless otherwise specified, the term “water uptake” refers to the degree of swelling of a solid material when the solid material is saturated with water.

Any specifically quantified values set forth herein for rheological, thermal, mechanical, electrical, or other similar properties of materials may, unless otherwise specified, be assumed to be derived or measured by a relevant and applicable standard as may be known and generally accepted in the art, such as ISO or ASTM standards. By way of non-limiting example, values for melt flow rate, elastic modulus, and Shore hardness as set forth herein may, unless otherwise specified, be assumed to be derived or measured according to ISO 1133 and/or ASTM D 1238, ISO 527 and/or ASTM E 111, and ISO 7619 and/or ASTM D 2240, respectively

The present disclosure provides biomaterial-based materials, e.g., textiles, having advantageous and beneficial properties, and methods for manufacturing such biomaterial-based materials. In general, the biomaterial-based materials of the present disclosure comprise a blend of biomaterial-derived elastomers, the use of which can advantageously provide the biomaterial-based material with significant drapability and toughness/durability while minimizing, and in many embodiments eliminating, the use of polyurethanes and polyvinyl chlorides.

Biomaterial-based materials, and particularly biomaterial-based textiles, according to the present disclosure generally include a blend of at least two polymers: a thermoplastic elastomer and a second polymer, and optionally including any number (third, fourth, etc.) of additional polymers. The present inventors have found that blends of these two types of polymers can yield biomaterial textiles and other biomaterial-based materials with certain advantageous and desirable properties, such as low hardness (e.g., low Shore A hardness), low elastic modulus (i.e., low stiffness, high drapability, etc.), high tear strength, and amenability to processing by, e.g., calendering, extrusion, and/or molding. This benefit is unexpected in that, in general, polymers of either of these two types, on their own, are not suitable for leather analog materials or other similar textiles due to deficiencies in various mechanical, aesthetic, and/or textural properties, but an appropriate blend or mixture of these polymers can yield a biomaterial-based material characterized by properties superior to those of either type of polymer alone. By way of non-limiting example, the present inventors have found that certain commercially available biomaterial-based (1,3-diene) polymers, such as polyfarnesenes and poly(farnesene-block-styrene) copolymers (e.g., Kuraray SEPTON™ BIO 902 and/or Kuraray SEPTON™ BIO 904), have an exceptionally low elastic modulus (less than 1 MPa) and low hardness (a Shore A hardness of less than 60), providing these polymers with excellent drapability and making them suitable for soft-touch applications, but have relatively low tensile strength (about 5 MPa) and are very difficult to process because they have very low melt strength and thus cannot be extruded into high-quality films; by contrast, the present inventors have also found that certain other biomaterial-based polymers (e.g., DuPont Hytrel® 3078 ECO B (a polyester), Braskem I'm Green™ bio-based ethylene vinyl acetate (EVA), and biomaterial-based styrene-butadiene (e.g., styrene-ethylene-butadiene-styrene (SEBS)) copolymers such as Dryflex® Green and Styroflex®) have high tensile strength, high tear strength, and easy processability, but are poorly drapable because they have higher elastic moduli (at least about 15 MPa) and have higher hardness (a Shore A hardness of at least about 60). By blending these different types of biomaterial-derived polymers, the drawbacks of each can be overcome to provide a biomaterial-derived polymeric blend characterized by an advantageous combination of high strength, easy processing, low elastic modulus, and superior bally flex performance, also referred to as fatigue resistance (resistance to either permanent deformation or fracture under a cyclic load). Bally flex performance (as measured according to ISO 5402) of biomaterial textiles and other biomaterial-based materials comprising the disclosed blends, including coated biomaterial textile compositions, may achieve at least about 50,000, and in some cases at least about 80,000 or least about 100,000 flex cycles without exhibiting noticeable cracks or breaks in the polymer composite or the coating layer.

In some embodiments, any one or more of a third polymer, a fourth polymer, etc. may act as a processing aid to improve the processability of the biomaterial textile composition. By way of non-limiting example, where the thermoplastic elastomer and the second polymer have poor melt characteristics, the extrusion quality of the films may be improved by incorporating a third polymer with improved melt characteristics; this improvement in quality may correlate with a reduction in torque applied by the extruder, which can be attributed to improved flow properties of the melted polymer blend as a result of, e.g., a reduction in viscosity and/or an increase in slip velocity of the melt. Introduction of the third polymer may therefore, for example, enable higher amounts of the thermoplastic elastomer to be used, and thus the production of a softer material, while maintaining the quality of the extruded sheet.

Methods of Manufacturing and/or Recycling Biomaterial-Based Materials

The biomaterial-based materials of the present disclosure may be made by any of a number of suitable processes, including, but by no means limited to, extrusion processes. The method of making a biomaterial textile includes deforming a deformable mixture comprising a liquid fraction and one or more biomaterials into a desired spatial configuration, wherein the one or more biomaterials comprise a polymer. By way of non-limiting example, a deformable mixture comprising a blend of polymers as described herein may be produced on a twin-screw extruder or using a rubber kneader such as a Banbury mixer. This deformable mixture may then be formed into sheets by extruding through a sheet die or by calendering or formed into other desired shapes and/or spatial configurations by compression molding or injection molding. The deformable mixture is then treated to form the biomaterial textile. In some embodiments, the treating step may comprise removing at least a portion of the liquid fraction from the deformable mixture, heating the deformable mixture, cooling the deformable mixture, causing a chemical reaction in the deformable mixture (e.g., to cause curing or hardening of the deformable mixture), or a combination thereof. In embodiments in which the treating step comprises removing at least a portion of the liquid fraction from the deformable mixture, this may be carried out, by way of non-limiting example, by heating the deformable mixture, applying a negative pressure to the deformable mixture, radiofrequency irradiation of the deformable mixture, microwave irradiation of the deformable mixture, or a combination thereof; in some embodiments, a rate at which the at least a portion of the liquid fraction is removed may be controlled, optimized, selected, and/or tuned to provide a preselected porosity to the finished biomaterial-based material. In some embodiments, the method may also include treating the polymer by, e.g., calendering, compression molding, and/or injection molding. In some embodiments, the liquid fraction may be an oil; more particularly, certain embodiments of biomaterial textiles according to the present disclosure comprise an extruded mixture of a thermoplastic elastomer block copolymer and an oil. Additionally or alternatively, the temperature of the liquid fraction may be above room temperature and the liquid fraction may comprise one or more polymers that are solid at room temperature. Additionally or alternatively, the liquid fraction may comprise one or more carrier fluids, dispersion media, solvents, etc.

Often, the deformable mixture may be a substantially viscoplastic material that holds its shape (i.e., remains substantially rigid) at low stresses but can be made to deform and/or flow when a stress in excess of the material's yield stress is applied. Materials of this kind are known in the art as Bingham plastics.

In many embodiments, the amenability of polymer blends as disclosed herein to processing in a fluid and/or deformable state (e.g., extrusion, compression molding, injection molding, melt processing, etc.) also allows for easy recycling and/or reuse of articles made from the biomaterial-based material, or of the biomaterials themselves. Stated slightly differently, an article made from biomaterial-based materials according to the present disclosure (or biomaterial components thereof) may be able to be recycled, reshaped, etc. merely by heating the article to the melting temperature of the biomaterial-based material (or a temperature at which the biomaterial-based material is in a viscoplastic state) to form a new deformable mixture; deforming (e.g., by extrusion, molding, etc.) the new deformable mixture into a spatial configuration corresponding to a new or recycled article; and treating the deformable mixture (as described elsewhere throughout this disclosure) to form the new or recycled article; in some embodiments of these recycling methods, the original article may include one or more backing layers or coatings as disclosed herein, which may (but need not) be separated or removed from the article prior to recycling. Optionally, these recycling methods may further include steps of adding or removing components of the deformable mixture and/or biomaterial-based material, such that the new or recycled article has a different material composition than the original article; by way of non-limiting example, biomaterial components of an original article may be separated from a remainder of the original article for further processing (either alone or in combination with other materials) into a different article. Additionally or alternatively, these recycling methods may further include steps of combining “new” or “fresh” biomaterial-based material with “old” or “used” biomaterial-based material to form a new article; the weight ratio of “fresh” to “used” biomaterial-based material in these methods may be in any range of A:B to C:D, where A and B are non-negative integers whose sum is 100, C and D are non-negative integers whose sum is 100, and A is less than C. Thus, in some embodiments, materials that are renewable, recyclable, and/or biologically derived may make up at least about 50 wt %, at least about 55 wt %, at least about 60 wt %, at least about 65 wt %, at least about 70 wt %, at least about 75 wt %, at least about 80 wt %, at least about 85 wt %, at least about 90 wt %, at least about 91 wt %, at least about 92 wt %, at least about 93 wt %, at least about 94 wt %, at least about 95 wt %, at least about 96 wt %, at least about 97 wt %, at least about 98 wt %, at least about 99 wt %, at least about 99.1 wt %, at least about 99.2 wt %, at least about 99.3 wt %, at least about 99.4 wt %, at least about 99.5 wt %, at least about 99.6 wt %, at least about 99.7 wt %, at least about 99.8 wt %, at least about 99.9 wt %, at least about 99.91 wt %, at least about 99.92 wt %, at least about 99.93 wt %, at least about 99.94 wt %, at least about 99.95 wt %, at least about 99.96 wt %, at least about 99.97 wt %, at least about 99.98 wt %, at least about 99.99 wt %, or all or substantially all of the biomaterial-based material.

In some embodiments of textile compositions according to the present disclosure, biomaterials may make up at least about 40 wt. %, at least about 45 wt. %, at least about 50 wt. %, at least about 55 wt. %, at least about 60 wt. %, at least about 65 wt. %, at least about 70 wt. %, at least about 75 wt. %, at least about 80 wt. %, at least about 85 wt. %, at least about 90 wt. %, at least about 95 wt. %, at least about 96 wt. %, at least about 97 wt. %, at least about 98 wt. %, at least about 99 wt. %, or substantially all of a textile composition and/or biomaterial textile composition (as those terms are defined herein). The content of biomaterials in a textile composition and/or biomaterial textile composition may, in some embodiments, be calculated and/or determined according to either or both of ASTM D6866 and ISO 16620-2.

Particular biomaterial textile compositions according to embodiments of the present disclosure include filamentous fungal mycelial biomass as a biomaterial. In certain embodiments, the filamentous fungal mycelial biomass may act as a stiffening agent to increase the elastic modulus of the biomaterial textile composition (e.g., from about 10 MPa to about 15-20 MPa); this effect is often advantageous, as it allows for further processing of the biomaterial textile composition (e.g., application of a relatively stiff coating material) that might otherwise fail or be more difficult or less effective if performed on the softer biomaterial textile composition in the absence of the fungal stiffening agent. Addition of filamentous fungal mycelial biomass as a stiffening agent may also prevent the deformable mixture from being excessively sticky or tacky, thus improving the extrudability of the deformable mixture and the handfeel, dirt resistance, and amenability to coating of the biomaterial textile composition.

In some embodiments that include filamentous fungal mycelial biomass, material properties of the composition can be improved by use of fine filamentous fungal particles (i.e., fungal particles having a relatively fine particle size). Particularly, filamentous fungal mycelial biomass used as a biomaterial in biomaterial textile compositions according to embodiments of the present disclosures may have an average particle size of no more than about 250 μm, no more than about 200 μm, no more than about 150 μm, no more than about 100 μm, or no more than about 50 μm. In many embodiments, the average particle size of the filamentous fungal mycelial biomass is preferably less than 100 μm and most preferably no more than about 30 μm; the present inventors have found that for many applications, these particle sizes provide a better feeling and/or better performing biomaterial textile composition. In some embodiments, a D50 particle size of the filamentous fungal mycelial biomass may be from about 10 μm to about 30 μm, or about 20 μm, and/or a D90 particle size of the filamentous fungal mycelial biomass may be about 35 μm. Non-limiting examples of techniques that may be employed to obtain a suitable particle size distribution of the filamentous fungal mycelial biomass include spray drying, jet milling, and combinations thereof.

### Biomaterial Textile Compositions

Biomaterial textile compositions according to a first set of embodiments of the present disclosure include a polymer component comprising at least (1) a thermoplastic elastomer (e.g., a polymer (such as, for example, a block copolymer) comprising at least one monomer selected from the group consisting of farnesenes, myrcenes, butadienes, isoprenes, etc.) and (2) a second polymer. Typically, the thermoplastic elastomer makes up about 20 wt % to about 90 wt % (or any value in any range having an upper bound of any whole number of weight percent from 20 wt % to 90 wt % and a lower bound of any other whole number of weight percent from 20 wt % to 90 wt %), and the second polymer makes up about 5 wt % to about 75 wt % (or any value in any range having an upper bound of any whole number from 5 wt % to 75 wt % and a lower bound of any other whole number of weight percent from 5 wt % to 75 wt %), of the biomaterial textile composition (or a precursor thereof, e.g. a deformable and/or extrudable mixture) on a dry basis, i.e., excluding water. More generally, a weight ratio of the thermoplastic elastomer to the second polymer may be in any range having a lower bound of A:B and an upper bound of C:D, where A and B are whole numbers whose sum is 100, C and D are whole numbers whose sum is 100, and A is less than C; most typically, the weight ratio of the thermoplastic elastomer to the second polymer is from about 20:80 to about 90:10. The thermoplastic elastomer and the second polymer may, in many embodiments, collectively make up at least about 50 wt %, at least about 55 wt %, at least about 60 wt %, at least about 65 wt %, at least about 70 wt %, at least about 75 wt %, at least about 80 wt %, at least about 85 wt %, at least about 90 wt %, at least about 95 wt %, at least about 96 wt %, at least about 97 wt %, at least about 98 wt %, at least about 99 wt %, or substantially all of the biomaterial textile composition.

The thermoplastic elastomer may, in some embodiments, be a block copolymer comprising first and second polymer blocks; by way of non-limiting example, the thermoplastic elastomer may include a first polymer block comprising a structural unit derived from one or more farnesenes (which may, in embodiments, be present in an amount of about 50 wt % to about 99 wt % (or any subrange thereof) of the thermoplastic elastomer, and may typically be present in an amount of about 70 wt % to about 82 wt % of the thermoplastic elastomer) and a second polymer block comprising a structural unit derived from styrene (which may, in embodiments, be present in an amount of about 1 wt % to about 50 wt % (or any subrange thereof) of the thermoplastic elastomer, and may typically be present in an amount of about 11 wt % to about 35 wt %, or about 18 wt % to about 30 wt %, of the thermoplastic elastomer). In some embodiments, the structural unit derived from one or more farnesenes may differ from the one or more farnesenes from which it is derived in that at least about 30%, at least about 40%, at least about 50%, at least about 60%, at least about 70%, at least about 80%, at least about 90%, or about 100% of carbon-carbon bonds that are double bonds in the one or more farnesenes may be hydrogenated (i.e., single bonds) in the structural unit. Additionally or alternatively, the thermoplastic elastomer may include, in addition to one or more 1,3-diene monomers (e.g., one or more farnesenes, myrcene, butadiene, isoprene, etc.), an aromatic vinyl monomer (e.g., styrene, α-methylstyrene, 4-methylstyrene, styrene sulfonate, etc.). Although not required, it may in many embodiments be advantageous for the thermoplastic elastomer to be biologically derived (e.g., Kuraray SEPTON™ BIO 902 and/or Kuraray SEPTON™ BIO 904). In such embodiments, one or both polymer blocks of the thermoplastic elastomer block copolymer are derived from biomass and are not petroleum based. In many embodiments, the thermoplastic elastomer may be characterized by any one or more of a desirably low elastic modulus (e.g., an elastic modulus of no more than about 1 MPa); a desirably low, high, or intermediate melt flow rate (MFR) (e.g., an MFR of 10 kg of material at 230° C. of no more than about 5 g/10 min, or of at least about 500 g/10 min, or of between about 5 and 500 g/10 min, and often about 55 g/10 min); a desirably low, high, or intermediate viscosity at 30° C. when dissolved in toluene (e.g., a viscosity of about 5 to about 10, often about 8.6, mPa·s of a 5 wt % solution in toluene, and/or a viscosity of about 5 to about 30, often between about 11 and about 28, mPa's of a 10 wt % solution in toluene, and/or a viscosity of about 25 to about 1000, often between about 32 and about 102 or about 902, mPa's of a 20 wt % solution in toluene); and/or a desirably low type A hardness value (e.g., a type A hardness of about 5 to about 30, often of about 8 to about 25). It is to be expressly understood that certain embodiments may include two or more thermoplastic elastomers.

The second polymer may, in some embodiments, be a thermoplastic polyester elastomer (e.g., DuPont Hytrel® 3078, DuPont Hytrel® 3078 ECO B), an ethylene vinyl acetate (e.g., Braskem I'm Green™ bio-based EVA), a styrene-butadiene-styrene (SBS) copolymer (e.g., Styroflex®), a styrene-butadiene-ethylene-styrene (SEBS) copolymer (e.g., Dryflex® Green), a styrene-ethylene-propylene-styrene (SEPS) copolymer (e.g., Kraton thermoplastic elastomers), or a combination thereof. Non-limiting examples of suitable second polymers include Braskem I'm Green™ EVA SVT2180, low-density polyethylene (e.g., Braskem I'm Green™ LDPE SBC818, Braskem I'm Green™ linear low-density polyethylene), Braskem I'm Green™ high-density polyethylene Styroflex® 2G66 B60 (a styrene-butadiene block copolymer), Pebax® thermoplastic elastomers (polyether block amide copolymers), Dryflex® Green styrene-butadiene block copolymers, Dryflex® Green thermoplastic olefins (e.g., ethylene propylene monomer (EPM) or ethylene propylene diene monomer (EPDM) rubbers), DuPont Hytrel® 3078, DuPont Hytrel® 3078 ECO B, polybutylene succinate, polyhydroxy alkanoates, polylactic acid, nylon-11, polyethylene furanoate, and combinations thereof. It is to be expressly understood that certain embodiments may include two or more second polymers. Typically, the second polymer has any one or more of (i) a tensile strength of from about 10 MPa to about 50 MPa (or any value in any subrange thereof), (ii) a density of from about 0.94 g/cm³ to about 1.28 g/cm³ (or any value in any subrange thereof), (iii) a strain at break of from about 200% to about 900% (or any value in any subrange thereof), (iv) a Shore D hardness of from about 24 to about 70 (or any value in any subrange thereof), and (v) a melting point of from about 86° C. to about 221° C. (or any value in any subrange thereof). In embodiments, the second polymer is an ethylene vinyl acetate having a vinyl acetate content (on a molar and/or weight basis) of at least about 11% (and in particular embodiments, about 11% to about 19%), a melt flow rate (MFR) between about 2.0 and 2.5 g/10 min at 190° C. and 2.16 kg, an elastic modulus of about 20 MPa, and/or a biobased content of at least about 70% preferably at least about 80%. Although not always required, it may in many embodiments be highly advantageous for the second polymer to be capable of being bonded by any one or more conventional adhesives, such as, by way of non-limiting example, a roasted hydrocarbon adhesive, a mixed-protein adhesive, a gelatin adhesive, a keratin adhesive, a fibrin adhesive, a wax adhesive, a starch adhesive, a dextrin adhesive, a polysaccharide adhesive, a tree gum or resin adhesive, a latex rubber cement adhesive, a methyl cellulose adhesive, a ketone adhesive, a dichloromethane adhesive, an acrylonitrile adhesive, a cyanoacrylate adhesive, a methyl acrylate adhesive, an ethylene-vinyl acetate adhesive, a polyolefin adhesive, a polyamide adhesive, a polyester adhesive, a polyurethane adhesive, a polycaprolactone adhesive, a phenol formaldehyde resin adhesive, a urea-formaldehyde adhesive, a polysulfide adhesive, an epoxy resin adhesive, a polyvinyl adhesive, a silicone resin adhesive, and/or a silyl modified polymer adhesive. This feature may greatly increase the attractiveness of the biomaterial textile composition to designers and manufacturers for use as a “drop-in” replacement for hide leather or previous alternatives/analogs thereof (e.g., polyurethane-based faux leathers).

The combination of the thermoplastic elastomer and the second polymer allows for the production of biomaterial textile compositions characterized by a combination of material properties that could not be achieved by either of these types of polymers alone. By way of non-limiting example, the elastic modulus of many commercially available biologically derived polymers is generally between about 30 MPa and about 80 MPa, far too high to be suitable as a drapable material (e.g., a textile material, such as a leather analog material); however, by combining one or more of these polymers with one or more much “softer” thermoplastic elastomer (which often have elastic moduli of 1 MPa or lower) by the methods and in the amounts disclosed herein, the elastic modulus of the finished biomaterial textile composition may be no more than about 20 MPa, no more than about 19 MPa, no more than about 18 MPa, no more than about 17 MPa, no more than about 16 MPa, no more than about 15 MPa, no more than about 14 MPa, no more than about 13 MPa, no more than about 12 MPa, no more than about 11 MPa, no more than about 10 MPa, no more than about 9 MPa, no more than about 8 MPa, no more than about 7 MPa, no more than about 6 MPa, no more than about 5 MPa, no more than about 4 MPa, no more than about 3 MPa, no more than about 2 MPa, and/or no more than about 1 MPa, thus resulting in a suitably flexible and/or drapable product. Conversely, many commercially available thermoplastic elastomers have tensile strengths of no more than about 5 MPa (much too low to be suitable as leather analog or similar materials); however, by combining one or more of these thermoplastic elastomers with one or more much stronger second polymers (which often have tensile strengths of at least about 10 MPa, and in some cases at least about 50 MPa), the tensile strength of the finished biomaterial textile composition may be at least about 10 MPa, at least about 15 MPa, and/or at least about 20 MPa, and/or may be no more than about 50 MPa, no more than about 45 MPa, no more than about 40 MPa, no more than about 35 MPa, no more than about 30 MPa, and/or no more than about 25 MPa, thus resulting in a suitably durable and mechanically resilient biomaterial textile composition.

The thermoplastic elastomer and the second polymer may be chosen such that certain material characteristics of these two components have a predetermined relationship that in turn lends a desirable quality to the combination of the two components. By way of a first non-limiting example, the second polymer may have a melt flow index (e.g., as measured by ASTM D1238-10) that is higher than a melt flow index (MFI) of the thermoplastic elastomer under the same conditions. By way of second non-limiting example, the second polymer may have a slip velocity (e.g., at a temperature of about 350° F., about 360° F., about 370° F., about 380° F., about 390° F., about 400° F., about 410° F., or about 420° F., and/or at a stress of about 0.1 MPa to about 1 MPa, as measured by a capillary rheometer) that is greater (e.g., at least about 10% greater, at least about 20% greater, at least about 30% greater, at least about 40% greater, at least about 50% greater, at least about 60% greater, at least about 70% greater, at least about 80% greater, at least about 90% greater, at least about 100% greater, at least about 200% greater, at least about 300% greater, at least about 400% greater, at least about 500% greater, at least about 600% greater, at least about 700% greater, at least about 800% greater, or at least about 900% greater) than a slip velocity of the thermoplastic elastomer under the same conditions. By way of third non-limiting example, the second polymer may have a viscosity (e.g., at a temperature of about 350° F., about 360° F., about 370° F., about 380° F., about 390° F., about 400° F., about 410° F., or about 420° F., and/or at a shear rate of about 10 s⁻¹ to about 100 s⁻¹) that is lower than (e.g., no more than about 95% of, no more than about 90% of, no more than about 85% of, no more than about 80% of, no more than about 75% of, no more than about 70% of, no more than about 65% of, no more than about 60% of, no more than about 55% of, no more than about 50% of, no more than about 45% of, no more than about 40% of, no more than about 35% of, no more than about 30% of, no more than about 25% of, no more than about 20% of, no more than about 15% of, or no more than about 10% of) a viscosity of the thermoplastic elastomer under the same conditions. The preceding examples are chosen to illustrate how a thermoplastic elastomer with a relatively low MFI, a relatively low melt strength, and/or a relatively low slip velocity (e.g., Kuraray SEPTON™ BIO SF902) may be utilized in an extrudable mixture, i.e., by being combined with a second polymer that compensates for these characteristics of the thermoplastic elastomer and improves the extrudability of the mixture.

Additionally, biomaterial textile compositions according to a second set of embodiments of the present disclosure include a polymer component comprising a thermoplastic elastomer block copolymer that comprises at least (1) a first “soft” polymer block and (2) a second “hard” polymer block. Typically, the thermoplastic elastomer block copolymer has an elastic modulus of no more than about 10 MPa and/or a molecular weight of at least about 10 kDa, at least about 20 kDa, at least about 30 kDa, at least about 40 kDa, at least about 50 kDa, at least about 60 kDa, at least about 70 kDa, at least about 80 kDa, at least about 90 kDa, or at least about 100 kDa, and/or the biomaterial textile composition as a whole has an elastic modulus of no more than about 25 MPa, a Shore A hardness of no more than about 70, and/or a tensile stress at 5% tensile strain of no more than about 1.2 MPa. In these embodiments, the “soft” polymer block may comprise any one or more of polyfarnesene, hydrogenated polyfarnesene, polymyrcene, hydrogenated polymyrcene, polybutadiene, hydrogenated polybutadiene, polyisoprene, hydrogenated polyisoprene, poly(ethylidene norbornene), poly(dicyclopentadiene), poly(vinyl norbornene), a poly(alkyl acrylate) (e.g., repeating units of butyl acrylate, stearyl acrylate, stearyl methacrylate, lauryl acrylate, lauryl methacrylate, glyceryl acrylate, 2-octyl acrylate decyl acrylate, 2-ethylhexyl acrylate, n-octyl acrylate, isooctyl acrylate, methyl acrylate, ethyl acrylate, isopropyl acrylate, n-propyl acrylate, octadecyl acrylate, methoxyethyl acrylate, 2-hydroxyethyl acrylate, hydroxyethyl methacrylate, 2-aminoethyl acrylate, and/or glycidyl acrylate), a poly(ester) acrylate, a poly(ether) acrylate, a poly(vinyl ester) (e.g., repeating units of vinyl acetate, vinyl propionate, vinyl butyrate, vinyl laureate, vinyl stearate, and/or maleic anhydride), a poly(vinyl alcohol), a poly(vinyl nitrile), a poly(ether) (e.g., repeating units of tetramethylene ether glycol, ethylene glycol, and/or propylene glycol), a poly(ester) (e.g., repeating units of caprolactone, ethylene terephthalate, butylene succinate, lactic acid, and ethylene furanoate), a poly(carbonate), amorphous or low-crystallinity polyethylene, amorphous or low-crystallinity polypropylene, a polyitaconate, polyisobutylene, polyoctene, polyhexene, polybutylene, polymethyl pentene, and a polysiloxane, and/or the “hard” polymer block may comprise any one or more of a polymerized aromatic vinyl compound, poly(methyl methacrylate), crystalline polypropylene, crystalline polyethylene, a polyimide, polyisobornyl methacrylate, and polyisobornyl acrylate. In typical embodiments, the “hard” polymer blocks makes up no more than about 30 mol. %, no more than about 25 mol. %, no more than about 20 mol. %, or no more than about 15 mol. % of the thermoplastic elastomer block copolymer. In embodiments, the “soft” polymer block comprises a structural unit derived from one or more farnesenes, and the structural unit may differ from the one or more farnesenes from which it is derived in that at least about 30%, at least about 40%, at least about 50%, at least about 60%, at least about 70%, at least about 80%, at least about 90%, or about 100% of carbon-carbon bonds that are double bonds in the one or more farnesenes may be hydrogenated (i.e., single bonds) in the structural unit. In embodiments, the farnesene-derived structural unit is derived from a plant such as, for example, sugar cane. In embodiments, the “hard” polymer block comprises styrene and makes up about 18 to about 22% of the thermoplastic elastomer block copolymer.

As further described elsewhere throughout this disclosure, many current leather analog and similar materials include large quantities of polyurethanes (PUs) and/or polyvinyl chlorides (PVCs), which often result in materials that look or feel subjectively “plasticky” or “artificial” and/or require environmentally damaging processing techniques. Additionally, articles made from such PU- and/or PVC-based materials are difficult or impossible to recycle into new articles. Thus, one advantage of many embodiments the biomaterial textile compositions of the present disclosure, relative to previous conventional leather analog and similar materials, is that the biomaterial textile composition of the present disclosure may have a low content of PUs and/or PVCs. Particularly, a total content of PUs and/or PVCs in biomaterial textile compositions of the present disclosure may be no more than about 10 wt %, no more than about 9 wt %, no more than about 8 wt %, no more than about 7 wt %, no more than about 6 wt %, no more than about 5 wt %, no more than about 4 wt %, no more than about 3 wt %, no more than about 2 wt %, no more than about 1 wt %, no more than about 0.9 wt %, no more than about 0.8 wt %, no more than about 0.7 wt %, no more than about 0.6 wt %, no more than about 0.5 wt %, no more than about 0.4 wt %, no more than about 0.3 wt %, no more than about 0.2 wt %, no more than about 0.1 wt %, no more than about 0.09 wt %, no more than about 0.08 wt %, no more than about 0.07 wt %, no more than about 0.06 wt %, no more than about 0.05 wt %, no more than about 0.04 wt %, no more than about 0.03 wt %, no more than about 0.02 wt %, or no more than about 0.01 wt %. In some embodiments, the biomaterial textile composition may be free or substantially free of polyurethanes, polyvinyl chlorides, or both.

As the various polymers in the polymeric blends of biomaterial-based textiles according to the present disclosure may have limited or poor miscibility with each other, the mechanical properties of these blends (and the textiles produced therefrom) can, in many embodiments, be further improved by incorporating a compatibilizer into the polymeric blend to arrest or limit separation of these polymers into distinct phases and allow for the formation of a single continuous phase that is stable over long timeframes. Non-limiting examples of such compatibilizers include polymeric compatibilizers such as polyethylene-octene-maleic anhydride copolymers (e.g., Dow RETAIN™ 3000), butadiene-graft-maleic anhydride copolymers (e.g., Evonik POLYVEST® MA 75), and polyethylene-carboxylic acid copolymers (e.g., Dow SURLYN™ 9320 ionomer), or monomeric or oligomeric compatibilizers such as epoxidized oils (e.g., Epoxol 9-5 or Epoxol EMS), diethers (e.g., ethers of isosorbide), or alkyl dicarboxylic esters. The compatibilizer(s) may, in typical embodiments, be included in amounts of about 0.5 wt % to about 10 wt % (or any subrange thereof) of the total polymer component/compatibilizer mixture. It may in some embodiments be particularly advantageous to use compatibilizers that are themselves at least partially biologically derived. In many embodiments, the compatibilizer may advantageously contribute polar functional groups (e.g., anhydride or carboxylic acid groups) to the polymeric mixture; these polar functional groups increase the surface energy of the finished textile or other biomaterial-based material, thereby improving the “wet-out” (i.e., tendency to spread evenly across the entire material surface) of many common coatings and adhesives and, in some embodiments, the strength of the adhesion of such coatings/adhesives to the material surface.

In certain embodiments, a compatibilizer comprising itaconic acid or maleic anhydride grafted (at about 0.1 to about 5.0 wt %) onto polyfarnesene or other poly(1,3-diene) may be used; as both itaconic acid and farnesenes can be obtained from biomaterial (e.g., itaconic acid can be produced by fungal fermentation of carbohydrates, and various farnesenes are naturally produced by certain plant species), this type of compatibilizer can be mostly or entirely biomaterial-derived. Compatibilizers of this kind may work particularly well in polymeric blends containing SEBS copolymers and/or poly(farnesene)-based block copolymers. Such compatibilizers may be formed, by way of non-limiting example, by mixing about 1 wt % to about 3 wt % itaconic acid and about 0.01 wt % to about 1 wt % of an organic peroxide with one or more liquid poly(farnesene) s and heating this mixture to activate the free radical-induced grafting of the itaconic acid onto the poly(farnesene), and optionally further heating the reaction product (which may often be in the form of a sticky, viscoelastic gel) to a suitable temperature (in some embodiments, at least about 60° C.) to decrease the viscosity thereof.

In some embodiments, one or more gases (e.g., air, carbon dioxide, nitrogen, etc.), and optionally a foaming agent, may be incorporated into biomaterial textile compositions according to the present disclosure to produce a “foamed” biomaterial textile composition that has a significantly lower mass density than a corresponding “unfoamed” biomaterial textile composition; decreasing the density may provide the biomaterial textile composition with a softer, smoother, and/or more “leather-like” handfeel. Conversely, in other embodiments, it may be desirable to degas the biomaterial textile composition or a precursor thereof (e.g., degassing a deformable mixture comprising the polymeric blend before, during, or after deposition of the deformable mixture into a desired spatial configuration) to remove any air bubbles and thereby increase the mass density of the biomaterial textile composition. In some embodiments, the biomaterial textile composition may be “unfoamed” and have a mass density of at least about 1 g/cm³, at least about 1.05 g/cm³, at least about 1.1 g/cm³, at least about 1.15 g/cm³, at least about 1.2 g/cm³, at least about 1.25 g/cm³, at least about 1.3 g/cm³, at least about 1.35 g/cm³, at least about 1.4 g/cm³, at least about 1.45 g/cm³, or at least about 1.5 g/cm³, or in any subrange having a lower bound of any whole number of milligrams per cubic centimeter from 1 g/cm³ to 1.5 g/cm³ and an upper bound of any other whole number of milligrams per cubic centimeter from 1 g/cm³ to 1.5 g/cm³. In other embodiments, the biomaterial textile composition may be “foamed” such that the density of the biomaterial textile composition is decreased relative to a corresponding “unfoamed” biomaterial textile composition by at least about 5%, at least about 10%, at least about 15%, at least about 20%, at least about 25%, at least about 30%, at least about 35%, at least about 40%, at least about 45%, at least about 50%, at least about 55%, at least about 60%, at least about 65%, at least about 70%, at least about 75%, at least about 80%, at least about 85%, at least about 90%, or at least about 95%, e.g., such that the “foamed” biomaterial textile composition has a mass density of no more than about 1 g/cm³, no more than about 0.95 g/cm³, no more than about 0.9 g/cm³, no more than about 0.85 g/cm³, no more than about 0.8 g/cm³, no more than about 0.75 g/cm³, no more than about 0.7 g/cm³, no more than about 0.65 g/cm³, no more than about 0.6 g/cm³, no more than about 0.55 g/cm³, no more than about 0.5 g/cm³, no more than about 0.45 g/cm³, no more than about 0.4 g/cm³, no more than about 0.35 g/cm³, no more than about 0.3 g/cm³, no more than about 0.25 g/cm³, no more than about 0.2 g/cm³, no more than about 0.15 g/cm³, no more than about 0.1 g/cm³, or no more than about 0.05 g/cm³. In some embodiments, foamed biomaterial textile compositions may also differ from unfoamed biomaterial textile compositions in one or more other characteristics or properties, e.g., thermal properties (e.g., thermal effusivity, thermal conductivity, heat capacity, etc.), insulation properties, physical properties (e.g., tensile strength, strain at break, flexibility, etc.), and the like.

In some embodiments, one or more fillers and/or reinforcing materials, such as natural or synthetic fibers or a combination thereof, may be added to the biomaterial textile composition (or a precursor thereof, e.g., a deformable and/or extrudable mixture comprising the polymer component) to reinforce and provide additional structural integrity to the resulting biomaterial textile composition. Non-limiting examples of suitable fillers and/or reinforcing materials include fungal hyphae and/or mycelium, cellulose fibers, cardboard, paper, microfibrillated cellulose, nanofibrillated cellulose, recycled fibers, recycled particles, polymeric fibers, flame retardants, colored pigments, polymeric particles, etc. Most typically, the reinforcing materials, e.g., fibers, may be added to the biomaterial textile composition or precursor thereof in an amount of about 2 wt % to about 10 wt %, more preferably about 2.5 wt % to about 9 wt %, and most preferably about 3 wt % to about 8 wt %, or any subrange of any of these ranges, on a dry basis (i.e., excluding water).

In some embodiments, one or more plant oils may be added to the biomaterial textile composition (or a precursor thereof, e.g., a deformable and/or extrudable mixture comprising the polymer component). The plant oil may act in the biomaterial textile composition as any one or more of a fragrance, a pest repellent or pesticide, a preservative, a lubricant, a dirt-proofing or dirt resistance agent, a stain-proofing or stain resistance agent, and a waterproofing or water resistance agent. Non-limiting examples of suitable plant oils include cedar oil. Most typically, the plant oil, e.g., cedar oil, may be added to the biomaterial textile composition or precursor thereof in an amount of about 0.1 wt % to about 0.5 wt %, more preferably about 0.15 wt % to about 0.35 wt %, and most preferably about 0.2 wt %, or any subrange of any of these ranges, on a dry basis (i.e., excluding water).

In some embodiments, one or more salts may be added to the biomaterial textile composition (or a precursor thereof, e.g., a deformable and/or extrudable mixture comprising the polymer component). The salt may be useful as part of a brine rinse to separate organic contaminants, to promote “salting out” of dyestuff precipitates, to blend with concentrated dyes, to provide a cationic charge to promote absorption of anionic dyes (or vice versa), as an antimicrobial and/or preservative, as a humectant, as a desiccant, etc. Non-limiting examples of suitable salts include sodium chloride, sodium benzoate, and sodium hydroxide. Most typically, the salt, e.g., sodium chloride, may be added to the biomaterial textile composition or precursor thereof in an amount of about 0.1 wt % to about 2 wt %, or any subrange thereof, on a dry basis (i.e., excluding water).

In some embodiments, one or more dopants (e.g., a thermal dopant, an optical dopant, an electromagnetic dopant, etc.) may be added to the biomaterial textile composition (or a precursor thereof, e.g., a deformable and/or extrudable mixture comprising the polymer component). A thermal dopant may, but need not, be selected from the group consisting of a ceramic material, a metallic material, a polymeric material, and combinations thereof. Non-limiting examples of suitable thermal dopants include activated charcoal, aluminum oxide, bentonite, diatomaceous earth, ethylene vinyl acetate, lignin, nanosilica, polycaprolactone, polylactic acid, silicone, yttrium oxide, and other ceramic, metallic, and/or polymeric materials. The dopant may alter a selected thermal, optical, and/or electromagnetic characteristic or property of the biomaterial textile composition relative to the same characteristic or property in the absence of the dopant. Non-limiting examples of thermal characteristics or properties that may be altered by inclusion of a thermal dopant in the biomaterial textile composition or precursor thereof include thermal effusivity, thermal conductivity, heat capacity, and the like.

In some embodiments, the biomaterial textile composition or precursor thereof may comprise a gelling agent and/or a non-gelling polysaccharide, e.g., in an amount of about 5 wt % to about 70 wt %, or any subrange thereof, on a dry basis (i.e., on a basis excluding water). A gelling agent may be desirable in certain instances to provide a deformable mixture with certain rheological characteristics, e.g., a desired viscosity and/or yield stress. Non-limiting examples of suitable gelling agents include one or more polymers with a molecular weight of at least about 80,000 daltons, which may, in some embodiments, include one or more polysaccharides, polypeptides, proteins, starches, block copolymers, polyelectrolytes, vegetable gums, hydrocolloids (e.g., ι-karrageenan, κ-carrageenan, λ-carrageenan, agar, starch, modified starch, xanthan, guar gum, locust bean gum, gum arabic, acacia gum, gum karaya, gum tragacanth, alginate, pectin, methyl cellulose, hydroxypropylmethyl cellulose, carboxymethyl cellulose, etc.), and combinations thereof.

In some embodiments, one or more crosslinkers may be added to the biomaterial textile composition (or a precursor thereof, e.g., a deformable and/or extrudable mixture comprising the polymer component). Crosslinking may be useful to increase solvent resistance (e.g., by reducing swelling or dissolution in solvents), increasing the thermomechanical stability of the material (e.g., by rendering thermoplastics into thermosets), increasing strength and/or elasticity of the material, etc. Particularly, water uptake-resistant or anti-swelling crosslinkers may be useful to decrease the water uptake of the finished biomaterial textile composition, i.e., decrease the tendency of the finished biomaterial textile composition to absorb water. Non-limiting examples of suitable crosslinkers include polyamideamine-epichlorohydrin (PAE) resins, epoxides, acrylates, and free radical initiators (e.g., organic peroxides). Most typically, crosslinkers, e.g., PAE resin, free radical initiators, etc. may be added to the biomaterial textile composition or precursor thereof in an amount of about 0.01 wt. % to about 10 wt. %, or any subrange thereof, on a dry basis (i.e., excluding water); in many typical embodiments, the amount of crosslinker may be no more than about 0.1 wt. % and particularly no more than about 0.04 wt. %. Additionally or alternatively, the biomaterial textile composition may be treated with or otherwise include a waterproofing or water resistance agent, such as lecithin and/or beeswax, in an amount of between about 0.1 wt % and about 40 wt %, or alternatively in any range having a lower bound of any number of tenths of a percent between 0.1 wt % and 40 wt % and an upper bound of any other number of tenths of a percent between 0.1 wt % and 40 wt %. In some embodiments, the water uptake of the finished biomaterial textile composition may be no more than about 80%, no more than about 75%, no more than about 70%, no more than about 65%, no more than about 60%, no more than about 55%, no more than about 50%, no more than about 45%, no more than about 40%, no more than about 35%, no more than about 30%, no more than about 25%, no more than about 20%, no more than about 15%, no more than about 10%, no more than about 5%, no more than about 4%, no more than about 3%, no more than about 2%, or no more than about 1%.

In some embodiments, one or more pigments, e.g., an oxide pigment or metal pigment, may be added to the biomaterial textile composition (or a precursor thereof, e.g., a deformable and/or extrudable mixture comprising the polymer component). The addition of such pigments to a deformable and/or extrudable mixture comprising the polymer component may allow for the creation of an extruded product having a desired color. Similarly, in some embodiments, one or more other additives that may modify the visual appearance of the extruded product (e.g., glitter, glow-in-the-dark additives, additives that impart a metallic appearance, etc.) may be added to the deformable and/or extrudable mixture.

The biomaterial textile composition or precursor thereof can also include other additives. By way of non-limiting example, the biomaterial textile composition or precursor thereof can include suitable amounts of one or more fillers, functionalizing compounds, crosslinkers, polymers, sizing agents, hydrophobing agents, plasticizers, pigments, dyes, antifoaming agents, defoaming agents, flocculants, deflocculants, antimicrobial agents, antistatic agents, UV stabilizers, surface modifiers, foaming agents, blowing agents, and/or flame retardants. The additive may in certain embodiments comprise a surface modifier (e.g., a texture modifier, a slip agent, a non-slip agent, an anti-blocking agent, a matting agent, and/or a gloss agent).

### Properties of Biomaterial Textile Compositions and Biomaterial Textiles

Biomaterial textile compositions and biomaterial textiles as disclosed herein may generally have mechanical, and in many cases aesthetic (i.e., “look and feel”), characteristics comparable to conventional textiles, e.g., leather. Particularly, the combination of biomaterials with other components can give the desired look and feel of conventional fibrous materials. By way of non-limiting example, biomaterials may be used to impart a desired texture or “hand feel” to the biomaterial textile composition and/or biomaterial textile; stated slightly differently, the biomaterial may be effective to reduce the extent to which a biomaterial textile composition and/or biomaterial textile subjectively “feels” like a typical plastic to a user (e.g., in terms of smoothness and hardness), making articles made from such biomaterial textile compositions and biomaterial textiles more appealing in applications in which the tactile properties of the article are important (e.g., automotive trims and seats and similar upholstered items, shoes, apparel, accessories, etc.). Non-limiting examples of suitable plasticizers include glycerol, urea, epoxidized oils, monomeric or oligomeric esters, and combinations and mixtures thereof.

A low Shore A durometer hardness (preferably below about 50) is generally required for a material to feel “soft.” It is therefore desirable to be able to provide a material with a low hardness to achieve a certain subjective “feel” for certain applications (e.g., it may be desirable for textile materials for use in clothing to have a low Shore A hardness, preferably no more than about 30), while also being able to provide a material with a higher hardness for other applications (e.g., it may be desirable for materials used in gaskets, seals, or other structural applications to have a higher Shore A hardness, preferably at least about 40 and even more preferably at least about 70, such that they are resistant to indentation under pressure).

In some embodiments, the biomaterial textile compositions and/or biomaterial textiles disclosed herein can have tensile strengths that are suitable for a variety of applications of conventional materials. For example, the biomaterial textile compositions and/or biomaterial textiles can have tensile strengths that are greater than about 3 MPa, greater than about 4 MPa, greater than about 5 MPa, greater than about 6 MPa, greater than about 7 MPa, greater than about 8 MPa, greater than about 9 MPa, greater than about 10 MPa, greater than about 11 MPa, greater than about 12 MPa, greater than about 13 MPa, greater than about 14 MPa, greater than about 15 MPa, greater than about 16 MPa, greater than about 17 MPa, greater than about 18 MPa, greater than about 19 MPa, or greater than about 20 MPa. In other embodiments, the biomaterial textile compositions and/or biomaterial textiles can have tensile strengths from about 3 MPa to about 30 MPa, or in any subrange having a lower bound of any whole number of megapascals from 3 MPa to 30 MPa and an upper bound of any other whole number of megapascals from 3 MPa to 30 MPa.

In some embodiments, the biomaterial textile compositions and/or biomaterial textiles disclosed herein can have an elastic modulus that is suitable for a variety of applications of conventional materials. For example, the materials can have elastic moduli that are no more than about 20 MPa, no more than about 19 MPa, no more than about 18 MPa, no more than about 17 MPa, no more than about 16 MPa, no more than about 15 MPa, no more than about 14 MPa, no more than about 13 MPa, no more than about 12 MPa, no more than about 11 MPa, no more than about 10 MPa, no more than about 9 MPa, no more than about 8 MPa, no more than about 7 MPa, no more than about 6 MPa, no more than about 5 MPa, no more than about 4 MPa, no more than about 3 MPa, no more than about 2 MPa, or no more than about 1 MPa. In other embodiments, the biomaterial textile compositions and/or biomaterial textiles can have elastic moduli from about 1 MPa to about 20 MPa, or in any range having a lower bound of any whole number of megapascals from 1 MPa to 20 MPa and an upper bound of any other whole number of megapascals from 1 MPa to 20 MPa. In general, a lower elastic modulus, ceteris paribus, provides a higher degree of “drapability” and is thus desirable in textile materials; the drapability of a textile material can thus be modified by tuning both the thickness of the material (which for textiles is generally between about 0.5 mm and about 2 mm) and its elastic modulus (or its flexural modulus, which is proportional to the elastic modulus).

In some embodiments, the biomaterial textile compositions and/or biomaterial textiles disclosed herein can have a tensile modulus that is suitable for a variety of applications of conventional materials. For example, the materials can have tensile moduli that are greater than about 20 MPa, greater than about 25 MPa, greater than about 30 MPa, greater than about 35 MPa, greater than about 40 MPa, greater than about 45 MPa, greater than about 50 MPa, greater than about 60 MPa, greater than about 70 MPa, greater than about 80 MPa, greater than about 90 MPa, greater than about 100 MPa, greater than about 125 MPa, greater than about 150 MPa, greater than about 175 MPa, or greater than about 200 MPa. In other embodiments, the biomaterial textile compositions and/or biomaterial textiles can have tensile moduli from about 20 MPa to about 200 MPa, or in any range having a lower bound of any whole number of megapascals from 20 MPa to 200 MPa and an upper bound of any other whole number of megapascals from 20 MPa to 200 MPa. Alternatively, in some embodiments, the biomaterial textile compositions and/or biomaterial textiles disclosed herein can have a tensile modulus of no more than about 100 MPa, no more than about 95 MPa, no more than about 90 MPa, no more than about 85 MPa, no more than about 80 MPa, no more than about 75 MPa, no more than about 70 MPa, no more than about 65 MPa, no more than about 60 MPa, no more than about 55 MPa, no more than about 50 MPa, no more than about 45 MPa, no more than about 40 MPa, no more than about 35 MPa, no more than about 30 MPa, no more than about 25 MPa, or no more than about 20 MPa, or alternatively in any range having a lower bound of any whole number of megapascals from 20 MPa to 100 MPa and an upper bound of any other whole number of megapascals from 20 MPa to 100 MPa.

In some embodiments, biomaterial textile compositions disclosed herein can have a flexural modulus that is suitable for a variety of applications of conventional materials. For example, the compositions can have flexural moduli that are no more than about 100 MPa, no more than about 90 MPa, no more than about 80 MPa, no more than about 70 MPa, no more than about 60 MPa, no more than about 50 MPa, no more than about 40 MPa, or no more than about 30 MPa. Particularly, a biomaterial textile composition according to the present disclosure may have a flexural modulus of about 1 MPa to about 30 MPa, or of any value in any range having a lower bound of any whole number of megapascals from 1 MPa to 30 MPa and an upper bound of any other whole number of megapascals from 1 MPa to 30 MPa.

In embodiments in which the biomaterial textile composition and/or biomaterial textile is, or is intended to be, extruded or injection-molded, it may be desirable to tune the melt flow rate of the material, as measured by ASTM D1238-10, within a specific range to achieve desirable flow characteristics of the melted material. Particularly, if the melt flow rate of the material is too low, the pressure in the extruder may exceed safe limits, whereas if the melt flow rate is too high, the quality of the melt (and thus of the extruded product) may be poor. The melt flow rate can be increased by raising the temperature, but it is often desirable to achieve acceptable melt flow rates at lower temperatures to accommodate the use of temperature-sensitive additives (e.g., pigments, fungal mycelium or other biomass-derived fibers, etc.). In general, the present inventors have found that a melt flow index, measured by ASTM D1238-10, of about 2 to about 20 are easily processable according to the methods and systems of the present disclosure.

In some embodiments, it may be especially desirable to generate a biomaterial textile composition and/or biomaterial textile with a low tensile (or flexural) modulus and/or a low elastic modulus, resulting in a more drapable product, and a low hardness, resulting in a softer feel. In addition, it may be desirable for these materials to have high tensile strength and/or tear strength, and/or to include a high content of carbonaceous material derived from renewable, recycled, and/or biological sources. The biomaterial textile compositions and/or biomaterial textiles of the present disclosure thus overcome a substantial drawback of conventional materials in the art, as this combination of features (i.e., low tensile modulus, low hardness, high tensile strength, high tear strength, and/or high content of renewable and/or biologically derived carbon) has previously been extremely difficult or impossible to achieve. Incorporation of biomass as a filler material in earlier composite materials has sometimes been employed to increase the overall composition of renewable and/or biologically derived carbon, but often, these fillers increase the tensile modulus, resulting in a stiffer composite. The biomaterial textile compositions and/or biomaterial textiles of the present disclosure, by contrast, can have both a low tensile modulus and a high content (e.g., at least about 50 wt %, at least about 60 wt %, at least about 70 wt %, at least about 80 wt %, or at least about 90 wt %) of recycled/renewable/biologically derived carbon, while also maintaining adequate tensile strength (e.g., at least about 5 MPa) and elongation at break (e.g., at least about 50%); without wishing to be bound by any particular theory, the present inventors hypothesize that this combination of advantageous features is achieved by the use of formulations that comprise a combination of particulate biomaterial with one or more thermoplastics having low glass transition temperatures. Such formulations can readily be formed into a desired spatial configuration by any of several techniques, including, by way of non-limiting example, extrusion through a die and/or into a mold or cavity. In many embodiments, these composites can be formed into sheets by combining the components in the extruder and co-extruding the combined components. The proportion of carbon in the thermoplastic elastomer (e.g., Kuraray SEPTON™ BIO SF902), the second polymer (e.g., low-density polyethylene (LDPE), ethylene-vinyl acetate, etc.), or both, and/or in the overall biomaterial textile composition and/or biomaterial textile, that is recycled, recyclable, renewable, and/or biologically derived may be at least about 50 wt %, at least about 60 wt %, at least about 70 wt %, at least about 80 wt %, or at least about 90 wt %, as embodied, by way of non-limiting example, by Example 12 below.

Embodiments of the present disclosure enable the creation of biomaterial textile compositions and/or biomaterial textiles that are resilient to repeated flexing. By way of non-limiting example, the materials of the present disclosure can withstand at least about 5,000, at least about 10,000, at least about 15,000, at least about 20,000, at least about 25,000, at least about 30,000, at least about 35,000, or at least about 40,000 flex cycles in flex cycle testing according to BS EN ISO 5402:2009. In other embodiments, materials of the present disclosure can withstand from about 5,000 to about 1,000,000 flex cycles, or a number of flex cycles in any range having a lower bound of any whole number from 5,000 to 1,000,000 and an upper bound of any other whole number from 5,000 to 1,000,000.

Biomaterial textile compositions and/or biomaterial textiles according to the present disclosure may be manufactured such that they are characterized by a desired strain at break. In some embodiments, by way of non-limiting example, the biomaterial textile compositions and/or biomaterial textiles may be manufactured to have a strain at break of at least about 5 percent, at least about 10 percent, at least about 15 percent, at least about 20 percent, at least about 25 percent, at least about 30 percent, at least about 35 percent, at least about 40 percent, at least about 45 percent, at least about 50 percent, at least about 55 percent, at least about 60 percent, or at least about 65 percent, or of no more than about 70 percent, no more than about 65 percent, no more than about 60 percent, no more than about 55 percent, no more than about 50 percent, no more than about 45 percent, no more than about 40 percent, no more than about 35 percent, no more than about 30 percent, no more than about 25 percent, no more than about 20 percent, no more than about 15 percent, no more than about 10 percent, or alternatively in any range having a lower bound of any whole-number percentage between 1 percent and 70 percent and an upper bound of any other whole-number percentage between 1 percent and 70 percent.

Biomaterial textile compositions and/or biomaterial textiles according to the present disclosure may be manufactured such that they are characterized by a desired tear strength (e.g., as measured according to ISO 3377-2). In some embodiments, by way of non-limiting example, the biomaterial textile compositions and/or biomaterial textiles may be manufactured to have a tear strength of at least about 5 N/mm, at least about 10 N/mm, at least about 15 N/mm, at least about 20 N/mm, at least about 25 N/mm, at least about 30 N/mm, at least about 35 N/mm, at least about 40 N/mm, at least about 45 N/mm, at least about 50 N/mm, at least about 55 N/mm, at least about 60 N/mm, at least about 65 N/mm, at least about 70 N/mm, at least about 75 N/mm, at least about 80 N/mm, at least about 85 N/mm, at least about 90 N/mm, at least about 95 N/mm, or at least about 100 N/mm, or a tear strength in any range having a lower bound of any whole number of newtons per millimeter from 5 N/mm to 100 N/mm and an upper bound of any other whole number of newtons per millimeter from 5 N/mm to 100 N/mm.

Biomaterial textile compositions, biomaterial textiles, and/or individual layers or sheets thereof according to the present disclosure may be manufactured such that they are characterized by a desired thickness. In some embodiments, by way of non-limiting example, the biomaterial textile compositions, biomaterial textiles, and/or individual layers or sheets thereof may be manufactured to have a thickness of between about 0.1 mm and about 10 cm, or alternatively a thickness in any range having a lower bound of any number of tenths of millimeters between 0.1 mm and 10 cm and an upper bound of any other number of tenths of millimeters between 0.1 mm 10 cm. In some embodiments, the thickness of the materials is between about 0.1 mm and about 2 mm or between about 0.5 mm and about 2 mm. In some embodiments, it may be especially preferable for a biomaterial textile composition, a biomaterial textile, or an individual layer or sheet thereof to have a thickness from about 0.7 mm to about 1 mm, whereas in certain other embodiments, it may be especially preferable for a “thinner” biomaterial textile composition, biomaterial textile, or individual layer or sheet thereof to have a thickness from about 0.1 mm to about 0.5 mm; in the latter case, sheets of suitable thinness can be formed, by way of non-limiting example, by blown film line extrusion, cast film line extrusion, or the like.

Biomaterial textile compositions and/or biomaterial textiles according to the present disclosure may be manufactured such that they are characterized by a desirably low water uptake. In some embodiments, by way of non-limiting example, the biomaterial textile compositions and/or biomaterial textiles may be manufactured to have a water uptake of no more than about 100%, no more than about 95%, no more than about 90%, no more than about 85%, no more than about 80%, no more than about 75%, no more than about 70%, no more than about 65%, no more than about 60%, no more than about 55%, no more than about 50%, no more than about 45%, no more than about 40%, no more than about 35%, no more than about 30%, no more than about 25%, no more than about 20%, no more than about 15%, no more than about 10%, no more than about 5%, no more than about 4%, no more than about 3%, no more than about 2%, or no more than about 1%.

Textile compositions according to the present disclosure may be produced as a rolled sheet material, as is typical of the product of, e.g., an extrusion process. In some embodiments, such a rolled sheet may have a total length of at least about 5 meters, at least about 10 meters, at least about 15 meters, or at least about 20 meters. Additionally or alternatively, such a rolled sheet may have a width of at least about 10 cm, at least about 20 cm, at least about 30 cm, at least about 40 cm, at least about 50 cm, at least about 60 cm, at least about 70 cm, at least about 80 cm, at least about 90 cm, at least about 100 cm, at least about 110 cm, at least about 120 cm, at least about 130 cm, at least about 140 cm, at least about 150 cm, at least about 160 cm, at least about 170 cm, at least about 180 cm, at least about 190 cm, or at least about 200 cm.

Materials of the disclosure can achieve combinations of beneficial properties, such as having both high tensile strength values and high tensile modulus values, or having both high tensile strength values and low elastic modulus values. For example, such materials can have a tensile strength of greater than about 3 MPa (or any other tensile strength value or within any tensile strength range referenced above) while also having a tensile modulus of greater than about 20 MPa (or any other tensile modulus value or within any tensile modulus range referenced above), and/or while also having a tensile modulus of no more than about 15 MPa (or any other elastic modulus value or within any elastic modulus range referenced above). Additionally or alternatively, biomaterial textile compositions and/or biomaterial textiles according to the present disclosure may have a biomass content of at least about 10 wt %, at least about 15 wt %, at least about 20 wt %, at least about 25 wt %, at least about 30 wt %, at least about 35 wt %, at least about 40 wt %, at least about 45 wt %, or at least about 50 wt %, while also having one or more of (i) a tensile strength of at least about 1.5 MPa, at least about 3 MPa, or at least about 10 MPa; (ii) a tensile modulus of at least about 20 MPa and/or of no more than about 100 MPa; (iii) an elastic modulus of no more than about 15 MPa, no more than about 10 MPa, no more than about 5 MPa, or no more than about 1 MPa; (iii) a tensile elongation of at least about 40%; (iv) an ability to withstand at least about 5,000 flex cycles in flex cycle testing according to BS EN ISO 5402:2009; (v) a strain at break of at least about 5 percent and/or of no more than about 70 percent; and/or (vi) a tear strength of at least about 5 N/mm.

In some embodiments, to achieve any one or more of the material properties described herein, a biomaterial textile composition according to the present disclosure may be crosslinked, using either or both of a chemical crosslinker (as described above) or electron beam irradiation cross-linking. For some applications and embodiments, electron beam irradiation may be particularly preferable because it can be done at room temperature and can be decoupled from other manufacturing steps (e.g., compression molding, extrusion, injection molding, foaming, etc.) thereby reducing operational constrains on the key parameters (e.g., temperature) of these other manufacturing steps. This decoupling of the crosslinking step may also enable higher crosslink densities to be achieved than can be feasibly achieved using thermally activated free radical initiators; for example, too high a content of a peroxide initiator during extrusion may cause the biomaterial textile composition to gel within the extruder, and even at crosslink densities below the gel point may lead to other defects due to, e.g., buildup of material on the die lip as a result of reduced polymer melt flow. By contrast, crosslinking by electron beam irradiation, as is often employed in the manufacture of, for example, ethylene-vinyl acetate (EVA) foams, is ideally suited for cases where higher crosslink densities are needed, or where other thermally activated processes may need to occur (such as activation of blowing agents to make a foam). Crosslinking may be especially desirable in some embodiments to prevent the biomaterial textile and/or biomaterial textile composition from cracking and/or crumbling, to improve the resilience to repeated flexing of the biomaterial textile and/or biomaterial textile composition (i.e., improved bally flex performance), and/or to improve the fatigue resistance, thermal stability, and/or tear resistance of the biomaterial textile and/or biomaterial textile composition. The advantages of crosslinking are embodied, by way of non-limiting example, by Example 14 below. A first non-limiting example of a thermoplastic elastomer/second polymer combination identified by the present inventors as being particularly advantageous is the combination of a thermoplastic elastomer that is a hydrogenated styrene/farnesene block copolymer having a styrene content of about 18 wt % (e.g., Kuraray SEPTON™ BIO SF902 (“SF902”)), and a thermoplastic polyester elastomer that is a block copolymer having a hard (crystalline) segment of polybutylene terephthalate and a soft (amorphous) segment based on polyether chemistry (e.g., DuPont Hytrel® 3078 or DuPont Hytrel® 3078 ECO B (“Hytrel”)). The present inventors have found that blends of these two polymers in SF902/Hytrel weight ratios of about 20:80 to about 60:40 exhibit an advantageous combination of excellent tensile strength (at least about 5 MPa) and low elastic modulus (no more than about 5 MPa); this is a surprising finding, as those of ordinary skill in the art would expect poor compatibility between Hytrel (a polyester containing many polar polyether units along the backbone) and SF902 (a farnesene-styrene block copolymer with much lower polarity). Even more specifically, blends of these two polymers in SF902/Hytrel weight ratios of about 20:80 to about 35:55 are likely to be especially preferable for providing a desirable combination of high tensile strength and low elastic modulus; the present inventors have found that a 20:80 blend of these two polymers exhibits the same tensile strength as pure Hytrel, but an elastic modulus about one-third that of pure Hytrel, thus significantly reducing the perceived stiffness and concomitantly improving the handfeel of sheets of the biomaterial textile composition without compromising its strength. Additionally, when using Hytrel as the second polymer and an MFR (at 190° C. and 2.16 kg of material) of 5 grams per 10 minutes, the present inventors have successfully extruded high-quality material sheets with SF902 contents of up to 80 wt %, which is desirable for achieving materials with a soft handfeel. Further advantages of this combination of thermoplastic elastomer and second polymer are described in Example 1 below.

A second non-limiting example of a thermoplastic elastomer/second polymer combination identified by the present inventors as being particularly advantageous is the combination of a thermoplastic elastomer that is an at least partially hydrogenated styrene/farnesene block copolymer having a styrene content of about 18 wt % (e.g. SF902) and low-density polyethylene (LDPE), e.g., Braskem I'm Green™ SBC 818. Particularly, when using LDPE as the second polymer, the present inventors have successfully extruded high-quality material sheets with SF902 contents of at least about 60 wt %, which is desirable for achieving materials with a soft handfeel; by way of non-limiting example, as described in Example 10 below, the present inventors are able to extrude high-quality sheets of very soft material when an SF902/LDPE ratio is at least about 70:30. This is an advantageous property because it has previously proven very difficult to extrude high-quality sheets comprising SF902; the present inventors are unaware of any previous successful attempts to extrude polymer blends containing more than about 60 wt % SF902. Further advantages of this combination of thermoplastic elastomer and second polymer are described in Example 10 below.

A third non-limiting example of a thermoplastic elastomer/second polymer combination identified by the present inventors as being particularly advantageous is the combination of a thermoplastic elastomer that is an at least partially hydrogenated styrene/farnesene block copolymer (e.g., SF902) and ethylene-vinyl acetate (EVA), e.g., Braskem I'm Green™ SVT2180, having at least 11% by mass of the structural unit vinyl acetate and a tensile strength at break of 19 MPa. Non-limiting examples of advantageous features of this combination of thermoplastic elastomer and second polymer may include resilience to repeated flexing (improved bally flex performance) while retaining the ability to be embossed with an aesthetic pattern or design, and/or the ability to laminate structural fabrics to sheets of the SF902/EVA composition without the use of adhesives. Further advantages of this combination of thermoplastic elastomer and second polymer are described in Examples 12-14 below.

A fourth non-limiting example of a thermoplastic elastomer/second polymer combination identified by the present inventors as being particularly advantageous is the combination of a thermoplastic elastomer that is an at least partially hydrogenated styrene/farnesene copolymer (e.g., SF902) and a polyester having an elastic modulus of no more than about 600 MPa (and, most preferably of about 100 MPa to about 350 MPa). Particularly, the polyester may in many embodiments be polymerized from one or more diacids (e.g., succinic acid, sebacic acid, adipic acid, terephthalic acid, etc.) and one or more diols, wherein the diols include 1,4-butanediol; non-limiting examples of polyesters of this type include polybutylene adipate terephthalate (PBAT) and aliphatic polyesters such as polybutylene succinate (PBS), polybutylene adipate, polybutylene succinate adipate (PBSA), polybutylene sebacate, and the Dupont Hytrel® series of thermoplastic polyester elastomers, which are polymerized from 1,4-butanediol, terephthalic acid, and polytetrahydrofuran.

### Backings

In some embodiments, biomaterial textiles according to the present disclosure may be multilayer textiles made by depositing (e.g., by extrusion) a biomaterial textile composition onto a surface of, and/or adhering, laminating, or otherwise affixing a biomaterial textile composition to, one or more backing layers (e.g., a cotton backing, a nylon backing, a cardboard backing, a paper backing, a foam backing, etc.). It is to be expressly understood that in some embodiments in which the biomaterial textile composition is in a “melt” phase or other deformable form, the biomaterial textile composition can be affixed to a backing layer without the use of adhesives or bonding agents by extruding the biomaterial textile composition directly onto the backing layer, because the mechanism of adhesion between the two layers is physical rather than covalent. Elimination of adhesives and bonding agents is yet another advantage and benefit of the present disclosure, as adhesives generally have a negative effect on the drapability of a textile material.

Non-limiting examples of textile backing materials that may be adhered, laminated, or otherwise affixed to biomaterial textile compositions according to the present disclosure to form a multilayer textile include an acrylic textile, an alpaca textile, an angora textile, a cashmere textile, a coir textile, a cotton textile, an eisengarn textile, a hemp textile, a jute textile, a Kevlar textile, a linen textile, a microfiber textile, a mohair textile, a nylon textile, an olefin textile, a pashmina textile, a polyester textile, a piña textile, a ramie textile, a rayon textile, a sea silk textile, a silk textile, a sisal textile, a spandex textile, a spider silk textile, a wool textile, and combinations thereof. In some embodiments, the backing material may be chemically pre-treated to provide functional groups on a surface of the backing material that improve the adhesion between the biomaterial textile composition and the backing material. In some embodiments, the backing layer may be a porous or mesh material, which may have a pore size of between about 5 μm and about 25.4 mm, between about 25 μm and about 5.60 mm, between about 0.165 mm and about 2.00 mm, between about 15 μm and about 400 μm, or alternatively in any range having a lower bound of any whole number of micrometers between 1 μm and 25.4 mm and an upper bound of any other whole number of micrometers between 1 μm and 25.4 mm.

Additionally or alternatively, biomaterial textile compositions according to the present disclosure may be adhered, laminated, or otherwise affixed to a foam backing material, non-limiting examples of which include polyolefin foams, open-cell polyurethane foams, closed-cell polyethylene foams, latex foams, polyurethane/polyester foams, polyurethane/polyether foams, and combinations thereof, to form a multilayer textile. Multilayer textiles that include a biomaterial textile composition according to the present disclosure and a foam backing layer may be especially useful for automotive interior applications (e.g., for use in seat cushions, seat backs, headrests, footrests, consoles, armrests, door panels, and the like). In some embodiments, a total thickness of such multilayer textiles, and/or of an individual layer thereof, may be from about 0.5 mm to about 5 mm, or about 3 mm, or alternatively in any range having a lower bound of any whole number of micrometers between 0.5 mm and 5 mm and an upper bound of any other whole number of micrometers between 0.5 mm and 5 mm. The foam backing layer may comprise one or more foam materials of any density, i.e., a very low-density foam material, a low-density foam material, a medium-density foam material, and/or a high-density foam material, as those terms are defined herein.

Additionally or alternatively, biomaterial textile compositions according to the present disclosure may be adhered, laminated, or otherwise affixed to a backing layer of a scaffold material such as a non-woven fabric (i.e., a fabric made by a spunbond method or a melt-blown method) to form a multilayer textile.

An adhesion force between the layer(s) of biomaterial textile composition and the layer(s) of backing material may be at least about 1 N, at least about 2 N, at least about 3 N, at least about 4 N, at least about 5 N, at least about 6 N, at least about 7 N, at least about 8 N, at least about 9 N, at least about 10 N, at least about 11 N, at least about 12 N, at least about 13 N, at least about 14 N, or at least about 15 N (or in any range having an upper bound of any one of these values and a lower bound of any other one of these values), and the multilayer textile may, but need not, be engineered such that a failure mode of adhesion between the layers is either adhesive or cohesive. It is to be expressly understood that multilayer textiles as disclosed herein may include biomaterials in all or less than all of the several layers, and that those layers that include biomaterials may all include the same biomaterial (or combination of biomaterials) or may respectively include different biomaterials (or combinations of biomaterials). Multilayer textiles as disclosed herein may have two, three, four, five, six, seven, eight, nine, ten, or more than ten material layers, and may in some embodiments include one or more very thin layers (e.g., having a thickness of no more than about 10 μm each).

In some embodiments, it may be preferable for an elastic modulus of the biomaterial textile composition and an elastic modulus of the backing material to be the same, or for the difference between these two elastic moduli to be relatively small; this feature may improve the extent to which the finished textile resists delamination of the backing from the one or more biomaterial textile composition layers to which it is adhered. More particularly, some embodiments of textile compositions according to the present disclosure include a biomaterial textile composition comprising a biomass additive, such as filamentous fungal mycelial biomass, that modifies an elastic modulus of the biomaterial textile composition such that the elastic modulus of the biomaterial textile composition differs from the elastic modulus of the backing by no more than about 50%, no more than about 45%, no more than about 40%, no more than about 35%, no more than about 30%, no more than about 25%, no more than about 20%, no more than about 15%, no more than about 10%, or no more than about 5%.

### Topcoats and Topcoat Adhesives

In some embodiments, biomaterial textiles according to the present disclosure may particularly include a coating material (which may be referred to hereinafter as a “topcoat”), which in some embodiments may comprise or be derived from a polar solvent; this polar solvent may, by way of non-limiting example, be applied to a surface of a biomaterial textile composition after deposition of a deformable mixture comprising the polymeric blend of the biomaterial textile composition into a desired spatial configuration. In some, but by no means all, cases, the topcoats are polyurethane-based coatings, typically in the form of a polyurethane dispersion (PUD), i.e., a dispersion of polyurethane in a liquid dispersion medium and/or solvent (such as water or an organic solvent). Particularly, polyurethane-based coating materials may consist of a blend of one or more polyurethanes with one or more other suitable topcoat additives, such as acrylics, isocyanates, silicone-based handfeel modifiers, dulling agents, wetting agents, pigments, and the like; such materials may also contain one or more surfactants to improve the dispersibility and stability of the polyurethane(s) and other topcoat additives in the dispersion medium and/or solvent.

In many applications, leather analog materials and other similar textile compositions provided with a topcoat must exhibit an adhesive strength between the topcoat and the biomaterial textile composition exceeding a certain threshold when dry and/or when wet, to ensure that the topcoat does not delaminate from the textile. This threshold value is generally at least about 2.0 N per 10 mm² (200 kPa). Unlike many previous attempts to provide leather analogs and other similar textiles that incorporate biomaterials, textile compositions according to the present disclosure can, even when wet, achieve these adhesive strengths, and indeed even greater strengths of at least about 2.2 N per 10 mm² (220 kPa), at least about 2.4 N per 10 mm² (240 kPa), at least about 2.6 N per 10 mm² (260 kPa), at least about 2.8 N per 10 mm² (280 kPa), at least about 3.0 N per 10 mm² (300 kPa), at least about 3.2 N per 10 mm² (320 kPa), at least about 3.4 N per 10 mm² (340 kPa), at least about 3.6 N per 10 mm² (360 kPa), or at least about 3.8 N per 10 mm² (380 kPa).

The coatings/topcoats of the present disclosure may provide the textile composition with one or more of several advantageous and/or beneficial features in addition to those described elsewhere throughout this disclosure. By way of first non-limiting example, the coatings/topcoats of the present disclosure may improve the abrasion resistance of the textile. By way of second non-limiting example, the coatings/topcoats of the present disclosure may aid in “locking in” plasticizers or other additives, i.e., preventing leaching or separation of these additives from the biomaterial textile composition or migration within the biomaterial textile composition. By way of third non-limiting example, the coatings/topcoats of the present disclosure may improve the hand feel or other aesthetic qualities (e.g., color, pattern, texture, scent, etc.) of the textile, and in particular may provide aesthetic qualities that more closely approximate those of an animal-derived material (e.g., hide/true leather) of which the textile is an analog. By way of fourth non-limiting example, the coatings/topcoats of the present disclosure may improve the water repellence capabilities and/or hydrophobicity of the textile composition. By way of fifth non-limiting example, the coatings/topcoats of the present disclosure may improve the resistance of the textile composition to damage by ultraviolet light.

In some embodiments, it may be preferable for an elastic modulus of the biomaterial textile composition and an elastic modulus of the topcoat material to be the same, or for the difference between these two elastic moduli to be relatively small; this feature may improve the extent to which the finished textile resists delamination of the topcoat layer from the one or more biomaterial textile composition layers to which it is adhered. More particularly, some embodiments of textile compositions according to the present disclosure include a biomaterial textile composition comprising a biomass additive, such as filamentous fungal mycelial biomass, that modifies an elastic modulus of the biomaterial textile composition such that the elastic modulus of the biomaterial textile composition differs from the elastic modulus of the topcoat by no more than about 50%, no more than about 45%, no more than about 40%, no more than about 35%, no more than about 30%, no more than about 25%, no more than about 20%, no more than about 15%, no more than about 10%, or no more than about 5%.

Most typically, topcoat material(s) is/are applied to other layers of the textile composition (e.g., a biomaterial textile composition layer) by spray-coating, but it is to be expressly understood that the topcoat material(s) can also be applied by roll-coating or transfer-coating instead of or in addition to spray-coating. Particularly, in some embodiments of the present disclosure, the textile composition may be coated via “indirect” or “inverse” finishing, in which a film, paper, or sheet material (e.g., nylon, polyethylene terephthalate film, etc.) with a coating deposited thereon (e.g., by physical vapor deposition), referred to herein as a transfer film, is pressed onto a surface of a textile composition layer and heated; the paper or film is then peeled away, leaving behind the coating on the textile composition layer. Examples of transfer films include Dunmore metallic transfer films and Sappi casting and release papers. Advantageously, transfer film coating may allow the coating to be applied “in-line” (e.g., as sheets of the textile composition layer emerge from an extruder), in the same step used to apply a backing, and/or in a separate or standalone process step (using, e.g., a flatbed press, such as a hydraulic press, leather press, pneumatic press, or hot press, whereby the coated transfer film is laid on top of the textile composition layer and fed directly to the flatbed press), and/or facilitate the coating of either pre-coated or uncoated layers, which may (but need not) then be further coated by a different modality (e.g., spray coating). Indirect/inverse finishing using transfer films can be used to achieve a metallic, holographic, iridescent, colorful, glitter-like, patterned, or textured appearance on a surface of the textile composition, and/or may alter the texture, color, and/or handfeel of the textile composition. While transfer films have been used to apply patterns to thermoplastic or thermoset materials and synthetic leather analogs, the present inventors have surprisingly and unexpectedly found that transfer film coating can likewise be applied to biomaterial textile compositions according to the present disclosure that are soft and/or have a high content of biologically derived carbon.

In some embodiments, the textile composition may be subjected to plasma, flame, and/or corona treatment before and/or after application of topcoat material(s), and/or may be pretreated with a solvent-borne primer (e.g., Worthen 3296, a halogenation primer (such as Worthen 3213), a chlorinated polyolefin primer (such as Eastman CP 377W or CP 347W or Worthen 3267), or another chlorinated or non-chlorinated olefin primer) prior to application of topcoat material(s), to enhance adhesion of the topcoat material(s) and facilitate wet-out and adhesion of a topcoating material (e.g., a polyurethane). This pretreatment step may be particularly important where the surface energy of the un-topcoated leather analog material is highly hydrophobic, as this can create difficulties with wet-out of common leather topcoating materials; flame, plasma, or corona pretreatment can increase the surface energy from about 30 dynes per centimeter, typical of many biomaterial textile compositions according to the present disclosure, to 50-60 dynes per centimeter, depending on the watt density of the pretreatment process. Any one of these pre- and or post-treatments of layers of the textile composition, and any combination of two or more such treatments (e.g., corona treatment and application of a solvent-borne primer) may improve topcoat adhesion (i.e., resistance to peeling or delamination of the topcoat) and the textile composition's resistance to cracking or other material failure at flexing creases.

The selection of appropriate coating materials and pre- and/or post-treatment steps may be especially important in embodiments in which the biomaterial textile composition is intended to serve as a leather analog material. Whereas true leather and most existing synthetic polyurethane-based faux leather materials are porous and wettable by conventional polyurethane coatings, many biomaterial textile compositions according to the present invention, especially those that include fungal biomass, are soft, non-porous, and hydrophobic in the absence of coating; these differences necessitate the use of different coating materials (and, most typically, different wetting agents) than those used for true leather and existing synthetic faux leather materials. Particularly, the use of silicone surfactants/surface tension modifiers and wetting agents, in combination with standard and/or commercially available polyurethane coating compositions, may be desirable in some embodiments to overcome the hydrophobic (30-36 dynes/cm) surface energy of the biomaterial textile composition and thus enhance the wettability and improve the wet-out of the coating formulation. As certain mechanical properties (e.g., modulus of elasticity) of biomaterial textile compositions according to the present disclosure may differ from those of true leather, it is also preferable in many embodiments to select and/or modify the coating material(s) to “match” mechanical properties appropriately. It is also to be noted that, whereas many commercially available coating formulations contain penetrating oils, sealers, and the like to seal the pores in cowhide or synthetic faux leather, these ingredients are not necessary for application in many embodiments of biomaterial textile compositions according to the present disclosure.

In embodiments, the coating material may include one or more pigments or dyes so as to provide a desired color to the coating material and thus to the coated surface of the finished biomaterial textile composition. As those of ordinary skill in the art will appreciate, the coating formulations and processes disclosed herein are highly versatile and easily lend themselves to the use of a wider range of colors than may be possible with true leather or other similar conventional textile materials. In some embodiments, it may be preferable for the pigments and/or dyes to be largely or entirely biologically derived to improve the environmental impact and sustainability of the biomaterial textile manufacturing process; non-limiting examples of suitable biologically derived pigments and/or dyes include Living Ink algae-based pigments, such as Algae Black™.

A first non-limiting example of a coating material “recipe” suitable for application to surfaces of biomaterial textile compositions according to the present disclosure includes a first “base” or “adhesive” composition including about 65 parts by weight of an aqueous primer (e.g., Quaker AP-1683), about 15 parts by weight of a water-based aliphatic polyurethane resin (e.g., Quaker PR-1576), about 20 parts by weight of one or more pigments, and about 3 parts by weight of an aliphatic isocyanate crosslinker (e.g., Quaker AM-1506XL), and a second “top” composition including about 25 parts by weight of a “dull” aqueous dispersion or solution of polyurethanes (e.g., Quaker DT-1684), about 75 parts by weight of a “bright” aqueous dispersion or solution of polyurethanes (e.g., Quaker BT-1589), about 2 parts by weight of a silicone-based additive that enhances surface feel and haptic properties (e.g., Quaker AW-1198), about 5.1 parts by weight of an aliphatic isocyanate crosslinker (e.g., Quaker AM-1506XL), and about 5.355 parts by weight water. A second non-limiting example of a coating material “recipe” suitable for application to surfaces of biomaterial textile compositions according to the present disclosure includes a first “base” or “adhesive” composition including about 200 parts by weight of an anionic aliphatic polyurethane dispersion (e.g., Bayderm Bottom PG), about 200 parts by weight of a medium-hard self-crosslinkable acrylic dispersion (e.g., PRIMAL SCL 371), about 50 parts by weight of one or more additional aliphatic polyurethane dispersions (e.g., AQUADERM Finish 85 UD), about 150 parts by weight of a filler and/or material that enhances the “dry” handfeel of the finished composition (e.g., EUDERM X-Grade SF), about 50 parts by weight of a silica dispersion additive that reduces gloss and protects one or more underlying layers during embossing (e.g., EUDERM Matt SN 2), about 10 parts by weight of a polyethylene glycol/urethane-based thickener (e.g., ACRYSOL RM 2020 E), about 50 parts by weight of an aliphatic polyisocyanate crosslinker (e.g., AQUADERM XL 50), and about 30 parts by weight of a carbodiimide crosslinker (e.g., RODA Link 5777), and a second “top” composition including about 550 parts by weight of a first polycarbonate/acrylic material (e.g., AQUADERM Matt A), about 100 parts by weight of a second polycarbonate/acrylic material (e.g., AQUADERM Gloss A), about 60 parts by weight of a silicone-based emulsion for improving abrasion resistance (e.g., AQUADERM Additive DF), about 30 parts by weight of an additive that provides a “silky” or “waxy” feel (e.g., AQUADERM Additive GF), about 10 parts by weight of a polysiloxane-polyether that enhances film formation (e.g., AQUADERM Fluid H), about 100 parts by weight of an aliphatic polyisocyanate crosslinker (e.g., AQUADERM XL 50), and about 20 parts by weight of a carbodiimide crosslinker (e.g., RODA Link 5777).

It is to be expressly understood that, while application of coatings may be desirable in certain embodiments, it is by no means necessary for all embodiments. Particularly, embodiments of the present disclosure encompass biomaterial textile compositions that are suitable for use as a textile product by an end consumer and that do not include or require coatings or surface finishings.

### Pattern and Texture

In embodiments of the present disclosure, biomaterial textile compositions may be provided with an aesthetic pattern or design on at least one surface thereof, which may be a coated/finished surface or an uncoated/unfinished surface. In general, such aesthetic patterns or designs may be imparted to the biomaterial textile compositions by any suitable method or process used to impart aesthetic patterns or designs to, e.g., true leather, conventional synthetic leather substitutes, and the like; non-limiting examples of such methods and processes include embossing (e.g., roller embossing, flat plate embossing, roll-to-roll embossing, etc.), stamping, laser cutting, and laser etching.

In some embodiments, sheets and/or layers of biomaterial textile compositions according to the present disclosure may be roller-embossed immediately upon extrusion, i.e., the sheets output from an extruder may be fed directly to one or more textured rollers, which press the sheets and imprint a pattern or texture thereon. Typically, a biomaterial textile sheet may be extruded out of a sheet die and into a roll stack that applies a selected pressure to the sheet, and the sheet may then be carried along a belt onto a winder, where it is wound onto a core to make a roll; one or more rollers may contain the pattern with which the biomaterial textile sheet is to imprinted as it emerges from the die and through the rollers. In some such embodiments, a backing material can also be fed into the rollers, such that when the pressure is applied, the backing material is bonded to the biomaterial textile sheet upon exiting the roll stack.

Additionally or alternatively, sheets and/or layers of biomaterial textile compositions according to the present disclosure may be embossed using textured films or uncoated transfer films in a similar manner to the roller embossing described above. It may even, in some embodiments, be possible and desirable for a biomaterial textile sheet according to the present disclosure to be laminated together with a backing material, coated with a topcoat material, and embossed in what is effectively a single process step by using a combination of backing material-fed rollers, coated transfer films (to apply the topcoating), and uncoated transfer films (to apply the embossing pattern), while in other embodiments a backing material and/or topcoat may be applied before and/or after embossing by uncoated transfer films.

Additionally or alternatively, sheets and/or layers of biomaterial textile compositions according to the present disclosure may be embossed using a silicon emboss film, particularly by pressing the silicon emboss film together with the one or more sheets and/or layers of the biomaterial textile composition (e.g., in a heat press). Suitable silicon emboss films can be made, by way of non-limiting example, by casting a silicon negative on a textured surface such as a patterned polyvinyl acetate (PVA) paper, which itself may be made, by way of non-limiting example, by 3D-printing a texture pattern onto a PVA paper template.

In some embodiments, a pattern or texture may be applied to sheets and/or layers of biomaterial textile compositions according to the present disclosure by ultraviolet-cured resin printing. In this process, a pattern or texture is 3D-printed onto an ultraviolet-cured resin; a “negative” of this pattern or texture is obtained by casting material onto the cured resin, and the casted negative is pressed onto the sheet/layer of the biomaterial textile composition to emboss the pattern or texture thereon.

### Articles of Manufacture

In embodiments of the present disclosure, an article of manufacture may comprise a biomaterial textile composition as disclosed herein. Non-limiting examples of articles of manufacture that may be made at least partially, and in some embodiments entirely or substantially entirely, from biomaterial textile compositions according to the present disclosure include fashion articles (i.e., articles of clothing, garments, apparel, apparel accessories, etc.), automotive interiors and accessories, interior furnishings, and the like.

In some embodiments, an article of clothing or a garment may comprise a biomaterial textile composition according to the present disclosure. Non-limiting examples of such articles of clothing and garments include shoes, socks, undergarments, gloves, scarves, belts, protective garments, shirts, pants, shorts, jackets, coats, hats, boots, sandals, flip-flops, watch straps, and aprons.

In some embodiments, an apparel accessory may comprise a biomaterial textile composition according to the present disclosure. Non-limiting examples of such apparel accessories include purses, clutches, billfolds, wallets, bags and cases (e.g., handbags, suitcases and other luggage items, briefcases, satchels, cosmetic bags, backpacks, hip packs, etc.), phone cases, jewelry items, and hair accessories.

In some embodiments, an automotive interior or accessory, or a component thereof, may comprise a biomaterial textile composition according to the present disclosure. Non-limiting examples of such automotive interiors and accessories, and components thereof, include seat covers, upholstery, trim, armrests, headrests, console wraps, dashboards, flooring, and steering wheel covers. It is to be expressly understood that such interiors or accessories, or components thereof, may suitably be used in vehicles and conveyances other than automobiles (e.g., airplanes, trains, etc.).

In some embodiments, an interior furnishing may comprise a biomaterial textile composition according to the present disclosure. Non-limiting examples of such interior furnishings include wall coverings, artworks, and furniture items (e.g., chairs, recliners, couches, sofas, loveseats, ottomans, etc.).

It is to be particularly understood that many embodiments of biomaterial textile compositions according to the present disclosure may be suitable for incorporation into articles of manufacture other than those used in landscaping, farming, and agriculture, and may be particularly suitable for incorporation into articles of manufacture that are adapted for indoor use only, indoor/outdoor use, or periodic or occasional outdoor use, rather than substantially permanent outdoor use. This stands in contrast to many currently known articles of manufacture made from textile or textile-like materials derived from non-animal biomass, such as mulch films; these articles are generally confined to landscaping, farming, or agriculture applications, and/or are adapted for substantially permanent outdoor use.

Embodiments of the present disclosure are further described by way of the following illustrative and non-limiting Examples.

### Example 1

### Poly(Styrene-Farnesene-Styrene) Block Copolymer/Segmented Polyester Elastomer Blends

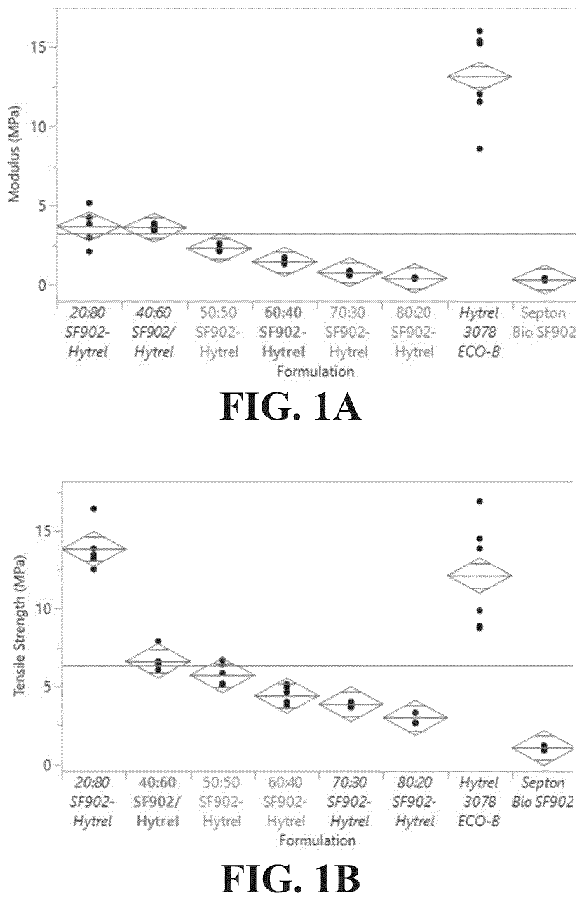

Approximately 0.8 mm-thick sheets of blends of a poly(styrene-farnesene-styrene) block copolymer (Septon Bio SF902 (Kuraray)) and Hytrel 3078 ECO-B (Celanese) were prepared by dry-blending pellets of each polymer in a bag and feeding the blended pellets to a 1.5″ single-screw extruder with an 8″-wide sheet die set to a nominal gap thickness of 0.8 mm. The single-screw extruder had five barrel zones, each set to a temperature of 400° F., and was set to a screw speed of 15 rpm. The extruded sheets were fed directly from the sheet die to a chilled roll stack to control the material and control its thickness. After extrusion, the sheets were conditioned at 25° C. and 50% relative humidity for 24 hours before they were subjected to tensile property testing in accordance with ISO 3376. The tensile modulus and tensile strength of sheets made from varying weight ratios of Septon Bio SF902 and Hytrel 3078 ECO-B are shown in FIGS. 1A and 1B, respectively.

While Septon Bio SF902 is extremely soft (having a Shore A hardness of about 8) and flexible (as suggested by its very low tensile modulus of about 0.3 MPa), it forms poor-quality sheets when extruded (i.e., it has a very low melt flow index) and its tensile strength, especially at high temperature, is too low for most useful applications. By contrast, Hytrel 3078 ECO-B is a high-performance polymer with a much higher tensile strength, but is much stiffer (having an elastic modulus about 40 times higher than Septon Bio SF902) and harder (having a Shore D hardness of about 30), which dramatically degrades the “handfeel” of the Hytrel polymer in textile applications. As this Example demonstrates, by blending the Septon and Hytrel polymers, the processability, and thus film quality, of extruded sheets are dramatically improved compared to sheets of 100% Septon Bio polymer, and the tensile strength can be dramatically improved (while maintaining a significant lower tensile modulus) relative to the pure Hytrel polymer.

### Example 2

Poly(Styrene-Farnesene-Styrene) Block Copolymer/Segmented Bio-Polyester Blends with Additional Biomass

Fusarium strain flavolapis was grown into mycelium sheets via a liquid-air fermentation process. The mycelium was deactivated, water-washed, dried in a convection oven at 120° C., and milled into a coarse mycelium powder (D90=216 μm) and a fine mycelium powder (D90=8.5 μm).

Blends of a poly(styrene-farnesene-styrene) block copolymer (Septon Bio SF902 (Kuraray)), a segmented polyester elastomer (Hytrel 3078 ECO-B (Celanese)), and fungal biomass were compounded and pelletized using a Leistritz twin-screw extruder equipped with 27 mm diameter screws operating at 100 rpm. Three blends were prepared: one consisting of 35 wt % of each of the two polymers and 30 wt % of the coarse mycelium powder; one consisting of 35 wt % of each of the two polymers and 30 wt % of the fine mycelium powder; and one consisting of 31.5 wt % of each of the two polymers, 27 wt % of the fine mycelium powder, and 10 wt % of a compatibilizer (Dow Retain 3000). Strands of each of these three blends were extruded with a ten-zone barrel temperature profile given in Table 1 (where zone 1 is the zone closest to the feed throat and zone 10 is the zone closest to the strand die) and fed through a water trough to a pelletizer. A target throughput of the extruder was set to 9 lb/hr and controlled by controlling the flowrate of the materials into the extruder; the two polymers were fed as pellets directly into the extruder feed throat by separate loss-in-weight feeders, and the mycelium powder was fed via a third loss-in-weight feeder at barrel zone 5. Vent ports at barrel zones 4 and 8 and a vacuum pump at barrel zone 10 were used to ensure that any volatiles produced during extrusion escaped the extruder before the melt entered the die.

TABLE 1

| Zone | Temperature (° F.) |
|---|---|
| 1 | 428 |
| 2 | 428 |
| 3 | 392 |
| 4 | 356 |
| 5 | 356 |
| 6 | 338 |
| 7 | 338 |
| 8 | 320 |
| 9 | 320 |
| 10 | 338 |

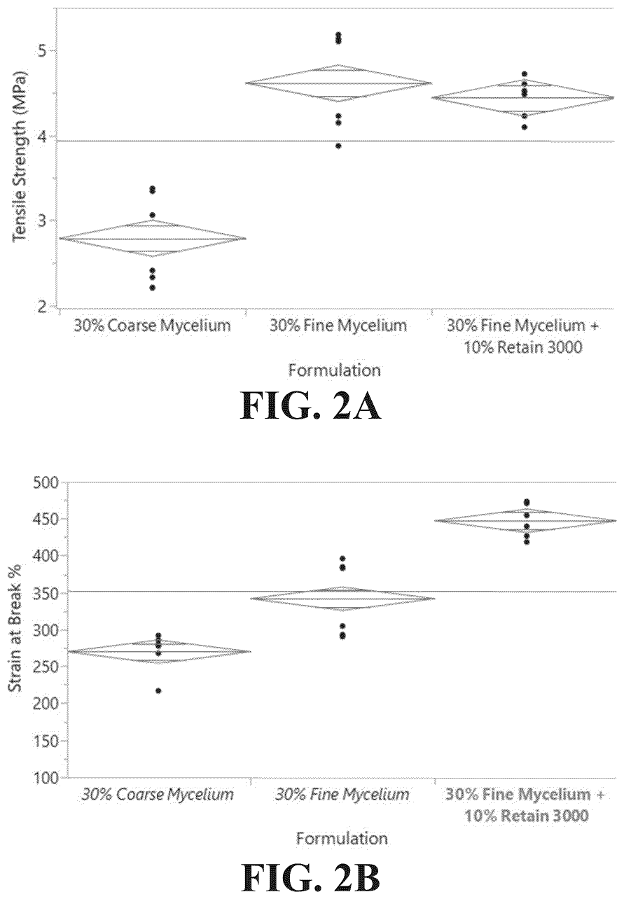

The compounded pellets were then dried to a moisture content of less than 0.5 wt % in a desiccant oven and extruded into biocomposite sheets using a single-screw extruder with a 1.5″ screw and an 8″-wide sheet die set to a nominal gap thickness of 0.8 mm. The single-screw extruder had five barrel zones with a barrel temperature profile outlined in Table 2 (where zone 1 is the zone closest to the feed throat and zone 5 is the zone closest to the sheet die); the screw speed was set to 15 rpm. The extruded sheets were fed directly from the sheet die to a chilled roll stack to cool the material and control its thickness. After extrusion, the biocomposite sheets were conditioned at 25° C. and 50% relative humidity for 24 hours before they were subjected to tensile property testing in accordance with ISO 3376. The tensile strength and elongation at break of the three types of sheet are shown in FIGS. 2A and 2B, respectively.

TABLE 2

| Zone | Temperature (° F.) |
|---|---|
| 1 | 340 |
| 2 | 350 |
| 3 | 360 |
| 4 | 370 |
| 5 | 375 |
| Adaptor | 380 |
| Sheet die | 355 |

As this Example demonstrates, the use of fungal mycelium with a smaller average particle size in biocomposite sheets according to the disclosure led to a substantial improvement in tensile strength and elongation at break. Adding a compatibilizer led to a further significant increase in elongation at break while maintaining a similar tensile strength, thereby improving the overall mechanical toughness of the biocomposite material. The sheets were also found to have Shore A hardness values of 62-68, providing a much softer relative to the Hytrel polymer alone (which has a Shore A hardness value of over 90).

### Example 3

### Elastic Modulus Tuning by Variation in Fungal Biomass Content

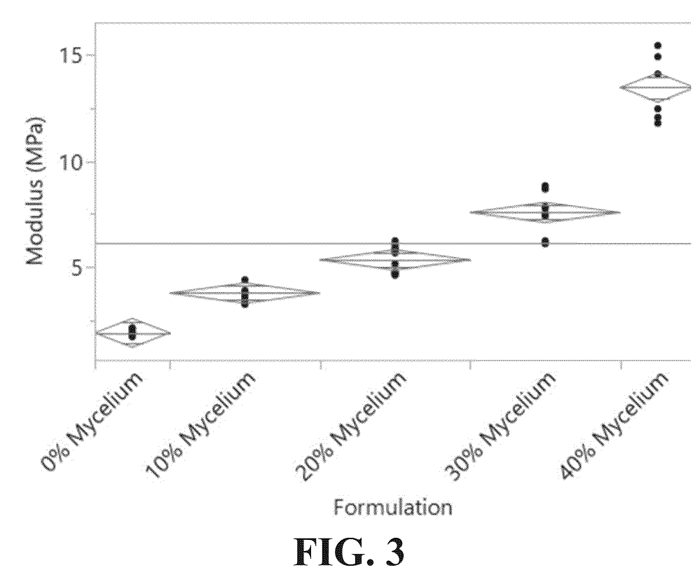

Sheets of the coarse mycelium powder-containing blend described in Example 2 were prepared, except that varying amounts of mycelium (0, 10, 20, 30, and 40 wt %) were used, with the amounts of the other components varied pro rata accordingly. The elastic moduli of these sheets were measured and are shown in FIG. 3.

This Example demonstrates that the quantity of mycelium fibers can be used to fine-tune the elastic modulus of the biocomposite material. This can be particularly useful when laminating backing fabrics or adding topcoats to the material to form a textile, as mismatch in the elastic modulus between the biocomposite material and other layers with which it is combined by coating/lamination can lead to material failures, especially in fatigue testing.

### Example 4

### Poly(Styrene-Farnesene-Styrene) Block Copolymer/Poly(Styrene-Butadiene-Styrene) Block Copolymer Blends

Approximately 1 mm-thick sheets of blends of a poly(styrene-farnesene-styrene) block copolymer (Septon Bio SF902 (Kuraray)) and a poly(styrene-butadiene-styrene) block copolymer (Styroflex 2G66 B60 (INEOS)) were extruded directly into sheets on a Thesyon twin-screw extruder equipped with 21 mm diameter screws operating at 250 rpm and an 8″-wide sheet die set to a nominal gap thickness of 0.8 mm. The extruded sheets were fed directly from the sheet die to a chilled roll stack to cool the material and control its thickness. Sheets of different compositions, having selected Styroflex:Septon Bio weight ratios, were produced by varying the feed rates of the two polymers, which were fed as pellets directly into the extruder feed throat via separate loss-in-weight feeders; the target throughput of the extruder was 10 lb/hr. The barrel temperature profile is given in Table 3 (where zone 1 is the zone closest to the feed throat and zone 5 is the zone closest to the sheet die). After extrusion, the sheets were conditioned at 25° C. and 50% relative humidity for 24 hours before they were subjected to tensile property testing in accordance with ISO 3376.

TABLE 3

| Zone | Temperature (° F.) |
|---|---|
| 1 | 350 |
| 2 | 400 |
| 3 | 400 |
| 4 | 400 |
| 5 | 400 |
| Adaptor | 400 |
| Sheet die | 330 |

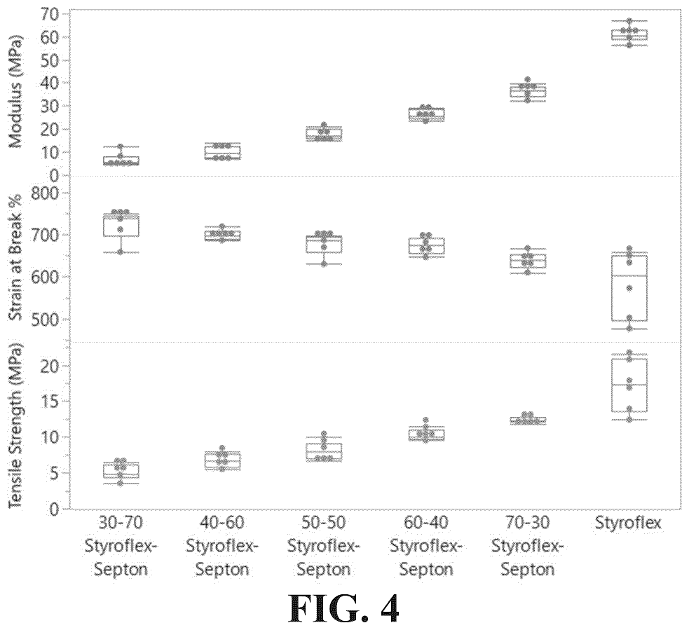

As FIG. 4 illustrates, extruded sheets of the pure Styroflex polymer have an elastic modulus of approximately 65 MPa and a Shore A hardness of over 90, which results in a “handfeel” typical of a flexible plastic material but unsuitable as a leather analog material or other similar textile. Blends of this polymer with the Septon Bio polymer have substantially reduced elastic modulus and hardness, and thus substantially improved handfeel and drapability. It was subjectively found that the most dramatically different handfeel was achieved with Styroflex:Septon Bio weight ratios of 30:70 or 40:60; further addition of the Septon Bio polymer continues to increase the elongation at break, but results in progressively lower tensile strength. This Example thus demonstrates that a blend for a particular application can be obtained having both a desired handfeel with a high tensile strength value.

### Example 5

### Poly(Styrene-Farnesene-Styrene) Block Copolymer/Poly(Ethylene-Vinyl Acetate) Blends

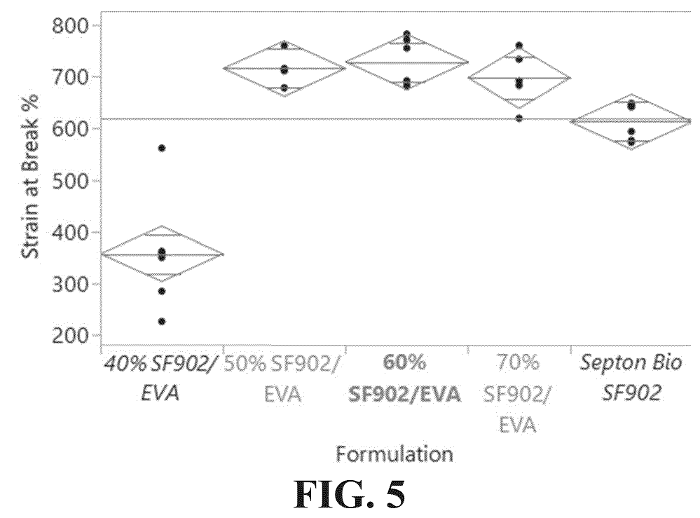

Approximately 0.8 mm-thick sheets of blends of a poly(styrene-farnesene-styrene) block copolymer (Septon Bio SF902 (Kuraray)) and poly(ethylene-vinyl acetate) copolymer (I'm Green EVA SVT2180 (Braskem)) were prepared by dry-blending pellets of each polymer in a bag and feeding the blended pellets to a 1.5″ single-screw extruder with an 8″-wide sheet die set to a nominal gap thickness of 0.8 mm. The single-screw extruder had five barrel zones, each set to a temperature of 400° F., and was set to a screw speed of 15 rpm. The extruded sheets were fed directly from the sheet die to a chilled roll stack to control the material and control its thickness. After extrusion, the sheets were conditioned at 25° C. and 50% relative humidity for 24 hours before they were subjected to tensile property testing in accordance with ISO 3376. The strain at break of sheets made from varying weight ratios of Septon Bio SF902 and I'm Green EVA SVT2180 is shown in FIG. 5.

While Septon Bio SF902 is extremely soft (having a Shore A hardness of about 8) and flexible (as suggested by its very low tensile modulus of about 0.3 MPa), it forms poor-quality sheets when extruded and its tensile strength is too low for most useful applications. By contrast, I'm Green EVA SVT2180 has much higher tensile strength, but is much stiffer (having an elastic modulus about 165 times higher than Septon Bio SF902) and harder (having a Shore A hardness of about 89), which dramatically degrades the “handfeel” of the I'm Green polymer in textile applications. As this Example demonstrates, by blending the Septon and I'm Green polymers, the processability, and thus film quality, of extruded sheets are dramatically improved compared to sheets of 100% Septon Bio polymer, and the tensile strength can be dramatically improved (while maintaining a significant lower tensile modulus) relative to the pure I'm Green polymer.

### Example 6

### Bio-Based Synthetic Leather Composite

Sheets of a blend of 40 wt % Septon Bio SF902, 40 wt % Hytrel 3078 ECO-B, and 20 wt % fungal biomass in the form of a coarse mycelium powder were prepared as described in Example 2; this material is referred to hereinafter as “Biocomposite A.” These sheets were then formed into a composite leather analog material by either of two different “leathermaking” processes.

In the first leathermaking process, Lubrizol Sancure 20025F and an adhesion promoter (Worthen 3296) were rolled, brushed, or sprayed onto sheets of Biocomposite A and allowed to dry. A lyocell-spandex textile knit was then placed on top of the Sancure-coated surface of the Biocomposite A sheet. Using a Practix OK-160 draw slide press, this layered assembly was heat-pressed at 155° C. and 100 psi for 60 seconds to adhere the textile backing to the Biocomposite A sheet. Via a standard method for measuring adhesive peel resistance (ASTM 1876), the adhesive strength of the backing was found to be 1.2±0.4 N/mm.

The second leathermaking process was identical to the first, except that the Sancure and adhesion promoter were replaced with a web adhesive (Bostik PE120), the lyocell-spandex knit was replaced with a polyester-spandex knit, and the heat-pressing temperature was increased to 175° C. Via a standard method for measuring adhesive peel resistance (ASTM 1876), the adhesive strength of the backing was found to be 1.4±0.5 N/mm.

Samples of the leather analog material made by the second leathermaking process were then subjected to various topcoating and/or embossing steps. Particularly, a polyurethane topcoat, consisting of a blend of polyurethanes, isocyanates, silicone-based handfeel modifiers, dulling agents, wetting agents, and pigments, was spray-coated onto samples of the leather analog material.

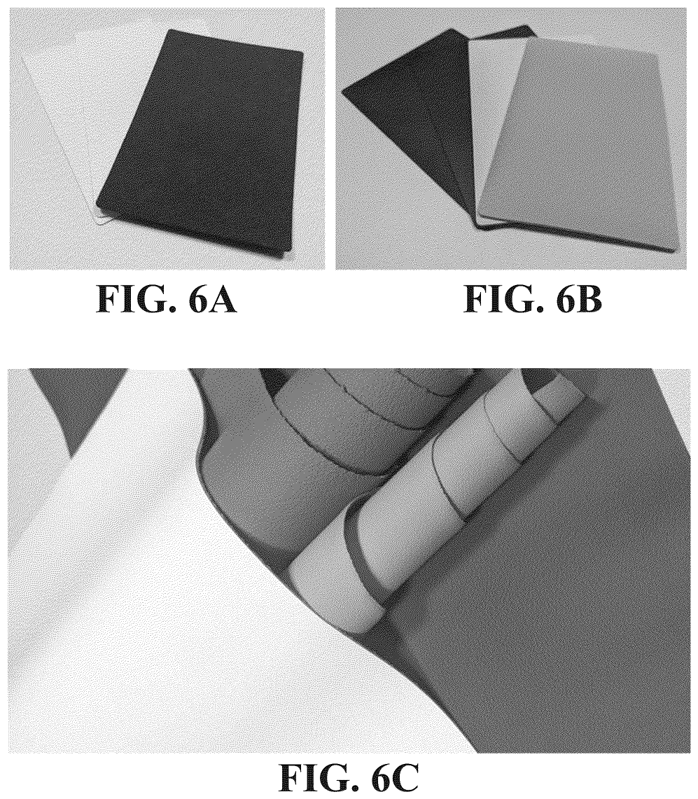

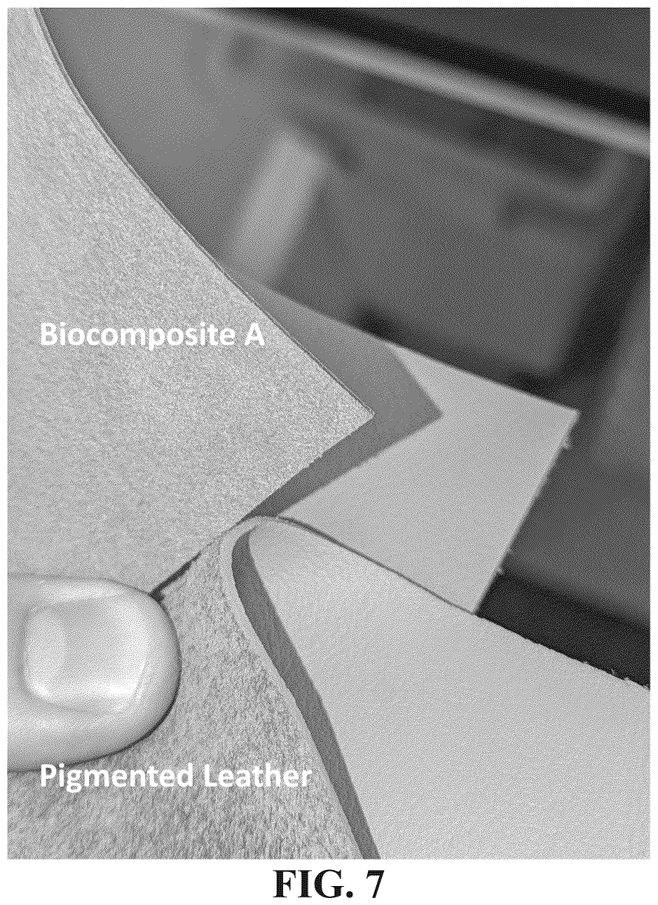

After topcoating, the samples were embossed by placing release papers engraved with various patterns onto the topcoated side of Biocomposite A and heat-pressing the engraved release paper onto the coating at 155° C. and 100 psi for 60 seconds. FIGS. 6A, 6B, and 6C illustrate topcoated and embossed leather analog materials according to this Example. FIG. 7 illustrates a leather analog material in which the aesthetics of hide/true leather were more closely matched by selecting a backing fabric that mimics the “crust” appearance of leather, and, on the opposing side, applying a topcoat composition and embossing pattern that mimic the handfeel and aesthetic of pigmented leather.

### Example 7

Injection-Molded Poly(Styrene-Farnesene-Styrene)/Poly(Ethylene-Vinyl Acetate) Blends with Additional Biomass

Fusarium strain flavolapis biomass was grown via a stirred-tank submerged fermentation process. Steam was injected into the fermentation vessel until the temperature inside the vessel reached about 80° C. to deactivate the growth of the biomass. The mycelium was then washed with deionized water and the washed biomass was collected and spray-dried from a moisture content of about 75 wt % to a moisture content of about 2 wt %. The particle size distribution of this spray-dried fungal biomass was determined by sieving the particles through meshes of various sizes, with the percentage of particles retained on a particular screen indicating the percentage of particles larger than that sieve size. The particle size distribution is shown in Table 4 below.

TABLE 4

| Sieve | Sieve | % particles |
|---|---|---|
| mesh # | size (μm) | retained |
| 35 | 500 | 0.00 |
| 60 | 250 | 0.14 |
| 100 | 150 | 0.28 |
| 200 | 75 | 52.41 |
| 270 | 53 | 11.95 |
| 500 | 25 | 29.19 |
| Bottom pan | 0 | 6.03 |

Blends of the spray-dried fungal biomass, a poly(styrene-farnesene-styrene) block copolymer (Septon Bio SF902 (Kuraray)), and a segmented polyester elastomer (Braskem I'm Green™ EVA), and fungal biomass were compounded and pelletized using a Leistritz twin-screw extruder equipped with 27 mm diameter screws operating at 200 rpm. Two blends were prepared: one consisting of 46 wt % Septon Bio SF902, 31 wt % Braskem I'm Green™ EVA, 20 wt % fungal biomass, and 3 wt % red pigment and one consisting of 38.66 wt % Septon Bio SF902, 25.77 wt % Braskem I'm Green™ EVA, 20 wt % fungal biomass, and 15.57 wt % white pigment. Strands of each of these blends were extruded with a ten-zone barrel temperature profile given in Table 5 (where zone 1 is the zone closest to the feed throat and zone 10 is the zone closest to the strand die) and fed directly to an underwater pelletizer. A target throughput of the extruder was set to 40 lb/hr and controlled by controlling the flowrate of the materials into the extruder; the two polymers were fed as pellets directly into the extruder feed throat by separate loss-in-weight feeders, and the fungal biomass was fed via a third loss-in-weight feeder at barrel zone 5. Vent ports at barrel zones 4 and 8 and a vacuum pump at barrel zone 10 were used to ensure that any volatiles produced during extrusion escaped the extruder before the melt entered the die.

TABLE 5

| Zone | Temperature (° F.) |
|---|---|
| 1 | 310 |
| 2 | 310 |
| 3 | 300 |
| 4 | 300 |
| 5 | 280 |
| 6 | 280 |
| 7 | 270 |
| 8 | 270 |
| 9 | 270 |
| 10 | 270 |

The compounded pellets were then dried in a desiccant dryer and then subjected to a second compounding step to introduce a pigment (red for the 20 wt % fungal biomass composition and white for the 30 wt % fungal biomass composition). The pigmented pellets were injection-molded into plaques of varying thickness and subjected to tensile property testing in accordance with ISO 3376; the red (20% fungal biomass) material was found to have a tensile modulus of 20.7 MPa, a strain at break of 116.7%, and a tensile strength of 2.2 MPa, while the white (30% fungal biomass) material was found to have a tensile modulus of 22.1 MPa, a strain at break of 163.6%, and a tensile strength of 2.7 MPa.

### Example 8

### Poly(Farnesene-Styrene)/Poly(Farnesene-Styrene-Butadiene)/Poly(Styrene-Butadiene) Blends

Approximately 1 mm-thick sheets of blends of a poly(styrene-farnesene-styrene) block copolymer (Septon Bio SF902 (Kuraray)), a poly(styrene-butadiene-styrene) block copolymer (Styroflex 2G66 B60 (INEOS)), and a poly(farnesene-styrene-butadiene) block copolymer (Septon Bio SF904 (Kuraray)) were extruded directly into sheets on a Thesyon twin-screw extruder equipped with 21 mm diameter screws operating at 250 rpm and an 8″-wide sheet die set to a nominal gap thickness of 0.8 mm. The extruded sheets were fed directly from the sheet die to a chilled roll stack to cool the material and control its thickness. Sheets of different compositions, having selected SF902:Styroflex:SF904 weight ratios, were produced by varying the feed rates of the three polymers, which were fed as pellets directly into the extruder feed throat via two separate loss-in-weight feeders; specifically, one loss-in-weight feeder contained different dry-blended ratios of the two Septon polymers, while the second loss-in-weight feeder contained the Styroflex polymer. The target throughput of the extruder was 5 lb/hr. The barrel temperature profile is given in Table 6 (where zone 1 is the zone closest to the feed throat and zone 5 is the zone closest to the sheet die). After extrusion, the sheets were conditioned at 25° C. and 50% relative humidity for 24 hours before they were subjected to further testing.

TABLE 6

| Zone | Temperature (° F.) |
|---|---|
| 1 | 350 |
| 2 | 400 |
| 3 | 400 |
| 4 | 400 |
| 5 | 400 |
| Adaptor | 400 |
| Sheet die | 390 |

The quality of the films extruded from the sheet die was evaluated qualitatively based on the ability of the film to continuously retain a rectangular shape as it was pulled through the roll stack. The film quality of each of the various blended sheets is given in Table 7.

TABLE 7

| SF902 wt % | SF904 wt % | Styroflex wt % | Film quality |
|---|---|---|---|
| 30 | 30 | 40 | Minor edge tears |
| 32.5 | 32.5 | 35 | |
| 35 | 35 | 30 | |
| 36 | 24 | 40 | Moderate edge tears |
| 39 | 26 | 35 | |
| 42 | 28 | 30 | |
| 24 | 36 | 40 | No edge tears |
| 26 | 39 | 35 | |
| 28 | 42 | 30 | |
| 20 | 30 | 50 | |
| 16 | 24 | 60 | |

Films consisting of 50% Styroflex polymer, 20% Septon Bio SF902, and 30% Septon Bio SF904 were subjected to tensile property testing in accordance with ISO 3376 and found to have a tensile modulus of 7.0±6.0 MPa, an elongation at break of 670.2%±22.4%, a tensile strength of 5.9±1.3 MPa, and an area under the curve of 22.1±3.5 MPa.

### Example 9

### Incorporation of Bio-Based Polybutylene Succinate and Low-Density Polyethylene as Process Aids in Poly(Farnesene-Styrene)/Poly(Ethylene-Vinyl Acetate) Blends

Approximately 0.7 mm-1 mm-thick sheets of blends of a poly(styrene-farnesene-styrene) block copolymer (Septon Bio SF902 (Kuraray)), a biologically derived poly(ethylene-vinyl acetate) (Braskem I'm Green™ EVA), and either polybutylene succinate (PBS) (FZ91PB, Mitsubishi Chemical Group) or low-density polyethylene (LDPE) (SBC818, Braskem) were extruded directly into sheets on a Thesyon twin-screw extruder equipped with 21 mm diameter screws operating at 255 rpm and an 8″-wide sheet die set to a nominal gap thickness of 0.7 mm. The extruded sheets were fed directly from the sheet die to a chilled roll stack to cool the material and control its thickness. Sheets of different compositions, having selected ratios of the polymers, were produced by varying the feed rates of the polymers, which were fed as pellets directly into the extruder feed throat via two separate loss-in-weight feeders; specifically, one loss-in-weight feeder contained different dry-blended ratios of the Septon and EVA polymers, while the second loss-in-weight feeder contained either PBS or LDPE. The target throughput of the extruder was 5 lb/hr. The barrel temperature profile is given in Table 8 (where zone 1 is the zone closest to the feed throat and zone 5 is the zone closest to the sheet die). After extrusion, the sheets were conditioned at 25° C. and 50% relative humidity for 24 hours before they were subjected to further testing.

TABLE 8

| Zone | Temperature (° F.) |
|---|---|
| 1 | 388 |
| 2 | 400 |
| 3 | 375 |
| 4 | 375 |
| 5 | 375 |
| Adaptor | 375 |
| Sheet die | 385 |

The quality of the films extruded from the sheet die was evaluated qualitatively based on the extent of surface roughening and edge tearing. The film quality of each of the various blended sheets is given in Table 9.

TABLE 9

| Sample | Parts by weight | | | | |
|---|---|---|---|---|---|
| ID | SF902 | EVA | LDPE | PBS | Film quality |
| 1 | 60 | 40 | 0 | 0 | Significant surface roughening |
| 2 | 70 | 30 | 0 | 0 | Significant surface roughening |
| 3 | 70 | 30 | 10 | 0 | No visible defects |
| 4 | 75 | 25 | 10 | 0 | Significant edge tearing |
| 5 | 75 | 25 | 14 | 0 | Minor edge tearing |
| 6 | 75 | 25 | 18 | 0 | Minor edge tearing |
| 7 | 75 | 25 | 22 | 0 | No visible defects |
| 8 | 75 | 25 | 0 | 9 | Minor edge tearing |
| 9 | 75 | 25 | 0 | 13 | No visible defects |

All ten films were then subjected to tensile property testing in accordance with ISO 3376. The results of this testing, as well as the amount of torque applied by the extruder (expressed as a percentage of the torque limit of the extruder), are given in Table 10.

TABLE 10

| | Extruder torque | Tensile modulus | Tensile strength |
|---|---|---|---|
| Sample ID | (% of max.) | (MPa) | (MPa) |
| 1 | 63 | 8.8 | 4.9 |
| 2 | 62 | 5.4 | 4.6 |
| 3 | 53 | 14.6 | 6.5 |
| 4 | 55 | 9.3 | 4.4 |
| 5 | 55 | 12.5 | 5.4 |
| 6 | 56 | 16.4 | 5.7 |
| 7 | 56 | 15.0 | 5.6 |
| 8 | 50 | 11.0 | 4.2 |
| 9 | 47 | 16.4 | 4.4 |

As Tables 9 and 10 show, increasing the loading of Septon SF 902 resulted in a lower modulus of elasticity, which is a desirable feature of a drapable textile, but at higher SF 902 loadings, the quality of the extruded sheets was compromised. Particularly, sheets containing only 60:40 or 70:30 blends of SF 902 and EVA (samples 1 and 2) had a rough surface appearance; this surface roughness was so severe that it could not be repaired by increasing the pressure from the roll stack. However, by adding a polymer with improved melt characteristics, e.g., Braskem I'm Green SBC 818 LDPE (which has an ASTM D 1238 melt index at 190° C. of 8.3) or PBS (melt index of 5) to the blend of SF 902 and EVA (melt indices of 0 and 2.1, respectively), the extrusion quality of the films was significantly improved; this improvement in quality correlates with a reduction in torque applied by the extruder, which can be attributed to improved flow properties of the melted polymer blend. Without wishing to be bound by any particular theory, the present inventors hypothesize that the improved melt flow characteristics are due to a reduction in viscosity and/or an increase in slip velocity of the melt. Introduction of the LDPE or PBS thus enables higher amounts of the SF 902 thermoplastic elastomer to be used, and thus the production of a softer material, while maintaining the quality of the extruded sheet.

### Example 10

### Poly(Farnesene-Styrene)/Low-Density Polyethylene and Poly(Farnesene-Styrene)/Ethylene-Vinyl Acetate Blends

Fusarium strain flavolapis biomass was grown and deactivated as described in Example 7. This biomass was then dried to a moisture content of about 3%, and the dried biomass was jet milled to a particle size of about 20 μm. Two types of biopolymer blend were then made: a first type comprising dried and milled fungal biomass, a poly(styrene-farnesene-styrene) block copolymer (Septon Bio SF902 (Kuraray)), and an ethylene-vinyl acetate (EVA) (SVT2180, Braskem), and a second type comprising dried and milled fungal biomass, the same poly(styrene-farnesene-styrene) block copolymer (Septon Bio SF902 (Kuraray)), and a low-density polyethylene (LDPE) (SBC818, Braskem). Each biopolymer blend was extruded into sheets using a Leistritz twin-screw extruder equipped with 27 mm diameter screws operating at 200 rpm. Sheets of each of these blends were extruded from a 14″-wide adjustable lip sheet die directly onto a temperature-controlled roll stack. The thickness of the sheets was targeted at about 0.7 mm and controlled by manually adjusting the sheet die opening and varying the distance between the rollers on the roll stack; the temperatures of the upper and lower rolls were set to 49° C. and 27° C., respectively, and the winder speed was 2.2 feet per minute. The fifteen-zone barrel temperature profile used for the sheet extrusion is given in Table 11 (where zone 1 is the zone closest to the feed throat and zone 15 is the zone closest to the sheet die). A target throughput of the extruder was set to 20 lb/hr and controlled by controlling the flowrate of the materials into the extruder; the two polymers were fed as pellets directly into the extruder feed throat by separate loss-in-weight feeders, and the fungal biomass was fed via a third loss-in-weight feeder at barrel zone 5. Vent ports at barrel zones 4 and 8 and a vacuum pump at barrel zone 10 were used to ensure that any volatiles produced during extrusion escaped the extruder before the melt entered the die.

TABLE 11

| Zone(s) | Temperature (° C.) |
|---|---|
| Feed throat | 54 |
| 1 | 200 |
| 2 | 190 |
| 3 | 180 |
| 4 | 170 |
| 5 | 170 |
| 6 | 160 |
| 7 | 160 |
| 8 | 160 |
| 9 | 160 |
| 10-15 | 160 |
| Sheet die | 160 |

Table 12 shows the composition of each biopolymer blend, and Table 13 shows the extrusion parameters (die pressure and screw torque) required to extrude the blend, the quality of each extruded sheet, and the minimum proportion of carbon in the non-fungal portion of each blend that was biologically derived (calculated according to ASTM D6866).

TABLE 12

Wt. %

| Blend ID | SF902 | LDPE | EVA | Fungal biomass |
|---|---|---|---|---|
| 1 | 40 | 40 | 0 | 20 |
| 2 | 48 | 32 | 0 | 20 |
| 3 | 56 | 24 | 0 | 20 |
| 4 | 60 | 20 | 0 | 20 |
| 5 | 32 | 0 | 48 | 20 |
| 6 | 40 | 0 | 40 | 20 |
| 7 | 48 | 0 | 32 | 20 |
| 8 | 56 | 0 | 24 | 20 |
| 9 | 60 | 0 | 20 | 20 |

TABLE 13

| | | | | % of biobased |
|---|---|---|---|---|
| | | Extruder | Die | carbon in |
| Blend | | torque | pressure | non-fungal |
| ID | Sheet quality | (% of max.) | (psi) | polymer blend |
| 1 | Smooth surface | 27 | 750 | 88 |
| | No tearing | | | |
| 2 | Smooth surface | 25 | 780 | 86 |
| | No tearing | | | |
| 3 | Smooth surface | 25 | 977 | 85 |
| | No tearing | | | |
| 4 | Smooth surface | 24 | 1050 | 84 |
| | Minor tearing | | | |
| 5 | Smooth | 37 | 1120 | 74 |
| | No defects | | | |
| 6 | Slight surface texture | 36 | 1162 | 75 |
| | No tearing | | | |
| 7 | Slight surface texture | 35 | 1212 | 76 |
| | Edge tearing | | | |
| 8 | Rough surface | NR | NR | 77 |
| | Major defects/tearing | | | |
| | Unable to collect sample | | | |
| 9 | Rough surface | NR | NR | 78 |
| | Major defects/tearing | | | |
| | Unable to collect sample | | | |

As Tables 12 and 13 illustrate, in the EVA blends, above a critical SF902 content (which the present inventors hypothesize to be greater than about 60 wt. %, but less than about 70 wt. %, of the non-fungal portion of the polymer blend), a noticeable degradation in sheet surface finish appearance and overall quality was observed, whereas in the LDPE blends, the SF902 content could be increased to at least about 75 wt. % of the non-fungal portion of the polymer blend while maintaining a high quality of the extruded sheet. Due to the selection of components, the proportion of carbon in the extruded material that was biologically derived was more than 70% for all of the blends.

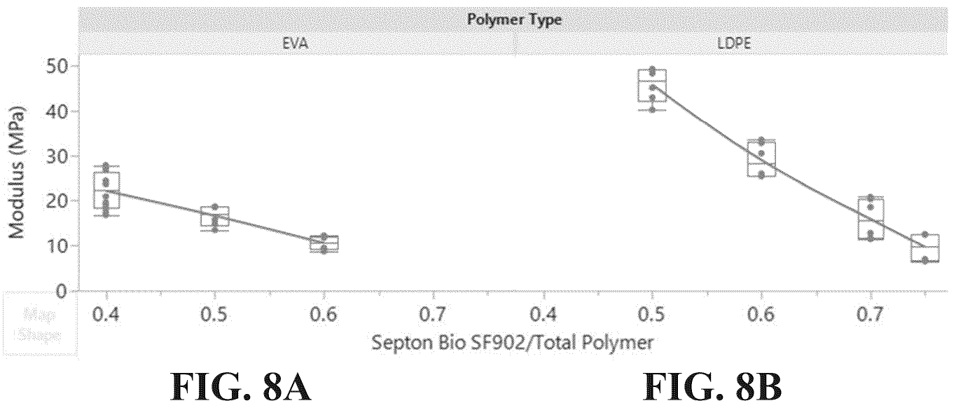

All sheets were conditioned at 25° C. and 50% relative humidity for 24 hours, and then subjected to tensile property testing in accordance with ISO 3376. The elastic moduli, as a function of SF902 content in the non-fungal polymer blend, of the EVA blends and LDPE blends are illustrated in FIGS. 8A and 8B, respectively. As FIGS. 8A and 8B illustrate, increasing the SF902 content resulted in a lower modulus of elasticity, which is a desirable feature of a drapable textile. More specifically, it is generally preferable for the elastic modulus of a drapable textile to be no more than about 30 MPa; this was achieved at all tested SF902 use amounts in the EVA blends, and in the LDPE blends where the SF902 made up at least about 60 wt. % of the non-fungal portion of the polymer blend.

### Example 11

### Crosslinking of Biomaterial Textile Composition Sheets by a Free Radical Initiator

Fusarium strain flavolapis biomass was grown, deactivated, dried, and jet milled as described in Example 10. Two biopolymer blends were then made: a first blend comprising 20 wt. % dried and milled fungal biomass, 48 wt. % of a poly(styrene-farnesene-styrene) block copolymer (Septon Bio SF902 (Kuraray)), and 32 wt. % of an ethylene-vinyl acetate (SVT2180, Braskem), and a second blend that was identical except that 19.9% of the fungal biomass and 0.1 wt. % of a thermally-activated free radical initiator (dicumyl peroxide, Liandox DCP 40-KL, 40% active) were used. Each biopolymer blend was extruded into sheets using a Leistritz twin-screw extruder equipped with 27 mm diameter screws operating at 200 rpm. Sheets of each of these blends were extruded from a 14″-wide adjustable lip sheet die directly onto a temperature-controlled roll stack. The thickness of the sheets was targeted at about 0.7 mm and controlled by manually adjusting the sheet die opening and varying the distance between the rollers on the roll stack; the temperatures of both the upper and lower rolls were set to 27° C., and the winder speed was 2.2 feet per minute. The fifteen-zone barrel temperature profile used for the sheet extrusion is given in Table 14 (where zone 1 is the zone closest to the feed throat and zone 15 is the zone closest to the sheet die). A target throughput of the extruder was set to 20 lb/hr and controlled by controlling the flowrate of the materials into the extruder; the two polymers were fed as pellets directly into the extruder feed throat by separate loss-in-weight feeders, and the fungal biomass powder and, if used, the free radical initiator (which was crushed and dry-blended with the fungal biomass powder) was/were fed via a third loss-in-weight feeder at barrel zone 5. Vent ports at barrel zones 4, 8, and 10 were used to ensure that any volatiles produced during extrusion escaped the extruder before the melt entered the die.

TABLE 14

| Zone(s) | Temperature (° C.) |
|---|---|
| Feed throat | 54 |
| 1 | 195 |
| 2 | 190 |
| 3 | 190 |
| 4 | 175 |
| 5 | 170 |
| 6 | 160 |
| 7 | 155 |
| 8 | 150 |
| 9 | 145 |
| 10 | 140 |
| 11 | 140 |
| 12 | 145 |
| 13 | 155 |
| 14 | 155 |
| 15 | 155 |
| Sheet die | 160 |

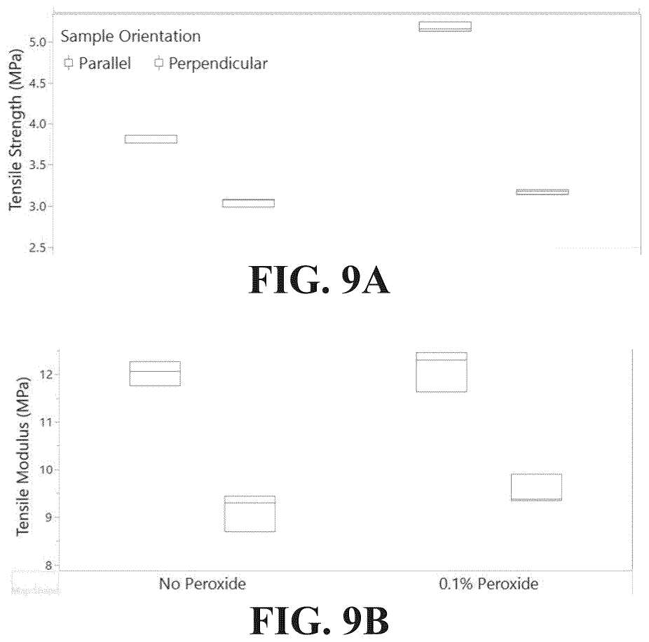

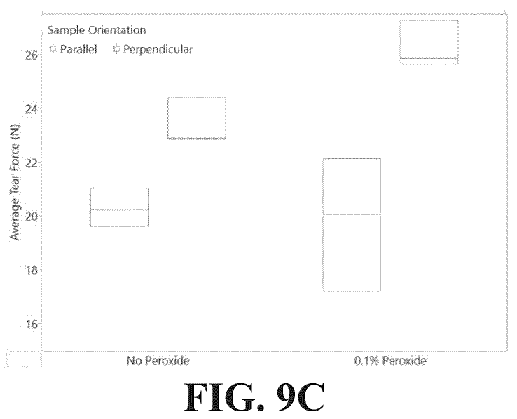

Sheets of each of the two materials were then subjected to tensile strength testing in accordance with ISO 3376 and double edge tear force testing in accordance with ISO 3377, both parallel to and perpendicular to the extrusion direction. The tensile strength, tensile modulus and tear force of each sheet are illustrated in FIGS. 9A, 9B, and 9C, respectively (in each figure, the data are presented as box plots for, from left to right, no crosslinker/parallel direction, no crosslinker/perpendicular direction, crosslinker/parallel direction, and crosslinker/perpendicular direction).

As FIGS. 9A, 9B, and 9C illustrate, the effect of including even a small amount (0.1 wt. %) of the organic peroxide free radical initiator/crosslinker during extrusion has a significant effect on both the tensile strength and tear strength of the product. Specifically, at this concentration of free radical initiator, the tensile strength in the direction parallel to extrusion and the tear force in the direction perpendicular to extrusion are increased significantly by incorporating the peroxide initiator, without altering the modulus of elasticity. Importantly, the torque and pressure measured in the extruder did not increase dramatically during extrusion at this loading level of peroxide initiator. The present inventors therefore anticipate that higher concentrations of peroxide initiator could easily be used, resulting in still greater tensile strength, tear strength, creep resistance, and elastic recovery in the extruded material, without compromising the extrudability of the melt.

### Example 12

### Adhesive-Free Lamination of Polymer Blends to a Polyester Backing

Fusarium strain flavolapis biomass was grown, deactivated, dried, and jet milled as described in Example 10. A biopolymer blend was then prepared, consisting of 38.5 wt % Septon Bio SF902 (Kuraray), 31.5 wt % Braskem I'm Green™ SVT2180 ethylene-vinyl acetate (EVA), 10 wt % titanium dioxide, and 20 wt % fungal biomass. This biopolymer blend was compounded using a Leistritz twin-screw extruder equipped with 27 mm diameter screws, then pelletized by an underwater pelletizer and dried prior to further processing. The compounded and pelletized blend was then extruded into 40″-wide sheets using a Davis Standard single-screw extruder equipped with a 4.5″ screw, a 40″-wide sheet die, and a temperature-controlled roll stack. The thickness of the sheets was controlled and set to about 0.020″.

0.5 mm-thick backing sheets of polyester fabric, made entirely from recycled polyester, were laminated onto sheets of the biopolymer blend by one of three methods. In the first method, the polyester fabric was fed directly into the roll stack of the single-screw extruder, a fixed pressure of about 40 psi was applied to the rollers to press the extruded polymer into the backing material, and the laminated composite was then cooled and hand-wound into rolls; the temperatures of the top, middle, and bottom rollers in the roll stack were approximately 90° F., 160° F., and 150° F., respectively, and the temperature of the biopolymer melt at the sheet die was approximately 350° F. In the second method, the extruded biopolymer blend was cooled, cut into individual 3′-by-1′ sheets, and laminated to the polyester backing using a flatbed hot press (Practix OK-160) at 120° C. and a nominal pressure of 100 psi for two minutes. In the third method, a hot-melt web adhesive (PO102 polyolefin web adhesive, Bostik) was used to laminate the polyester fabric to 3′-by-1′ sheets of the extruded biopolymer blend.

The adhesion strength between the biopolymer layer and the backing layer of each composite sheet was tested according to ASTM D1876, and the tear strength of each composite sheet was tested according to ISO 3377; the average tear force was normalized to the total thickness of each sample. A sheet of the extruded biopolymer composition without a backing layer was also tested as a control. The results are given in Table 15 below. As Table 15 shows, the adhesion strength of all of the composite sheets exceeded 0.5 N/mm, which is generally considered to be the threshold for acceptability for most small accessories. The lamination of the backing layer also resulted in a significant increase in tear strength relative to the unbacked control, and this increase was broadly similar regardless of the lamination method used.

TABLE 15

| | | Tear force | Avg. T-peel | T-peel strength |
|---|---|---|---|---|
| Lamination | Avg. tear | std. dev. | strength | std. dev. |
| method | force (N/mm) | (N/mm) | (N/mm) | (N/mm) |
| None | 30.65 | 1.55 | n/a | n/a |
| First | 42.92 | 8.58 | 0.64 | 0.12 |
| Second | 46.68 | 6.25 | 1.24 | 0.04 |
| Third | 44.71 | 4.79 | 1.10 | 0.01 |

### Example 13

### Impact of Fungal Biomass on Sheet Extrusion Processability

Fusarium strain flavolapis biomass was grown, deactivated, dried, and jet milled as described in Example 10. Two biopolymer blends, one consisting solely of Septon Bio SF902 (Kuraray) and Braskem I'm Green™ ethylene-vinyl acetate (EVA), and the other consisting of the same two polymers plus fungal biomass, were prepared. Each biopolymer blend was extruded into sheets having a thickness of approximately 0.7 mm using a Leistritz twin-screw extruder equipped with 27 mm diameter screws operating at 115 rpm and a 13″-wide adjustable lip sheet die set to a nominal gap thickness of 0.8 mm. The extruded sheets were fed directly from the sheet die to a chilled roll stack to cool the material and control the thickness. The temperatures of both the upper and lower rolls were set to 27° C., and the winder speed was 2.2 feet per minute. The fifteen-zone barrel temperature profile used for the sheet extrusion is given in Table 16 (where zone 1 is the zone closest to the feed throat and zone 15 is the zone closest to the sheet die). A target throughput of the extruder was set to 20 lb/hr and controlled by controlling the flowrate of the materials into the extruder; the two polymers were fed as pellets directly into the extruder feed throat by separate loss-in-weight feeders, and the fungal biomass was fed via a third loss-in-weight feeder at barrel zone 5.

TABLE 16

| Zone(s) | Temperature (° C.) |
|---|---|
| Feed throat | 54 |
| 1 | 195 |
| 2 | 190 |
| 3 | 190 |
| 4 | 170 |
| 5 | 170 |
| 6 | 160 |
| 7 | 155 |
| 8 | 150 |
| 9 | 145 |
| 10 | 140 |
| 11 | 140 |
| 12 | 145 |
| 13 | 155 |
| 14 | 155 |
| 15 | 160 |
| Sheet die | 160 |

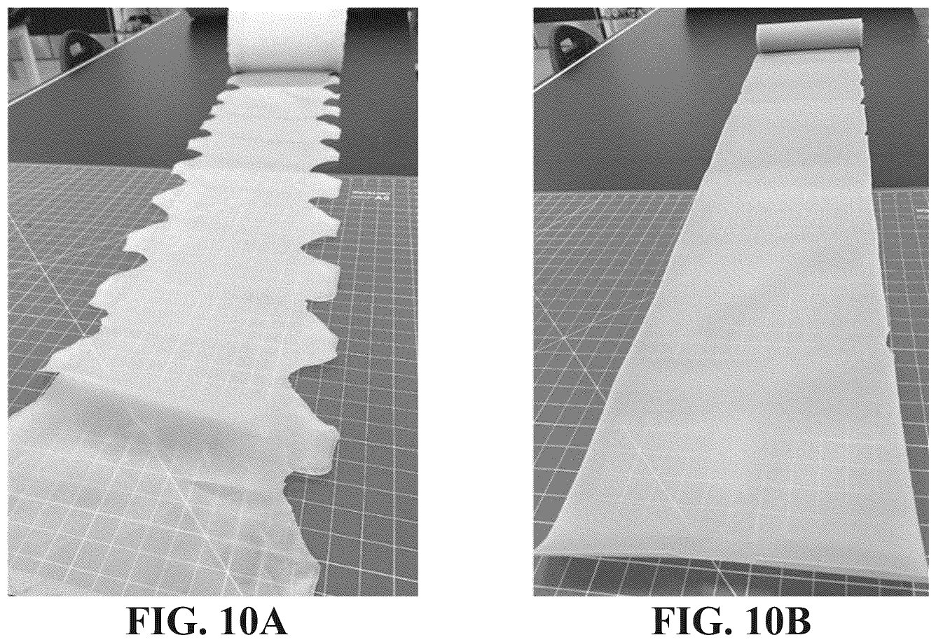

The quality of the films extruded from the sheet die was evaluated qualitatively based on the ability of each film to continuously retain a rectangular shape as it was pulled through the chilled roll stack. The sheets without and with fungal biomass are illustrated in FIGS. 10A and 10B, respectively. As FIGS. 10A and 10B clearly show, the samples that did not contain fungal biomass (FIG. 10A) had a rough surface appearance and major edge tearing, whereas samples that contained fungal biomass (FIG. 10B) had no noticeable surface roughness and very little edge tearing.

### Example 14

### Electron Beam Irradiation of Composite Sheets Containing Fungal Biomass

Fusarium strain flavolapis biomass was grown, deactivated, dried, and jet milled as described in Example 10. A biopolymer blend was then prepared, consisting of 43.7 wt % Septon Bio SF902 (Kuraray), 35.8 wt % Braskem I'm Green™ SVT2180 ethylene-vinyl acetate (EVA), 0.3 wt % carbon black, 0.25 wt % thermally-activated free radical initiator (dicumyl peroxide, Liandox DCP 40-KL, 40% active), and 20 wt % fungal biomass. This biopolymer blend was compounded using a Leistritz twin-screw extruder equipped with 27 mm diameter screws, then pelletized by an underwater pelletizer and dried prior to further processing. The compounded and pelletized blend was then extruded into 30″-wide sheets using a Davis Standard single-screw extruder equipped with a 4.5″ screw, a 34″-wide sheet die, and a temperature-controlled roll stack. The thickness of the sheets was controlled and set to about 0.029″.

After extrusion, the sheets were cut into panels 8′ in length, which were exposed to different dosages of electron beam irradiation as summarized in Table 17 below. 0.5 mm-thick backing sheets of polyester fabric, made entirely from recycled polyester, were laminated onto sheets of the biopolymer blend using a flatbed hot press (Practix OK-160) at 120° C. and a nominal pressure of 100 psi for two minutes; this technique is generally more environmentally sustainable than using a chemical adhesive, but it is necessary for a T-peel adhesion strength (as measured according to ASTM D1876) between the backing layer and the biomaterial layer to be at least about 0.5 N/mm to be practically useful for most applications. It is further desirable, and for some applications necessary, for the bally flex performance of the final composite material (as measured according to ISO 5402) to be at least about 50,000, and in some cases at least about 80,000 or least about 100,000 flex cycles. The adhesion strength between the layers and bally flex performance of the composite sheet were thus measured according to these standards, with the results given in Table 17.

As Table 17 shows, electron beam irradiation can result in significantly improved flex performance of the composite sheet due to improved compatibility between the biopolymers and the fungal biomass, but may also degrade the T-peel adhesion between the biopolymer layer and the backing layer due to greater crosslinking, which reduces the ability of the extruded biopolymer/fungal biomass composition to flow and adhere to the backing layer during hot pressing. The present inventors therefore hypothesize, based on the results of Table 17, that an electron beam dose range from about 5 megarads to about 15 megarads, or a subrange thereof having a lower bound of any whole-number multiple of 0.1 megarads from 5 to 15 megarads and an upper bound of any other whole-number multiple of 0.1 megarads from 5 to 15 megarads, may be an “optimal” range wherein both the bally flex performance of the composite and the T-peel adhesion strength between the layers may be acceptable or preferable.

TABLE 17

| | | Samples | | |
|---|---|---|---|---|
| E-beam | Samples surviving | surviving | Avg. T-peel | T-peel strength |
| dose | 50k flex cycles | 100k flex | strength | std. dev. |
| (Mrad) | (%) | cycles (%) | (N/mm) | (N/mm) |
| 0 | 11 | 0 | 1.05 | 0.09 |
| 5 | 100 | 67 | 1.00 | 0.04 |
| 7.5 | 100 | 100 | 0.80 | 0.05 |
| 15 | 100 | 100 | 0.53 | 0.38 |

### Example 15

### Recycling of Polyurethane-Coated Biomaterial Sheets

Fusarium strain flavolapis biomass was grown, deactivated, dried, and jet milled to form a “flour” having a D90 particle size of about 35 μm. Three different material formulations were then compounded and pelletized using a Thesyon twin-screw extruder equipped with 21 mm diameter screws operating at 250 rpm, as follows.

A first formulation, referred to hereafter as the “100% virgin” formulation, consisted of 20 wt % fungal biomass, 44 wt % Septon Bio SF902 (Kuraray), and 36 wt % Braskem I'm Green™ SVT2180 ethylene-vinyl acetate (EVA). Pellets of the latter two ingredients were dry-blended and fed to the extruder using a pellet feeder, and the fungal “flour” was side-stuffed using a powder feeder. The barrel zone temperatures, starting at the feed throat, were set to 350° F., 350° F., 350° F., 340° F., 330° F., and 320° F., respectively. The formulation was then pelletized and dried prior to further processing.

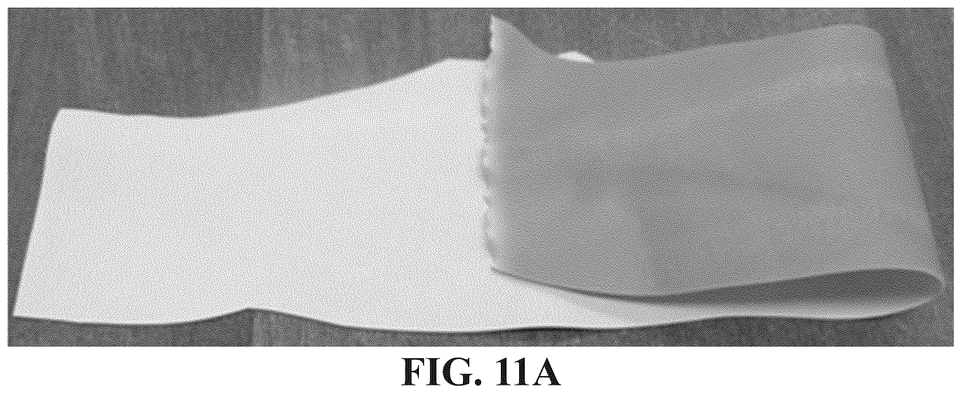

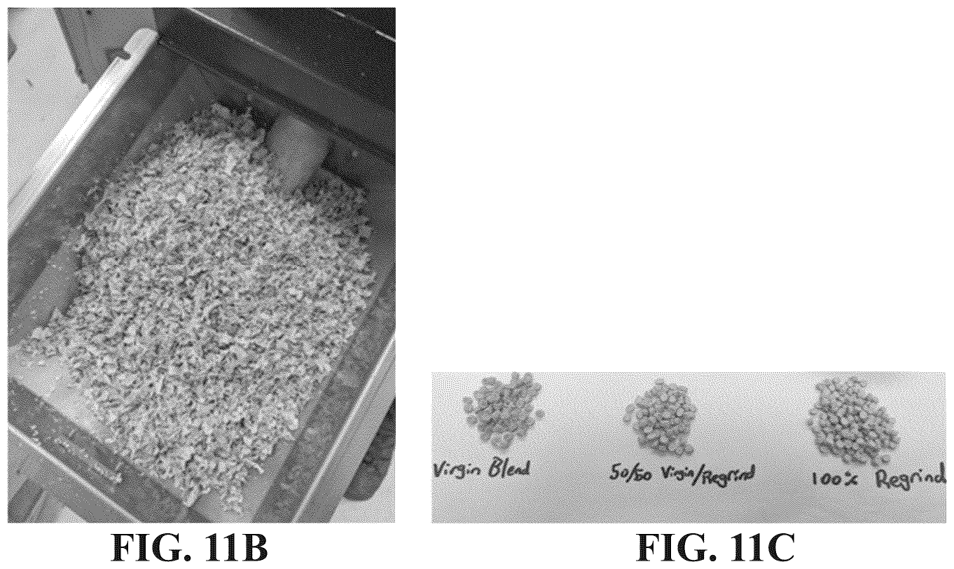

A second formulation, referred to hereafter as the “50% regrind/50% virgin formulation,” was compounded by feeding pellets of the 100% virgin material into the feed throat using a pellet feeder, and separately feeding an equal mass of a “regrind material” to the barrel through a side stuffer using a powder feeder. The regrind material consisted of sheets of the 100% virgin material as a base material, coated with a 70 μm-thick white-pigmented polyurethane topcoat. The base material was produced by compounding the 100% virgin material using a Leistritz twin-screw extruder equipped with 27 mm diameter screws, pelletizing the extruded 100% virgin material using an underwater pelletizer, and drying the pellets prior to further processing, then extruding the dried material into 30″-wide sheets using a Davis Standard single-screw extruder equipped with a 4.5″ screw, a 34″-wide sheet die, and a temperature-controlled roll stack; the thickness of the sheets was controlled to be about 0.029″. The base material sheets were then spray-coated with the polyurethane coating to give the material a leather-like feel and appearance, as shown in FIG. 11A, and then granulated using a Wittman G-Max 13 granulator, as shown in FIG. 11B.

A third formulation, consisting entirely of the “regrind material,” was re-blended by side-stuffing the regrind material into the Thesyon twin-screw extruder, pelletizing, and drying the pellets before further processing. Pellets of the three formulations side-by-side are shown in FIG. 11C.

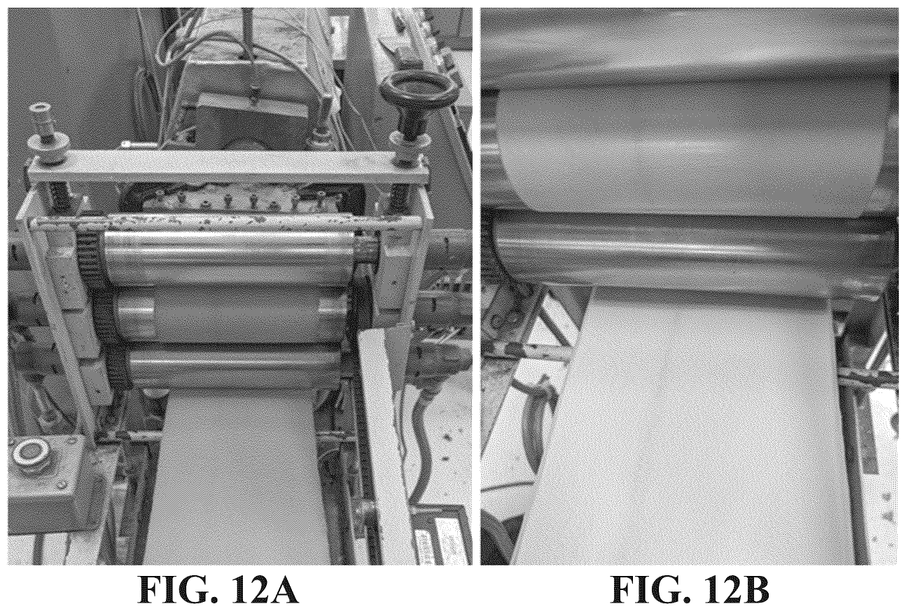

The pellets of each of the three formulations were extruded into sheets using a 1.5″ single-screw extruder with an 8″-wide sheet die set to a nominal gap thickness of 0.8 mm. FIGS. 12A and 12B show the 100% virgin sheets and 50% regrind/50% virgin sheets, respectively, exiting the single-screw extruder. As FIGS. 12A and 12B illustrate, the color of these two formulations was noticeably different as a result of the polyurethane topcoat in the 50% regrind/50% virgin material.

Sheets of each of the three materials were then subjected to tensile strength testing in accordance with ISO 3376, both parallel and perpendicular to the extrusion direction; the results are given in Table 18. As Table 18 shows, the average tensile strengths of the 100% virgin formulation and the 50% regrind/50% virgin formulation were essentially identical, while the 100% regrind material formulation exhibited only a small decrease in tensile strength. The present inventors therefore hypothesize that a significant amount of this regrind material can be recovered and recycled into new sheets with similar mechanical performance, even when coated with traditional leather topcoats.

TABLE 18

| | | Avg. tensile |
|---|---|---|
| Material type | Sample orientation | strength (MPa) |
| 100% virgin | Parallel | 4.1 |
| | Perpendicular | 2.4 |
| 50% regrind/ | Parallel | 4.2 |
| 50% virgin | Perpendicular | 2.4 |
| 100% regrind | Parallel | 4.0 |
| | Perpendicular | 2.0 |

### Example 16

### Poly(Farnesene-Styrene)/Polyester Blends

Sheets of a blend of a poly(farnesene-styrene) polymer (Kuraray Septon Bio SF902) and a polyester (polybutylene succinate (PBS), Mitsubishi Chemical Group) were compounded and pelletized using a Leistritz twin-screw extruder equipped with 27 mm diameter screws operating at 200 rpm. Two formulations were compounded, having 40:60 and 60:40 weight ratios of SF902 to PBS, respectively. The compounded and pelletized blends were extruded into sheets having a thickness of about 0.6 mm using a 1.5″ single-screw extruder with an 8″-wide sheet die set to a nominal gap thickness of 0.5 mm. The resulting films were then subjected to tensile property testing in accordance with ISO 3376, both parallel and perpendicular to the extrusion direction; the results are given in Table 19. As Table 19 shows, the stiffness of extruded sheets can be significantly reduced, relative to sheets of 100% PBS (which has a tensile modulus of about 590 MPa in the parallel direction and about 575 MPa in the perpendicular direction) by blending at least about 40 wt % of a poly(farnesene-styrene) polymer as disclosed herein, e.g., Kuraray Septon Bio SF902, with the PBS. The present inventors hypothesize that the bending stiffness of the sheets could be further reduced by extruding thinner films (e.g., having a thickness of less than about 0.5 mm) using a film die.

TABLE 19

| Material | | Tensile | | |
|---|---|---|---|---|
| (SF902/ | Sample | modulus | Strain at | Tensile |
| PBS wt %) | orientation | (MPa) | break (%) | strength (MPa) |
| 40/60 | Parallel | 223 | 180 | 30.5 |
| | Perpendicular | 192 | 112 | 13.1 |
| 60/40 | Parallel | 89 | 170 | 12.7 |
| | Perpendicular | 59 | 108 | 6.9 |

The concepts illustratively disclosed herein suitably may be practiced in the absence of any element which is not specifically disclosed herein. It is apparent to those skilled in the art, however, that many changes, variations, modifications, other uses, and applications of the disclosure are possible, and changes, variations, modifications, other uses, and applications which do not depart from the spirit and scope of the disclosure are deemed to be covered by the disclosure.

The foregoing discussion has been presented for purposes of illustration and description. The foregoing is not intended to limit the disclosure to the form or forms disclosed herein. In the foregoing Detailed Description, for example, various features are grouped together in one or more embodiments for the purpose of streamlining the disclosure. The features of the embodiments may be combined in alternate embodiments other than those discussed above. This method of disclosure is not to be interpreted as reflecting an intention that the claims require more features than are expressly recited in each claim. Rather, as the following claims reflect, inventive aspects lie in less than all features of a single foregoing disclosed embodiment. Thus, the following claims are hereby incorporated into this Detailed Description, with each claim standing on its own as a separate embodiment.

Moreover, though the present disclosure has included description of one or more embodiments and certain variations and modifications, other variations, combinations, and modifications are within the scope of the disclosure, e.g., as may be within the skill and knowledge of those in the art, after understanding the present disclosure. It is intended to obtain rights which include alternative embodiments to the extent permitted, including alternate, interchangeable, and/or equivalent structures, functions, ranges, or steps to those claimed, regardless of whether such alternate, interchangeable, and/or equivalent structures, functions, ranges, or steps are disclosed herein, and without intending to publicly dedicate any patentable subject matter.

1. A biomaterial textile composition, comprising a polymer component, wherein the polymer component comprises:
a. from about 20 wt % to about 95 wt % of a thermoplastic elastomer; and
b. from about 5 wt % to about 80 wt % of a second polymer,
wherein:
the thermoplastic elastomer has an elastic modulus of no more than about 10 MPa;
the second polymer has at least one characteristic selected from the group consisting of (i) a melt flow index greater than a melt flow index of the thermoplastic elastomer, (ii) a slip velocity greater than a slip velocity of the thermoplastic elastomer, or (iii) a viscosity lower than a viscosity of the thermoplastic elastomer; and
the biomaterial textile composition has at least one of (i) an elastic modulus of no more than about 25 MPa, (ii) a Shore A hardness of no more than about 70, and (iii) a tensile stress at 5% tensile strain of no more than about 1.2 MPa.

2. The biomaterial textile composition of claim 1, wherein the thermoplastic elastomer makes up at least about 40 wt % of the polymer component.

3. The biomaterial textile composition of claim 1, wherein the thermoplastic elastomer is a block copolymer comprising first and second polymer blocks.

4. The biomaterial textile composition of claim 1, wherein the second polymer makes up no more than about 80 wt % of the polymer component.

5. The biomaterial textile composition of claim 1, wherein the second polymer is selected from the group consisting of a thermoplastic polyester elastomer, an ethylene-vinyl acetate, a low-density polyethylene, a styrene-butadiene-styrene block copolymer, a styrene-ethylene-butylene-styrene block copolymer, a styrene-ethylene-propylene-styrene block copolymer, a styrene-ethylene-butadiene-styrene block copolymer, and combinations thereof.

6. The biomaterial textile composition of claim 1, wherein the second polymer is selected from the group consisting of Braskem I'm Green™ EVA SVT2180, Braskem I'm Green™ low-density polyethylene SBC818, Braskem I'm Green™ linear low density polyethylene, Braskem I'm Green™ high-density polyethylene, Styroflex® 2G66 B60, Pebax® thermoplastic elastomers, Dryflex® Green, DuPont Hytrel® 3078 ECO B, polybutylene succinate, polyhydroxy alkanoates, polylactic acid, nylon-11, polyethylene furanoate, Keltan Eco EPDM, and combinations thereof.

7. A biomaterial textile, comprising:
the biomaterial textile composition of claim 1; and
one or both of (i) a coating comprising or derived from a polar solvent, and (ii) a backing layer.

8. The biomaterial textile of claim 7, comprising the backing layer, wherein the backing layer is laminated to a layer of the biomaterial textile composition without the use of a chemical adhesive or bonding agent.

9. A method for making a biomaterial textile, comprising:
deforming a deformable mixture comprising a liquid fraction and one or more biomaterials into a desired spatial configuration, wherein the one or more biomaterials comprise at least one polymer;
treating the deformable mixture; and
processing the polymer.

10. The method of claim 9, wherein the one or more biomaterials comprise at least two polymers.

11. The method of claim 9, wherein the deforming step comprises extruding the deformable mixture.

12. The method of claim 9, wherein the processing step comprises at least one of calendering, compression molding, and injection molding.

13. The method of claim 9, wherein the polymer makes up from about 5 wt % to about 70 wt % of the biomaterial textile.

14. The method of claim 9, wherein:
the biomaterial textile comprises a thermoplastic elastomer in an amount of from about 20 wt % to about 90 wt % of the biomaterial textile; and
the biomaterial textile has an elastic modulus of no more than about 2500 MPa and at least one of (i) an elastic modulus of no more than about 20 MPa and (ii) a Shore A hardness of no more than about 60.

15. A biomaterial textile composition, comprising a polymer component, wherein the polymer component comprises at least 20 wt % of a thermoplastic elastomer block copolymer, wherein the thermoplastic elastomer block copolymer comprises:
a. a first block comprising a polymeric composition selected from the group consisting of polyfarnesene, hydrogenated polyfarnesene, poly(β-farnesene), hydrogenated poly(β-farnesene), polymyrcene, hydrogenated polymyrcene, poly(β-myrcene), hydrogenated poly(β-myrcene), polybutadiene, hydrogenated polybutadiene, polyisoprene, hydrogenated polyisoprene, polyocimene, hydrogenated polyocimene, polyalloocimene, hydrogenated polyalloocimene, polyphellandrene, hydrogenated polyphellandrene, poly(cyclic 1,3-diene), hydrogenated poly(cyclic 1,3-diene), polymyrcenol, hydrogenated polymyrcenol, poly(β-myrcenol), hydrogenated poly(β-myrcenol), polyipsdienol, hydrogenated polyipsdienol, poly(ethylidene norbornene), poly(dicyclopentadiene), poly(vinyl norbornene), poly(alkyl acrylate), poly(ester) acrylate, poly(ether) acrylate, poly(vinyl ester), poly(vinyl alcohol), poly(vinyl nitrile), poly(ether), poly(ester), poly(carbonate), polyethylene, polypropylene, a polyitaconate, polyisobutylene, polyoctene, polyhexene, polybutylene, polymethyl pentene, polysiloxane, and combinations thereof; and
b. a second block comprising a polymeric composition selected from the group consisting of polymerized aromatic vinyl compound, poly(methyl methacrylate), polypropylene, polyethylene, a polyimide, polyisobornyl methacrylate, polyisobornyl acrylate, and combinations thereof,
wherein:
the thermoplastic elastomer block copolymer has an elastic modulus of no more than about 10 MPa; and
the biomaterial textile composition has at least one of (i) an elastic modulus of no more than about 25 MPa, (ii) a Shore A hardness of no more than about 70, and (iii) a tensile stress at 5% tensile strain of no more than about 1.2 MPa.

16. The biomaterial textile composition of claim 15, wherein the polymeric composition of the first block comprises a structural unit derived from one or more farnesenes, wherein the structural unit derived from one or more farnesenes differs from the one or more farnesenes from which it is derived in that at least about 30%, at least about 40%, at least about 50%, at least about 60%, at least about 70%, at least about 80%, at least about 90%, or about 100% of carbon-carbon bonds that are double bonds in the one or more farnesenes are single bonds in the structural unit.

17. The biomaterial textile composition of claim 15, wherein the second block comprises styrene monomer units in an amount of about 17 to about 22 wt % of the thermoplastic elastomer block copolymer.

18. The biomaterial textile composition of claim 15, wherein a weight ratio of the first block to the second block is from about 50:50 to about 95:5.

19. The biomaterial textile composition of claim 15, wherein a proportion of carbon in the thermoplastic elastomer block copolymer that is renewable, recyclable, and/or biologically derived is at least about 70% or at least about 80%.

20. The biomaterial textile composition of claim 15, wherein the thermoplastic elastomer block copolymer makes up at least about 40 wt % of the polymer component.

21. A biomaterial textile comprising the biomaterial textile composition of claim 15, wherein the biomaterial textile further comprises one or both of (i) a coating, wherein the coating comprises or is derived from a polar solvent, and (ii) a backing layer.

22. The biomaterial textile of claim 21, wherein a polyurethane content of the coating is no more than about 10 wt %, no more than about 9 wt %, no more than about 8 wt %, no more than about 7 wt %, no more than about 6 wt %, no more than about 5 wt %, no more than about 4 wt %, no more than about 3 wt %, no more than about 2 wt %, no more than about 1 wt %, no more than about 0.9 wt %, no more than about 0.8 wt %, no more than about 0.7 wt %, no more than about 0.6 wt %, no more than about 0.5 wt %, no more than about 0.4 wt %, no more than about 0.3 wt %, no more than about 0.2 wt %, no more than about 0.1 wt %, no more than about 0.09 wt %, no more than about 0.08 wt %, no more than about 0.07 wt %, no more than about 0.06 wt %, no more than about 0.05 wt %, no more than about 0.04 wt %, no more than about 0.03 wt %, no more than about 0.02 wt %, or no more than about 0.01 wt %.

23. The biomaterial textile of claim 22, wherein the coating is substantially free of polyurethane.

24. A biomaterial textile composition, comprising:
an at least partially hydrogenated styrene/farnesene block copolymer having at least one characteristic selected from the group consisting of (i) a Shore A hardness of about 6 to about 10, (ii) a styrene content of about 10 wt % to about 25 wt %, and (iii) a melt flow rate at 230° C. and 10 kg of about 50 g/10 min to about 60 g/10 min; and
a polyester, having a Young's modulus of no more than about 600 MPa and derived from polymerization of one or more diacids with one or more diols,
wherein:
the one or more diols comprise 1,4-butanediol,
a weight ratio of the at least partially hydrogenated styrene/farnesene block copolymer to the polyester is at least about 0.4, and
the biomaterial textile composition has at least one characteristic selected from the group consisting of (iv) a Shore A hardness of no more than about 70 and (v) a tensile stress at 5% tensile strain of no more than about 1.2 MPa.

25. The biomaterial textile composition of claim 24, having an elastic modulus of no more than about 25 MPa.

26. The biomaterial textile composition of claim 24, wherein the at least partially hydrogenated styrene/farnesene block copolymer comprises Kuraray SEPTON™ BIO SF902.

27. The biomaterial textile composition of claim 24, wherein the polyester comprises polybutylene succinate.

28. The biomaterial textile composition of claim 24, wherein the biomaterial textile composition is in the form of a sheet having a thickness of at least about 0.7 mm.

29. The biomaterial textile composition of claim 24, wherein the biomaterial textile composition is in the form of a sheet having a thickness of no more than about 0.7 mm.

30. A biomaterial textile, comprising:
a layer or sheet of the biomaterial textile composition of claim 24; and
a backing layer.
